(19) United States
(12) Patent Application Publication
(10) Pub. No.: US 2008/0117029 A1
(43) Pub. Date: May 22, 2008

(54) SYSTEM AND METHOD FOR RELIABLE COMMUNICATIONS IN A ONE-WAY COMMUNICATION SYSTEM

(75) Inventors: Anthony E. Dohrmann, Carlsbad, CA (US); Clinton J. O'Conner, Cardiff by the Sea, CA (US); Richard W. Koralek, Palo Alto, CA (US)

Correspondence Address: KNOBBE MARTENS OLSON & BEAR LLP, 2040 MAIN STREET, FOURTEENTH FLOOR, IRVINE, CA, 92614, US

(73) Assignee: LaserShield Systems, Inc., Carlsbad, CA (US)

(21) Appl. No.: 11/933,188

(22) Filed: Oct. 31, 2007

Related U.S. Application Data
(62) Division of application No. 11/043,723, filed on Jan. 25, 2005, now abandoned.

(51) Int. Cl. G08B 9/00

(52) U.S. Cl. 340/286.02

(57) ABSTRACT

An alarm system, including ease of programming of a family or group of interoperating alarm devices via a learn mode that detects new devices and provides reliable accounting of the group via state dumps to an external system. Reliable communications with the external system are provided via a set of protocols. Disabling of the alarm system is prevented, by transmitting a pre-alarm signal prior to expiration of an entry delay, and by verifying communications with an external device, prior to an alarm-triggering event. Multi-priority message code assignment, including error tolerance, employs n-bit codes with maximized error tolerance. Message transmissions include multiple levels of error protection. The group of monitored alarm devices can be easily set up, purchased and activated by a consumer, and do not become permanent fixtures.

### PRIORITY CLAIM AND RELATED APPLICATIONS

This application is a divisional of U.S. application Ser. No. 11/043,723, filed Jan. 25, 2005, by Dohrmann entitled “APPARATUS, SYSTEM AND METHOD FOR ALARM SYSTEMS,” which is co-pending, the entire contents of which are incorporated by reference herein; which was the National Stage of International Application No. PCT/US03/23679, filed Jul. 28, 2003 by Dohrmann entitled “APPARATUS, SYSTEM AND METHOD FOR ALARM SYSTEMS,” which was co-pending at that time, the entire contents of which are incorporated by reference herein; which claims the benefit of U.S. Provisional Application No. 60/398,792, filed Jul. 29, 2002 by Dohrmann, entitled “ALARM SYSTEM AND METHOD,” which was co-pending at that time, the entire contents of which are incorporated by reference herein.

### BACKGROUND

1. Field of the Invention

The present invention generally relates to alarm systems and more particularly to a monitored alarm system and method for using the alarm system.

2. Description of the Related Art

In recent years, alarm systems may have been developed that include numerous alarm devices, such as smoke detectors, intrusion detectors, etc. However, such alarm systems typically may not include an easy and robust method of programming and/or accounting for the various devices that make up the alarm system.

Other alarm systems have been developed that may include connections to and communications with external systems, such as a central monitoring center. However, such alarm systems typically may not include a robust method of communications with such external systems.

In addition, alarm systems may include an entry delay between when an armed alarm system receives an alarm-triggering event and when the alarm system initiates an internal alarm sequence. However, a way for a burglar to thwart such an alarm system is to disconnect or break the connection to the external system prior to expiration of the entry delay and, thus, disable communications with the external system. Because the connection can include a phone line, etc., the burglar can simply unplug, cut or otherwise disable the phone line of the alarm system to defeat the alarm system prior to the expiration of the entry delay.

In an attempt to overcome the above-noted problem, systems may have been developed that include a wireless connection to report an alarm condition. Such systems may include a cell phone built into a control panel of an alarm unit. However, not only is this an expensive solution, such a system still can be thwarted, because the entry delay can give a determined burglar time to defeat the alarm by ripping the control panel off the wall and breaking or otherwise disabling the control panel prior to the expiration of the entry delay, typically lasting 30 seconds to several minutes. In addition, a burglar could disable any communications links, like the phone lines or cable, prior to the alarm-triggering, thus, thwarting a monitored alarm system.

Systems may have been developed that employ transmission of messages, such as alarm messages, between one device, such as a smoke detector, and another device, such as an alarm control panel. In such systems, however, the messages transmitted may be subject to bit errors during transmission rendering the received message unusable or inaccurate. This may be problematic during transmission of urgent or high priority messages, such as panic or medical alerts, and non-urgent or low priority messages, such as status alerts, wherein the urgent messages may be interpreted as the non-urgent messages and visa versa, leading to false alarms and potentially life-threatening situations.

Systems having multiple transmitters may have been developed. Typical examples may include local area networks and cable modems. In such systems, however, there may be a possibility of two or more transmitters transmitting simultaneously and rendering both data streams unreadable. This may be referred to as intra-system packet interference. Two common classes of techniques may be employed to minimize or prevent intra-system packet interference. In one method, which may be exemplified by Ethernet network protocols, each transmitter listens to the channel as it is transmitting. If a transmitter detects that its transmissions are being corrupted by another transmitter's simultaneous transmission, it stops and tries again at a later time. In another method, which may be exemplified by cable modem protocols, each transmitter that has data to transmit is assigned a time slot in which to transmit. Both of these techniques (and their variants), however, may require that each transmitter also include a receiver, either to listen to the channel to ensure its data is being properly transmitted without interference or to receive time slot information or other commands from a central station. Further, including a receiver in each transmitter is expensive.

Similarly, alarm systems may employ transmission of alarm messages from a plurality of transmitter devices, such as smoke detectors, to a receiver, such as an alarm control panel. However, as noted above, the multiple transmitters may simultaneously transmit messages to the receiver, rendering the received message unusable or inaccurate due to message collisions. This may be problematic during transmission of urgent or high priority messages, such as panic or medical alerts, wherein the urgent messages can be corrupted, leading to false alarms and potentially life-threatening situations.

In communication systems that are prone to transmission errors, it may be common to use some form of error protection. For systems that have two-way communication, a widely used technique may be Automatic Repeat Request (ARQ). In this technique, a receiver may determine (e.g., using an error detection code, such as a Cyclical Redundancy Checking (CRC) code) whether or not a received packet from a transmitter contains errors. If the received packet may be determined to contain errors, the receiver may send an ARQ to the transmitter to repeat the packet transmission. However, for systems that do not have two-way communication (e.g., one-way communication systems), some form of forward error correction and/or detection should be employed. Accordingly, the field of error correcting and detecting codes is an active field.

In many one-way communication systems, packet transmission may be required to meet some minimum reliability standard. In other words, a probability that a receiver will successfully receive and correctly interpret a transmission may be required to be greater than a threshold value. Conversely a probability that the receiver may not receive and correctly interpret a transmission may be required to be less than a desired value. One example of such a system is a wireless alarm system, wherein an intrusion alert from a remote sensor is transmitted to a central alarm unit. However, such systems may not typically ensure a high probability of successful message reception by the central alarm unit.

Accordingly, attempts may have been made to employ concatenated coding systems for such applications. In such coding systems, there may be employed convolutional codes and block codes (e.g., a Reed-Solomon code), with an interleaver between the codes to insure independence so that the codes do not interact. Other concatenated coding systems may include the presently popular “turbo” codes, which may consist of two convolutional codes in a parallel or serial concatenation configuration with a large random interleaver. However, Turbo codes and, in general, convolutional codes typically may not address error detection, whereas block codes (such as Reed-Solomon codes), and concatenated coding systems that may use a block outer code, typically may perform some error detection if properly implemented. In fact, for most block codes, there may be a tradeoff between the amount of error correction and the amount of error detection. In addition, many of these concatenated coding systems may be relatively complex and expensive to implement.

Finally, many monitored alarm systems have been developed that require expert installation, are expensive to purchase and operate, are complex to program, and become permanent fixtures after installation. Accordingly, such systems may have not gained wide acceptance, may be only with a small percentage of consumers, such as homeowners that can afford such expensive systems, can pay for the expert installation, and that want to include the alarm systems as a permanent fixtures in their homes.

The following patents teach various security systems are herein incorporated by reference for their supporting teachings:

U.S. Pat. No. 3,855,574 voice operated alarm system;

U.S. Pat. No. 4,056,815 is a battery operated transmitter circuit;

U.S. Pat. No. 4,064,507 is a noise generator circuit for a security system;

U.S. Pat. No. 4,498,075 is a fault indicator apparatus for a multi-zone intrusion system;

U.S. Pat. No. 4,511,886 an electronic security and surveillance system;

U.S. Pat. No. 4,943,799 is a portable alarm system with sealed enclosure;

U.S. Pat. No. 5,440,292 is an intrusion detector;

U.S. Pat. No. 5,463,595 is a portable security system for outdoor sites;

U.S. Pat. No. 5,621,385 is an intrusion alarm and detection system;

U.S. Pat. No. 5,629,687 is an universal interface for remotely monitored security systems;

U.S. Pat. No. 5,640,141 is a surveillance and alarm device for room spaces;

U.S. Pat. No. 5,777,551 is a portable alarm system;

U.S. Pat. No. 5,808,547 is an intrusion alarm and detection system;

U.S. Pat. No. 5,805,064 is a security system;

U.S. Pat. No. 5,850,180 is a portable alarm system;

U.S. Pat. No. 5,877,684 is a sensor equipped portable alarm device which can be used in conjunction with external alarm device; and

U.S. Pat. No. 5,939,990 is a method of indicating operation of backup battery and circuit for sensing the same.

The foregoing patents reflect the state of the art of which the applicant is aware and are tendered with the view toward discharging applicants' acknowledged duty of candor in disclosing information that may be pertinent in the examination of this application. It is respectfully stipulated, however, that none of these patents teach or render obvious, singly or when considered in combination, applicants' claimed invention.

Therefore, there is a need for an alarm system that provides ease of programming of various devices within the alarm system and that provides a reliable way for accounting for the various devices that make up the alarm system family. In addition, there is a need for an alarm system that provides reliable communications with external systems. Further, there is a need for a system and method for preventing disabling of a monitored alarm system by disabling communications with an external system, without comprising the entry delay feature.

There is also a need for a method and system for transmitting urgent and non-urgent messages, with a tolerance for transmission errors. In addition, there also is a need for a method and system for reliably transmitting multiple messages from multiple transmitters to a receiver in a robust and reliable manner and without employing a receiver in the transmitter devices. Further, there also is a need for providing robust error correction and detection for messages transmitted in one-way communication systems. Finally, there also is a need for a monitored alarm system that is affordable, easy to set up and operate, and that does not become a permanent fixture in a consumer's premises.

### SUMMARY

In one embodiment, there is an alarm system comprising at least one main alarm unit configured to receive messages generated by the alarm system, the messages including predetermined alarm event messages; and at least one remote alarm device configured to detect predetermined alarm events and transmit messages, the messages including predetermined alarm event messages, wherein the messages are represented by codes, the messages are classified as either high priority or low priority, and all codes in low priority messages differ in a plurality of binary bit locations from all codes in high priority messages.

In another embodiment, there is a method for assigning message codes in an alarm system comprising classifying a set of messages into high priority messages and low priority messages, and assigning codes such that all codes in low priority messages differ in a plurality of bit locations from all codes in high priority messages.

In another embodiment, there is a method of unilateral packet transmission in systems with multiple independent transmitters comprising transmitting a packet, waiting a randomly determined amount of time less than a predetermined maximum amount of time, retransmitting the packet, and repeating the waiting and the retransmitting a predetermined number of times.

In another embodiment, there is a method of encoding a message to increase error correction and detection in an alarm system comprising encoding a message with an error detection code, appending the error detection code to the encoded message, and encoding the resulting encoded message and error detection code with an error correction code.

In another embodiment, there is a method for activating an alarm system comprising receiving information to create a customer account, the customer account including a customer contact telephone number; receiving an alarm notification produced by performing a single manual input action on an alarm unit; telephoning the customer contact telephone number; requesting a passcode; receiving the passcode; and activating a monitoring account for monitoring the alarm system after receiving the passcode.

Reference throughout this specification to features, advantages, or similar language does not infer that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, the team and the additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific features, advantages or embodiments that are illustrated in the appended drawings. Same numbering between the various figures are intended to represent the same elements there between. Understanding that these drawings depict only typical features, advantages or embodiments of the illustrated invention and are not therefore to be considered to be limiting of its scope, the invention will be described and explained with additional specificity and detail through the use of the accompanying drawings, in which:

FIG. 1 is a block diagram illustrating one embodiment of an alarm system according to the present invention;

FIGS. 2a-2c are block diagrams illustrating alternative embodiments of the alarm system of FIG. 1;

FIG. 3a is a block diagram illustrating one embodiment of a master alarm unit according to the present invention;

FIG. 3b is a block diagram illustrating another embodiment of a master alarm unit according to the present invention;

FIGS. 3c-e are a flowchart illustrating one embodiment of a learn mode process according to the present invention;

FIG. 3f is a flowchart illustrating one embodiment of a MAU call process according to the present invention;

FIGS. 3g-h are a flowchart illustrating one embodiment of a Supercall process according to the present invention;

FIG. 4 is a block diagram illustrating one embodiment of a satellite alarm unit according to the present invention;

FIG. 5 is a block diagram illustrating one embodiment of a keyfob remote control according to the present invention;

FIG. 6 is a block diagram illustrating one embodiment of another remote device according to the present invention;

FIGS. 7a-b are a flowchart illustrating one embodiment of a pre-alarm process according to the present invention;

FIG. 7c is a flowchart illustrating one embodiment of a connection verification process according to the present invention;

FIG. 8 is a block diagram illustrating one embodiment of a communication packet according to the present invention;

FIG. 9a is a diagram illustrating one embodiment of a packet repetition technique with improved error tolerance in a multi-transmitter environment according to the present invention;

FIG. 9b is a flowchart illustrating one embodiment of a packet repetition technique with improved error tolerance in a multi-transmitter environment according to the present invention;

FIG. 10a is diagram illustrating one embodiment of a coded message data structure including multi-level error correction and detection according to the present invention;

FIG. 10b is a flowchart illustrating multi-level error correction and detection;

FIG. 11 is a chart illustrating exemplary functions of and processes performed by an Account Activation and Customer Support (AACS) System 1100;

FIGS. 12a-c are a flowchart illustrating one embodiment of an alarm system activation process according to the present invention;

FIGS. 12d-e are a flowchart illustrating one embodiment of an account test queue process according to the present invention;

FIGS. 12f-g are a flowchart illustrating one embodiment of an alarm system status check process according to the present invention;

FIG. 12h is a flowchart illustrating one embodiment of an account cancellation process according to the present invention;

FIGS. 12i-k are a flowchart illustrating one embodiment of an alarm process according to the present invention; and

FIG. 13 is an exemplary computer system, which may be programmed to perform one or more of the processes described with respect to FIGS. 1-12.

### DETAILED DESCRIPTION OF CERTAIN EMBODIMENTS

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

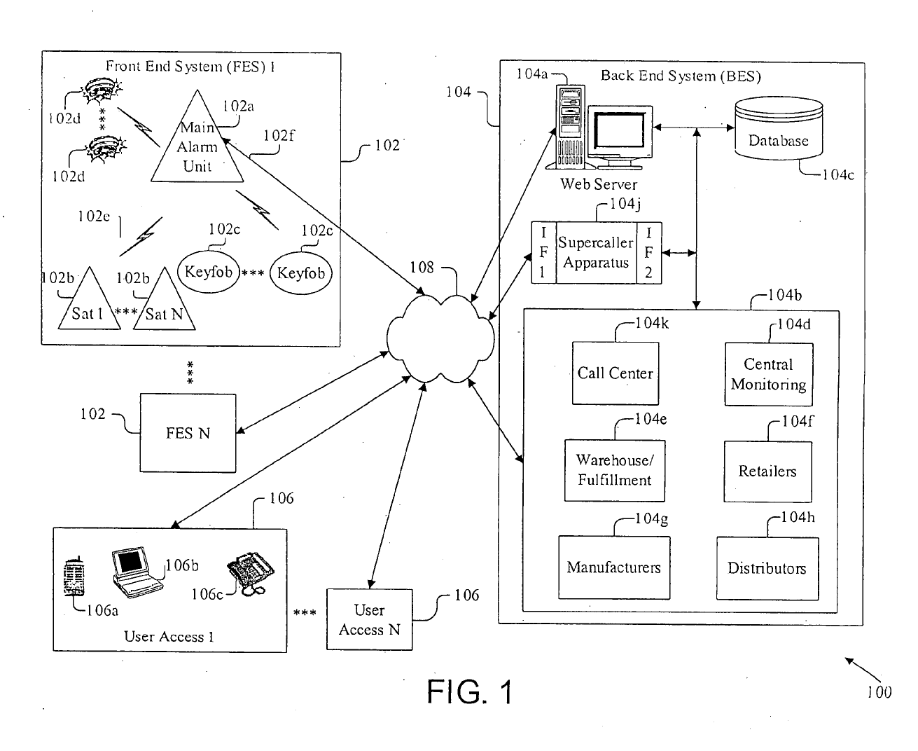

Referring to FIG. 1, there is illustrated an alarm system 100, according to an embodiment of the present invention. In FIG. 1, the alarm system 100, for example, includes one or more Front End Systems (FES) 102, coupled to a Back End System (BES) 104 via a communications network 108. Users of the FES 102 and the BES 104 can gain access to alarm system 100 via one or more user access devices 106, over the communications network 108.

The FES 102 includes, for example, a “family” of alarm devices 102a-102d. A Main Alarm Unit (MAU) 102a communicates, for example, via a communications link 102e, with one more remote devices, such as one or more satellite alarm units 102b, keyfob alarm units 102c, and other remote devices 102d. In a preferred embodiment, the alarm devices 102a-102d are portable, relatively easy to program, and provide various alarm system functions (e.g., motion, glass break, entry, fire, smoke, gas, flooding, etc., detection), as further described.

In one embodiment, the MAU 102a can be placed in a central location of user's premises (e.g., the living room), with one or more of the alarm devices 102b-102d placed at other locations in the premises (e.g., bedrooms, dens, etc.). In this way, complete alarm system coverage of the user's premises can be advantageously achieved. In a further embodiment, the alarm system within a user's premises may be remotely monitored by an alarm monitoring company, as shown in FIG. 1.

The MAU 102a can report to the BES 104 for monitoring alarm and other events, for example, generated by the MAU 102a and/or one or more of the alarm devices 102b-102d, over the communications network 108, via a communications link 102f. In a preferred embodiment the communications link 102f includes, for example, a telephone communications link, such as a hardwired phone line using DTMF tones, etc. Alternatively, the communications link 102f also may include a broadband connection, a modem connection, a cellular phone connection, etc. In addition, users of the FES 102 can communicate with the MAU 102a and/or the BES 104 over the communications network 108 to perform various functions, as further described, via the user access devices 106.

The BES 104 includes, for example, a web server 104a which may be maintained by a provider of the alarm system 100, third party systems 104b, and a database 104c (e.g., implemented with a database server, etc.), as further described. The third party systems 104b include, for example, one or more central monitoring center systems 104d, warehouse/fulfillment systems 104e, retailer systems 1044, manufacturer systems 104g, distributor systems 104h, customer, service or call center systems 104k, etc. Users, administrators, etc., of the systems 104a-104k can have various levels of access to the BES 104 and/or the FES 102 over the communications network 108, to perform various functions, as further described, via the user access devices 106.

In addition, the BES 104 further includes a supercaller apparatus 104j coupled to the communications network 108 via a first interface (IF1, e.g., Dual-Tone Multi-Frequency (DTMF), Internet Protocol (IP), etc., interface) for communicating with the MAU 102a and for communicating with the rest of the BES 104 via second interface (IF2, e.g., serial, parallel, etc., interface), as further described below and in the section entitled “SUPERCALL PROTOCOLS.” In a preferred embodiment, the call center 104k personnel and the alarm system 100 service provider administrators have access to the supercaller apparatus 104j for communicating with the MAU 102a. However, one or more of the BES 104 systems personnel and administrators can be given access to the supercaller apparatus 104j for communicating with the MAU 102a, as will be appreciated by those skilled in the relevant art(s).

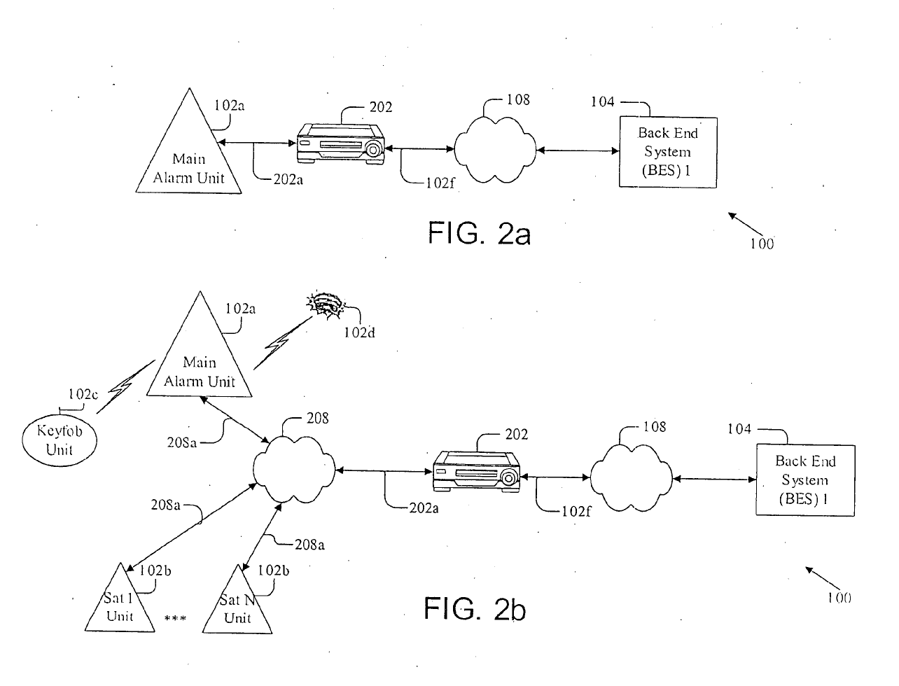

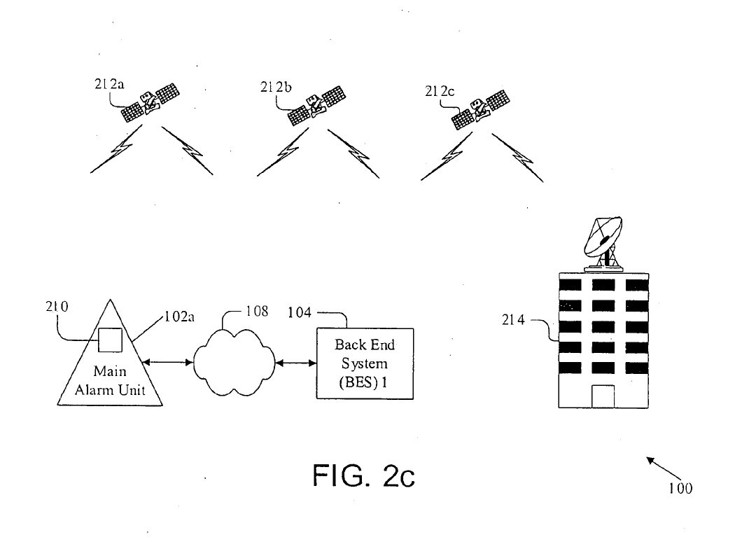

FIG. 2a shows the MAU 102a coupled to a device 202, such cable modem, network hub or switch, Digital Subscriber Line (DSL) modem, set-top box, cable box, satellite television receiver, Internet appliance, etc., via a wireless (e.g., cellular, 802.11b Wi-Fi, etc.) or hardwired (e.g., Ethernet cable, fiber optic cable, etc.) communications link 202a.

FIG. 2b illustrates a further alternate embodiment, wherein the MAU 102a and the satellite alarm units 102b are coupled to the device 202 via a local area network (LAN) 208 and a wireless (e.g., 802.11b, etc.) or hardwired (e.g., Ethernet cable, etc.) communications link 208a. In this way, the satellite alarm units 102b do not need to be connected directly to the MAU 102a.

FIG. 2c illustrates a further alternate embodiment, wherein the MAU 102a and the devices 102b-102d can be employed in a remote (e.g., hotel, etc.) or outdoor (e.g., camping) environment by including Global Positioning System (GPS) capability or other similar method for obtaining information about the geographic location of the MAU 102a and/or the devices 102b-102d. Accordingly, the MAU 102a includes a GPS receiver 210 that communicates with the GPS, including satellites 212a-212c and ground station or control segment 214. In this way, location information of the MAU 102a, provided by the GPS, can be transmitted to the BES 104 by the MAU 102a over the communications network 108.

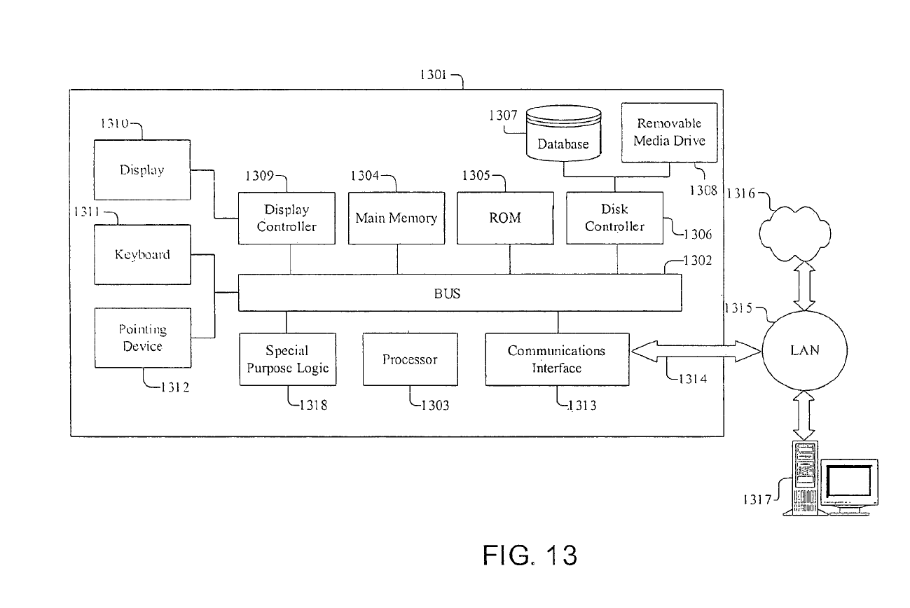

Accordingly, the devices and subsystems of the alarm system 100 of FIGS. 1-2 may include, for example, any suitable servers, workstations, personal computers (PCs), laptop computers, PDAs, Internet appliances, set top boxes, modems, handheld devices, telephones, cellular telephones, wireless devices, other devices, etc., capable of performing the processes of the embodiments of the present invention. The devices and subsystems may communicate with each other using any suitable protocol and may be implemented using the computer system 1301 of FIG. 13, for example. One or more interface mechanisms can be used in the alarm system 100 including, for example, Internet access, telecommunications in any form (e.g., voice, modem, etc.), wireless communications media, etc. Accordingly, the communications network 108 can include, for example, wireless communications networks, cellular communications networks, G3 communications networks, Public Switched Telephone Networks (PSTNs), Packet Data Networks (PDNs), Value Added Networks (VANs), secure and non-secure communications networks, financial transaction communications networks, electronic commerce (e-commerce) communications networks, the Internet, intranets, etc.

It is to be understood that the alarm system 100 of FIGS. 1-2 is for exemplary purposes, as many variations of the specific hardware used to implement the embodiments of the present invention are possible, as will be appreciated by those skilled in the relevant art(s). For example, the functionality of the devices and the subsystems of the alarm system 100 may be implemented via one or more programmed computer systems or devices.

To implement such variations and other variations, a single computer system (e.g., the computer system 1301 of FIG. 13) may be programmed to perform the special purpose functions of one or more of the devices and subsystems of the alarm system 100. On the other hand, two or more programmed computer systems or devices can be substituted for any one of the devices and subsystems of the alarm system 100. Accordingly, principles and advantages of distributed processing, such as redundancy, replication, etc., also may be implemented as desired to increase the robustness and performance of the alarm system 100, for example.

### Master Alarm Unit

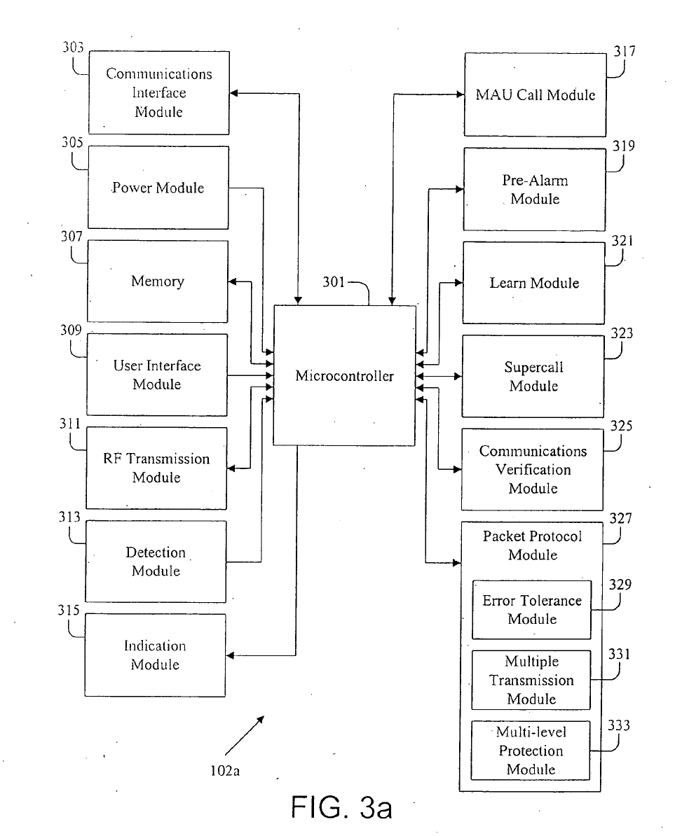

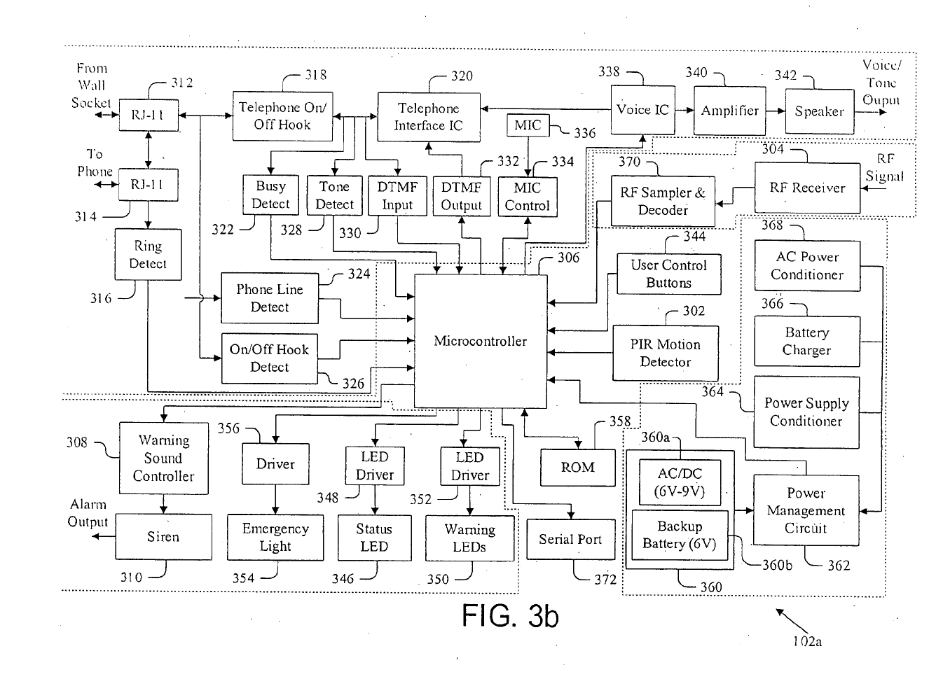

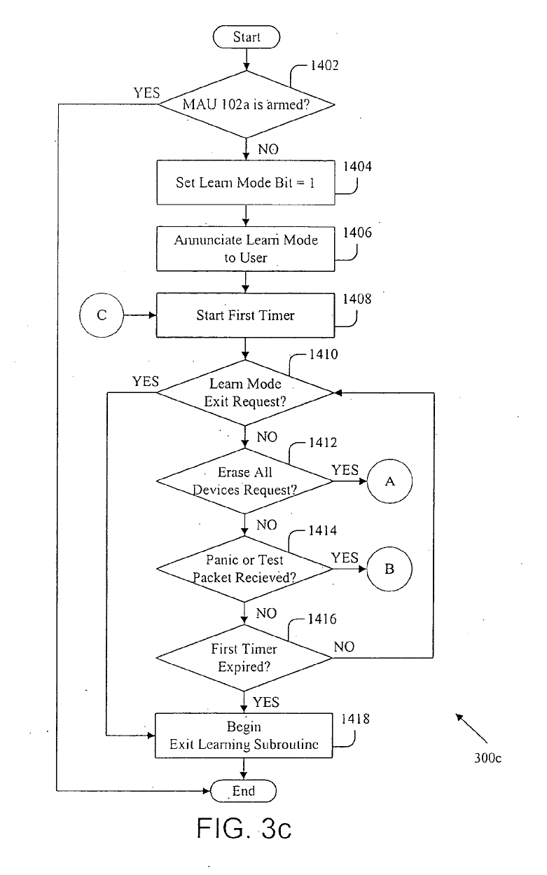

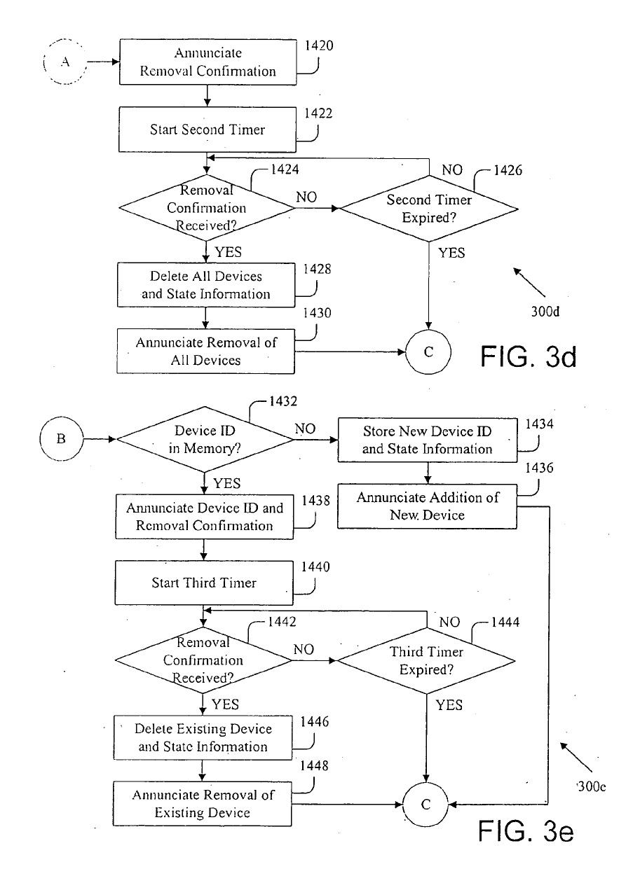

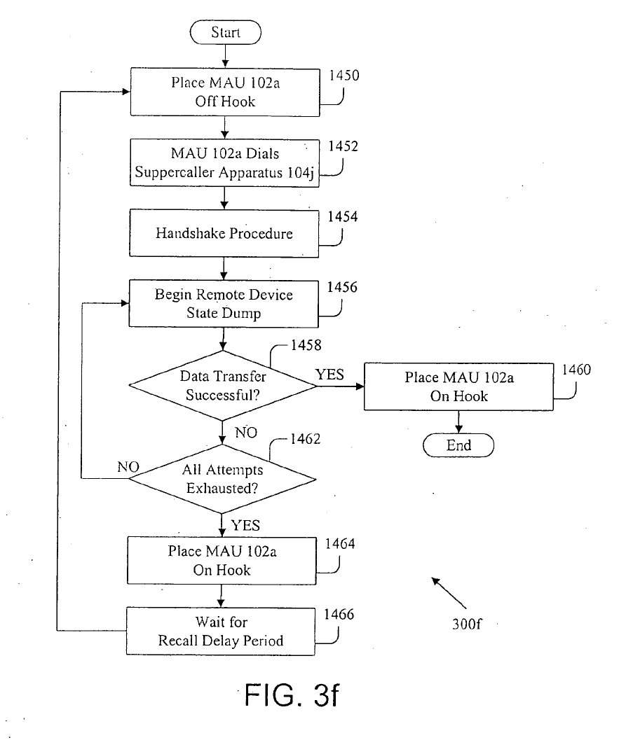

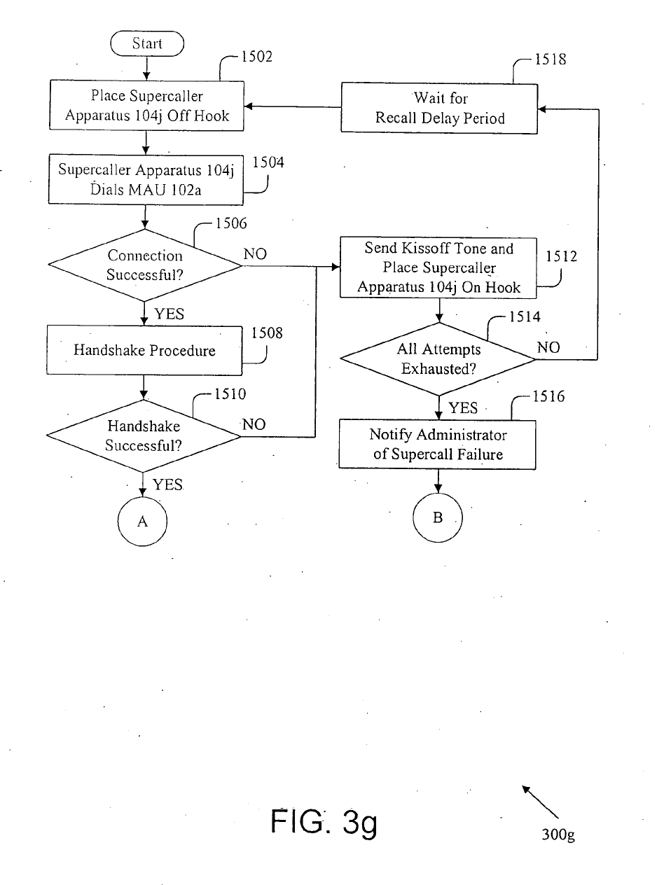

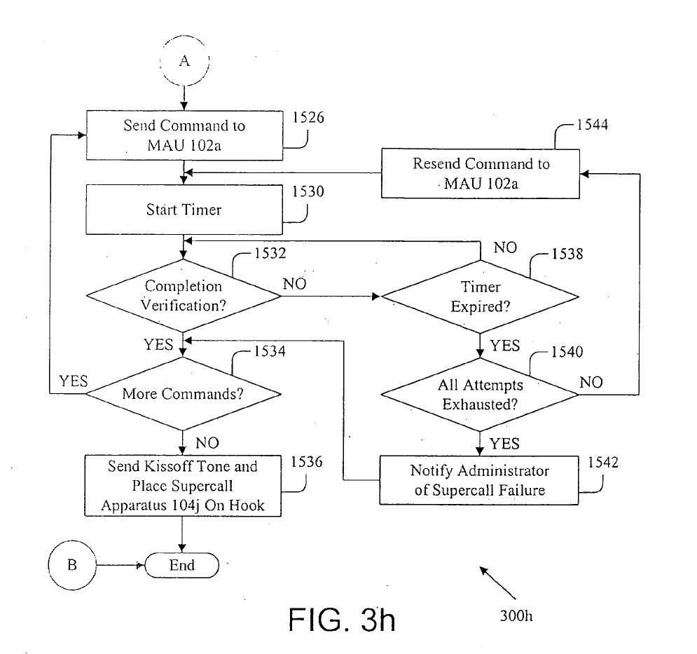

FIGS. 3a and 3b are block diagrams illustrating the features and capabilities performed by the MAU 102a of the alarm system 100 of FIGS. 1-2. Generally, the MAU 102a functions as the hub of the alarm system 100.

In FIG. 3a, the depicted MAU 102a includes a microcontroller 301, a communications interface module 303, a power module 305, a memory 307, a user interface module 309, a radio frequency (RF) transmission module 311, a detection module 313, an indication module 315, a MAU call module 317, a pre-alarm module 319, a learn module 321, a supercall module 323, a communications verification module 325 and a packet protocol module 327. The depicted packet protocol module 327 further includes an error tolerance module 329, a multiple transmission module 331, and a multi-level protection module 333.

In FIG. 3b, the MAU 102a provides, for example, the following functions: detection of motion of warm bodies with a built-in Passive Infrared (PIR) motion detector 302, reception of radio signals from remote devices 102b-102d via radio frequency (RF) receiver 304 over wireless data link 102e; state tracking of remote devices 102b-102d via microcontroller 306; sounding of an alarm in response to predetermined alarm events (e.g., motion detection, panic alerts, etc.) via warning sound controller 308 and siren 310; placement of a telephone call to the central monitoring center 104d to report the predetermined alarm events via a telephone interface (e.g., modules 312-332); acceptance of incoming calls via the telephone interface (312-332) to set operating parameters and to allow audio monitoring of a premises (e.g., using a built-in microphone 336 and controller 334), etc. In a further embodiment, the MAU 102a also may provide remote video surveillance and recording via a chip camera (not shown).

The depicted MAU 102a shown in FIG. 3b includes a microcontroller 306, a communications interface module 312-332, a power module 360-368, a memory 358 (typically ROM), a user input module, 344, a radio frequency (RF) transmission module 304, 370, a motion detection module 302, and an indication module 308, 310, 346-356.

In one embodiment, the call module 317, the pre-alarm module 319, the learn module 321, the supercall module 323, the communications verification module 325 and the packet protocol module 327 may be implemented at least in part through software coded in the memory 307 and microcontroller 301, as well as some of the other modules shown.

In a preferred embodiment, the MAU 102a includes, for example, a receive-only radio implemented via the RF receiver 304 and an RF sampler and decoder 370. The MAU 102a receives and interprets data from the remote devices (e.g., the satellite devices 102b, the keyfob devices 102c, other RF remote devices 102d, etc). However, two-way communications can be employed by including an RF transmitter in the MAU 102a and RF receivers in the devices 102b-102d, as will be appreciated by those skilled in the relevant art(s). In addition, the RF transmitter and receiver functions of the MAU 102a and the devices 102b-102d can be implemented via other radio technologies, such as Bluetooth, etc., as will be appreciated by those skilled in the relevant art(s).

The telephone interface of the MAU 102a includes, for example, two connectors 312 and 314 (e.g., RJ-11 connectors). One of the connectors 312 is employed for connection to a telephone service (e.g., via a wall plug) via the telephone line 102f over the communications network 108 (e.g., a PSTN), and the other connector 314 is a pass-through connector to a standard telephone set. Accordingly, the MAU 102a can initiate and receive phone calls via the telephone interface over the communications network 108 and can also allow a connection to another telephone network device (e.g. a phone, a fax, a modem, etc.). In a preferred embodiment, telephone communication is performed via DTMF tones and voice annunciations generated by the Voice IC 338 and transmitted through the telephone interface circuitry 320, 318, 312. However, modem, cellular, network, etc., communications can be employed by modifying the telephone interface to include modem communications, cellular communications, network communications functions, as will be appreciated by those skilled in the relevant art(s).

In order to provide ease of use and programming the MAU 102a employs, for example, three external switches (e.g., user control buttons 344). A first switch is a power switch, the primary function of which is to power the MAU 102a on and off. A second switch is a learn button, the primary function of which is to place the MAU 102a into a learn mode. A third switch is a panic button, the primary function of which is to initiate a panic alert. All three switches can be momentary pushbutton logic switches, wherein a switch input is processed by the microcontroller 306.

The MAU 102a may provide feedback on system status to the user with lights, alert sounds and annunciations, for example, via a status light emitting diode (LED) 346 and driver 348, one or more warning LEDs 350 and driver 352, a motion detect LED mounted behind a lens of the PIR motion detector 302, and recorded annunciations which may be played through the speaker 342. An emergency light 354 and driver 356 also may be provided. The warning sound controller 308 sounds the siren 310 (e.g., >96 dB piezoelectric, etc.) and the speaker 342 provides voice announcement capability. Voices are played back from sound files stored in, for example, a memory device 358 (e.g., a protected flash Read Only Memory (ROM), an Electrically Erasable Programmable ROM (ELEPROM), etc.). In a preferred embodiment, voice sound files are pre-recorded. However, the user can record custom sound files via the built-in microphone 336, as will be appreciated by those skilled in the relevant art(s).

In a preferred embodiment, the devices 102a-102d include a unique device identification (ID) number stored in a memory device thereof. For example, the device ID number of the MAU 102a is stored in the memory 358. The MAU 102a also includes a state machine (e.g., an eight-byte state machine implemented via the microcontroller 306 and the memory 358) to keep track of an internal status of the MAU 102a and the remote devices 102b-102d. Conditions or states of the system 100 may be tracked (e.g., using one bit per state) with the state machine. In one embodiment, a bit is set to zero for normal or default conditions, and a bit is set to one for unusual, abnormal or error conditions. State information may be stored in the memory 358.

The state information for the MAU 102a may include, for example, states related to the status of switches and buttons of the MAU 102a, such as a panic button is open/closed state, a power switch is open/closed state, a learn button is open/closed state, etc. (e.g., based on selection of the user control buttons 344). The state information may further include, for example, states related to internal conditions of the MAU 102a, such as panic alert cleared/un-cleared states, burglar alarm cleared/un-cleared states, medical alert cleared/un-cleared states, learn mode off/on states, alarm system 100 armed/disarmed states, motion detect cleared/motion detect states (e.g., based on the PIR motion detector 302), microphone 336 powered on/off states (e.g., based on the microphone 336 and controller 334), etc.

The state information may also include, for example, states related to power status of the MAU 102a, such as an AC power detected/not detected state, a battery fully charged/low battery detected state, a battery operating/time to replace state, a power supply operating/failure state, etc. (e.g., based on a power supply 360 including AC/DC power 360a and backup battery 360b, power management circuit 362, power supply conditioner 364, battery charger 366, AC power conditioner 368).

The state information additionally may include, for example, states related to phone line status of the MAU 102a, such as a phone line detected/not detected state (e.g., based on a phone line detect circuit 324), a dial tone present/not present state (e.g., based on the phone line detect circuit 324), an on hook/off hook state (e.g., based on an on/off hook detect circuit 326), a busy signal/no busy signal state (e.g., based on a busy detect circuit 322), a ringing/no ringing state (e.g., based on the ring detect circuit 316), a MAU 102a using/not using phone line state, a waiting for DTMF/DTMF received state (e.g., based on the DTMF input 330 and output 332 circuits), etc. In addition, the MAU 102a may be configured to detect, for example, stutter/steady dial tones, if the telephone line is in use by another phone, call waiting tones, a hang up by another phone (e.g., based on the phone line detect circuit 324 and the on/off hook detect circuit 326), etc.

The state information also includes, in one embodiment, the state information of the remote devices, including the satellite alarm units 102b, keyfobs 102c, and other remote devices 102f. In a further embodiment, the MAU 102a may store state information for all of the devices within the FES 102 and for the FES 102 in general.

As previously discussed, in a preferred embodiment, DTMF tones are used in communications between the MAU 102a and a user of the alarm system 100, the server 104a, and/or the central monitoring center 104d. The international DTMF standard has 16 tones. Twelve of the tones are associated with the 12 keys on a standard telephone keypad (0-9, * and #). The four additional tones are associated with keys called A, B, C, and D that are not found on standard telephone keypads.

A numeric value is assigned to each tone. The keys 1-9 have numeric values 1-9, the key 0 has numeric value 10, the keys *, #, A, B, and C have numeric values 11-15, and the key D has numeric value 0. These numeric values can be used for computing checksums. The numeric values associated with DTMF tones are sometimes written in hexadecimal, rather than decimal format, so that a single character can be used to represent each value.

In the context of the present invention, the keypad designation (0-9, *, #, and A-D) for the DTMF tones are referred to rather than the hexadecimal values thereof.

The state information further may include, for example, states and parameters that can be set by, for example, a supercall received by the MAU 102a over the communications network 108, such as dial phone number normally/dial 9 and pause 1 second before dialing states, dial phone number normally/dial 8 and pause 1 second before dialing states, do not dial *70 before dialing/dial *70 and pause 200 ms before dialing states, audible/silent burglar alarm states, audible/silent panic alert states, report events to the central monitoring center 104d (default state)/disable calls to the central monitoring center 104d states, alarm system 100 activated/deactivated states, report/do not report AC power loss states, etc.

For assisting in the understanding of the present invention, the word “Supercall” refers to a call placed to an MAU to set operating parameters or request system information. “Supercall” is a device that can perform a Supercall. Additional states and parameters that can be set by a supercall include, for example, duration of entry and exit delays, having programmable values (e.g., 5, 10, 15, 20, 30 (default entry delay), 40, 50, 60 (default exit delay), 70, 80, 90, 100, 120, 140, 160, 180 seconds), a parameter that specifies a maximum number of calls that can be placed by the MAU 102a to the central monitoring center 104d in one arming period, having programmable values (e.g., 0 (no calls), 1, 2 (default), 3, 4, 5 calls), power failure reporting, phone numbers for the alarm system provider 104a and the central monitoring center 104d, alarm system 100 user passcode. Additionally, a Supercall can request a report on the system status of an MAU 102a and/or the remote devices 102b-102d in its family—this is referred to as a state dump. State dumps are described in more detail below.

In addition, the MAU 102a receives and stores state information from the remote devices 102b-102d. The remote devices, the satellite devices 102b, the keyfob remote devices 102c and other devices 102d, communicate with the MAU 102a by, for example, radio RF transmissions (e.g., conforming to FCC Part 15). Additional remote RF devices 102d (e.g., smoke detectors, gas detectors, water detectors, sound detectors, etc.) can be added to the alarm system 100 for future expansion.

The remote devices 102b-102d communicate with the MAU 102a using a predetermined protocol for RF data communications. Such protocol includes, for example, a packet structure and error correction protocol, as further described below.

The MAU 102a keeps track of the ID number and state of all known (or learned) remote devices 102b-102f. The set of all learned remote devices is referred to as the MAU 102a “family” of devices. The number of remote devices for which the MAU 102a can store information will generally be determined by the amount of available memory 307 and/or ROM 358. In one embodiment the MAU 102a can store state information for up to 16 remote devices 102b-102d

In one embodiment, the remote devices use a predetermined format for transmitting state data to the MAU 102a. The format for transmitting state data may include, in one embodiment, the ID number of the device, information describing the type of device (e.g. satellite alarm unit 102b, keyfob 102c, other remote device 102d, etc.), and state information of the transmitting device.

The remote devices 102b-102d may include a “heartbeat” function. If a remote device 102b-102d has a heartbeat function, it maintains a heartbeat timer that has a predetermined duration (e.g. 60 minutes). Each time the remote device 102b-102d transmits a packet, it resets the heartbeat timer. If the heartbeat timer times out, the remote device 102b-102d transmits a “heartbeat” packet.

In the MAU 102a, heartbeat status of remote devices may be kept track of with a heartbeat bit (one such bit for each remote device that employs the heartbeat function) in the memory 358. The heartbeat bit may be set (e.g., to 1) every time state information is transmitted to the MAU 102a. Upon setting of the heartbeat bit, the MAU 102a may start a “missing heartbeat” timer of a pre-determined duration that will be longer than the duration of the heartbeat timer in the remote devices 102b-102d. The heartbeat timer, for example, is implemented in software via the microcontroller 306 and the memory 358.

Accordingly, the MAU 102a listens for heartbeats from the remote devices 102b-102d and maintains respective missing heartbeat timers (e.g., at two times the interval of the heartbeat timers of the remote devices 102b-102d) for every remote device 102b-102d. The respective missing heartbeat timers are reset when the MAU 102a receives a radio packet from the corresponding remote devices 102b-102d. If a missing heartbeat timer of the MAU 102a times out for a remote device in the family, the MAU 102a, for example, annunciates the problem via the speaker 342 (e.g., “REMOTE DEVICE NUMBER # IS NOT REPORTING,” where # corresponds to the non-responding remote device) and blinks the status LED 346.

The family 102a-102d of devices of the alarm system 100 may include, for example, data that identifies the devices and some or all of their operating or user interface parameters, such as device ID numbers, serial numbers, passcodes, account ID numbers, etc., that are associated with each of the devices 102a-102d. The master product database 104c maintained by the BES 104 keeps track of some or all of such numbers for each alarm device 102a-102d of one or more of the FESs 102.

Besides the unique device ID number assigned to each device, phone numbers (e.g., 12 digits, toll free, 8XX) to be dialed by the MAU 102a to report state information (e.g., to the web server 104a, to the central monitoring center 104d, to be stored in the database 104c, etc.) can be programmed (e.g., pre-programmed prior to distribution) in the memory 358. In addition, a unique account ID associated with a user of the FES 102, and used to bring up account information and history of the user for retrieval via the web server 104a, can be programmed in the memory 358.

Further, a user passcode to allow the user to access the MAU 102a of alarm system 100 remotely via the user access devices 106a, 106b, by phone, etc., over the communications network 108 can be programmed in the memory 358. Moreover, a super passcode to allow the alarm system 100 provider and/or the central monitoring center 104d to access the MAU 102a of the FES 102 to set device parameters remotely (e.g., via the user access devices 106a, 106b) over the communications network 108, can be programmed in the memory 358.

There are also provided user confirmation passwords that the user selects to confirm identity to the web server 104a and/or the central monitoring center 104d.

The user passwords or passcodes are assigned to respective account IDs. The user passwords are employed, for example, by the central monitoring center 104d to verify the user's identity, for example, after a respective MAU 102a phones the central monitoring center 104d to report an alarm condition. The user can set the passwords when the user registers for the alarm system 100 service.

Means may be provided for making an electronic connection between a remote programming device (not pictured) and the microcontroller 306 and/or memory 307 or ROM 358 of the MAU 102a. For example, a cable, such as a serial cable, etc., can be connected to the microcontroller 306 of the MAU 102a via a serial port 372. The serial port 372 provides access to the microcontroller 306 and, for example, is preferably not accessible by the user. The electronic connection, for example, may be used for testing the MAU 102a during development and production, and for reprogramming or updating device software, firmware and/or operating parameters. In addition, device software of the MAU 102a can be programmed, updated or re-programmed, for example, via the phone line over the communications network 108, as will be appreciated by those skilled in the relevant art(s).

The power management circuit 362 provides power to the MAU 102a electronics. The power management circuit 362 monitors the status of an AC/DC adapter 360a. The power management circuit 362 switches to the backup battery 360b power if the AC power to the AC/DC converter 360a is lost. The power management circuit 362 also takes care of the battery 360b maintenance (e.g., recharging). In one embodiment, the power management circuit 362 may be further configured to determine if the backup battery 360b is good, bad, or low. The power management circuit 362 may make this determination periodically, in one embodiment, even if the MAU 102a is using AC power at the time. If the backup battery 360b is low or bad, the MAU 102a may be configured to report the backup battery 360b status to the monitoring service 104d, for example, using the supercaller apparatus 104j. By reporting a low or bad backup battery 360b status, the monitoring center 104d or customer service 104k may notify the system 100 user of the backup battery 360b status.

A default source of power is from the external power supply. The battery 360b (e.g., lead-acid battery) provides an uninterruptible source backup of power. If the MAU 102a is powered on and if AC power is lost to the converter 360a, the power management circuit 362 switches to the battery 360b power. The power management circuit 362 monitors for presence of AC power, and switches back to AC power when restored.

The power management circuit 362 is functional whenever power is present, regardless of the on/off state of the MAU 102a electronics.

The power management circuit 362, for example, tracks the following conditions and reports them to the microcontroller 306: AC power lost or restored, battery 360b fully charged or low charge, power supply operating or bad, battery 360b operating or needs replacement, etc. In one embodiment of the present invention, the MAU 102a reports low power or bad battery conditions to the central monitoring 104d third party. In this way, the central monitoring 104d third party may contact the user to notify the user of a battery that is not functioning properly.

As previously mentioned, the backup battery 360 provides power to the MAU 102a in the event of a loss of AC power. In a preferred embodiment, the backup battery 360 is a rechargeable battery (e.g. a lead-acid battery). Over time, batteries may lose capacity, even if they are recharged regularly. If the capacity of the backup battery 360 drops below some level, it can no longer effectively perform the backup function. Therefore is it desirable and beneficial to be able to determine when the capacity a backup battery 360 has dropped below a level that has been determined to be the threshold level between “good” and “bad” battery. (This threshold level is a function of the nominal voltage of the battery and the battery chemistry as will be appreciated by those with skill in the art.) A means of determining whether the battery is good or bad is to provide means of isolating the backup battery 360 from the AC/DC power source 360a, and then applying a known load to the backup battery 360 for a known duration of time, and measuring the voltage of the battery at the end of the period of applied load. It is not desirable to perform this test too frequently, as each time the test is performed it detracts from the remaining life of the battery. But it is desirable to perform the test regularly enough to detect a bad battery and warn the user of the condition early enough to allow the user to install a replacement battery before the current battery fails completely. If the system contains a real time clock, it is relatively easy to program the system to perform a battery check on a regular interval, e.g. once every 30 days. However not all systems have real time clocks. In a preferred embodiment, to detect a bad battery, the MAU 102a keeps a count (e.g. with a “battery test counter”) of the number of times it has been disarmed. Each time the battery test counter reaches a certain number (e.g. 30), the MAU 102a performs the battery load test. For example, if we assume the system is generally armed and disarmed once per day, and if the battery load test is programmed to be performed each time the battery test counter reaches 30, the condition of the battery will be checked approximately once every 30 days. (Following a battery load test, the counter is reset to zero.) In the absence of a real time clock this provides an effective means of monitoring the condition of the battery. Other events (rather than disarming the system) can be used to trigger the battery load test, such counting the number of times the system is armed; or each time the system receives a User Call (described below); etc.

An initial state of the MAU 102a is powered off. When the power switch is pressed, the MAU 102a electronics wake up and run boot-up and self-test routines. Following a successful power-on, boot-up and self-test, the MAU 102a, for example: sends power to a light in the panic button, blinks the status LED 346, powers the emergency light 354 briefly, chirps the speaker 342, starts up an event manager (e.g., implemented in software) for controlling the MAU 102a, annunciates “ALARM ON,” powers up the radio receiver 304 and the PIR motion detector 302 (e.g., which preferably are powered on whenever the MAU 102a is powered on), and goes into the disarmed state (e.g., the default state of the powered up MAU 102a).

The event manager includes a main event loop for monitoring, for example, the following states: the AC power status, the battery 360b charge state, the condition of the power supply, the condition of the battery 360b, signals from the PIR motion detector 302, signals from the radio, abnormal state flags (e.g., the status LED 346 is blinked if an abnormal state is detected), input from the panic button, switch debouncing, input from the power switch, input from the learn button, presence of the phone line, detection of ringing on the phone line, heartbeats of the remote device 102b-102d, etc.

System software in the memory 358 manages, for example, the following device input/outputs (I/O's), based on events that occur during the main event loop: incoming radio signals, phone line signals (e.g., incoming, outgoing, off-hook, busy, etc.), output to the DTMF generator 332, voice annunciations, output to the speaker 342, output to the LEDs 346, and 350, output to the emergency light 354, spare outputs for future expansion, interrupts, etc.

The MAU 102a reports, for example, via a phone call, the following events to the central monitoring center 104d: burglar alarms, panic alerts, silent burglar alarms, silent panic alerts, etc., from the MAU 102a or the satellite units 102b. The MAU 102a also reports, for example, loss of AC power, restoring of AC power, low battery, restored battery, canceling of alarm or panic alert, etc., of the MAU 102a. The MAU 102a also reports, for example, glass break detection, smoke alarms, door/window open detection, carbon monoxide detection, etc., from the other remote devices 102d.

In a preferred embodiment, signals are sent from the MAU 102a to the central monitoring center 104d, for example, by DTMF tones over a standard phone line, but other signaling can be employed (e.g., over the Internet, etc.), as will be appreciated by those skilled in the relevant art(s). When a state occurs that requires a report to the central monitoring center 104d, the MAU 102a, for example, calls a Call-Station subroutine and sends the appropriate codes (e.g., that conform to the Ademco Contact ID standard).

To transmit codes to the central monitoring center 104d, the MAU 102a, for example, maintains a First In First Out (FIFO) queue, a call-queue in the memory 358, and whenever an event occurs that requires reporting, generates a call-byte identifying the event. As call-bytes are generated, they are placed in the call-queue. Whenever a call-byte is placed in the call-queue, the MAU 102a will initiate a call to the monitoring center 104d to report the event. If the MAU 102a is already on a call to the central monitoring center 104d at the time a call-byte is placed in the call-queue, the MAU 102a processes all call bytes in the call queue, and, for example, does not hang-up the call until the call-queue is emptied. In a preferred embodiment, if an emergency condition occurs (e.g. a motion detect while the system is armed or a Panic), and if there are already call-bytes in the call-queue, the call-byte for the emergency condition is placed at the head of the call-queue so that it will be processed before the other (non-emergency) conditions in the queue.

In a preferred embodiment, a data format for reporting events to the central monitoring center 104d, for example, conforms to a digital communication standard, such as the Ademco Contact ID standard, etc. The Ademco standard for an event message, for example, has the following format:

ACCT 18 QXYZ GG CCC

The first four digits (e.g., ACCT) are the Account ID. The next two digits are 18. The next four digits are the event qualifier (e.g., Q) and the event code (e.g., XYZ). The next two digits are the Group number (e.g., GG), and the final three digits are the Zone number (e.g., CCC). In a modification of the Ademco CID protocol, the MAU 102a may use the Group number to report the device type, and the Zone number to report the device number.

The MAU 102a also is capable of handling abnormal events or conditions internal to the MAU 102a, such as abnormal AC power conditions. For example, if the MAU 102a determines loss of AC power, the MAU 102a sets the AC power bit to 1, sets a flag for blinking the status LED 346, annunciates “NO AC POWER,” and turns on the emergency light 354 (e.g., for 7 minutes). Then the MAU 102a, for example, puts an AC Power Out byte in the call-queue.

If AC power is restored to the MAU 102a, the MAU 102a, for example, sets the AC Power bit to 0, and clears the flag for blinking the status LED 346. Then the MAU 102a, for example, puts an AC Power On byte in the call-queue. If the power management circuit 362 reports a failed power supply, the MAU 102a, for example, sets the Power Supply bit to 1, and sets the flag for blinking the status LED 346. In a preferred embodiment, this condition is annunciated (e.g., “AC ADAPTER PROBLEM”) when, for example, the disarm button is pressed.

The MAU 102a also is capable of handling abnormal events or conditions internal to the MAU 102a, such as abnormal battery 360b conditions. For example, if the power management circuit 362 reports a low battery 360b in the MAU 102a, the MAU 102a sets the Battery Charge bit to 1, puts an MAU Low Battery byte in the call-queue, and sets the flag for blinking the status LED 346. If the power management circuit 362 reports that the battery 360b is restored in the MAU 102a, the MAU 102a, for example, sets the Battery Charge bit to 0, puts an MAU Restored Battery byte in the call-queue, and clears the flag for blinking the status LED 346.

If the power management circuit 362 reports a bad battery 360b, the MAU 102a, for example, sets the Battery Condition bit to 1, and sets the flag for blinking the status LED 346. In one embodiment, this condition is annunciated (e.g., “REPLACE BATTERY IN MASTER ALARM UNIT”) when, for example, the disarm button is pressed.

Additionally, in another embodiment, if there are any abnormal states, the MAU announces them whenever it receives a disarm packet. This is part of the novel and simple user interface of the alarm system 100. Instead of having to read obscure numeric codes on a tiny hard-to-read LCD) the user sees a blinking status light (indicating an abnormal condition), pushes disarm on a keyfob 102c, and a voice announces the abnormal state(s). An alternative embodiment triggers a report of system status if the disarm button is pressed three times in fairly rapid succession. There are a variety of ways to trigger a report of system status—the novel aspect is that it is easy for the user to get the report—it is announced in plain language following a simple button press, rather than being a numeric code (or cryptic abbreviation) displayed on a tiny LCD (which is the industry standard).

If the phone line is not detected, the MAU 102a, for example, sets the Line Fault bit to 1, sets the flag for blinking the status LED 346, and, for example, annunciates “NO PHONE LINE.” If the phone line is present while phone line bit=1, the MAU 102a, for example, sets the Line Fault bit to 0, clears the flag for blinking the status LED 346, and, for example, annunciates “PHONE LINE RESTORED.” In one embodiment, the user may activate an audible annunciation of the status of the system communications by pressing a button on the keyfob 102c.

Then the MAU powers up, it checks, for presence of a phone line. If no phone line is present, the MAU assumes the system will not be connected to a phone line, and it goes into a “no event reporting” mode in which it does not attempt to place calls to the monitoring center. For users who don't want a connection to the monitoring service, this prevents the MAU from incessantly warning them that no phone line is present. If a phone line is present when the MAU powers up, the system goes into normal “event reporting” mode. Thus, the MAU automatically checks for presence of phone line at power up and toggles into one of two operating modes depending on whether a phone line is present or not. This simplifies the installation and set-up processes for the end user.

The MAU 102a also is capable of handling abnormal events or conditions, such as abnormal events that occur while the MAU 102a is in a telephone communications mode. For example, if a valid panic signal is received while handling an incoming call (e.g., from the user or a supercall), the MAU 102a sets the panic bit to 1, annunciates over the phone line “PANIC SIGNAL RECEIVED. GOOD-BYE,” goes On Hook and pauses to allow a complete hang-up, and handles the event. In a preferred embodiment, if a Panic or Burglar alarm is received while the MAU 102a is on a supercall, no annunciation is made and the call is terminated according to the supercall protocols.

If the armed bit is set to 1 and a valid Alarm signal is received while handling an incoming call (e.g., from the user or a supercall), the MAU 102a, for example, sets the alarm bit to 1, annunciates over the phone line “ALARM SIGNAL RECEIVED. GOOD-BYE,” goes On Hook, and pauses to allow a complete hang-up, and handles the event. If a smoke, flood, carbon monoxide, etc., signal us received while handling an incoming call (e.g., from the user or a supercall), the MAU 102a, for example, writes the new state information to the memory 358, annunciates over the phone line “ALARM CONDITION RECEIVED. GOO D-BYE,” goes On Hook and pauses to allow a complete hang-up, and handles the event according to the Disarmed mode procedure.

If the MAU 102a is reporting an event to the central monitoring center 104d, and additional state change information is received, if the state change information requires sending a code to the central monitoring station, the MAU 102a, for example, looks up the code for the new condition and compares it to the list of codes that have been sent to the central monitoring center 104d on the present call. If the new code has not already been sent, then the MAU 102a, for example, adds the new code to the queue of codes to be sent on the present call. In other words, if event codes are received while the MAU 102a is on a call to the central monitoring center 104d, the MAU 102a filters out any codes that have already sent, and sends all others.

The MAU 102a also is capable of handling abnormal events or conditions reported from the remote devices 102b-102d, such as abnormal events or conditions related to the AC power of the remote devices 102b-102d. For example, if one of the remote device 102b-102d loses AC power, the MAU 102a stores the state data in the memory 358, sets the flag for blinking the status LED 346, and annunciates “SATELLITE (REMOTE DEVICE) NUMBER # HAS LOST POWER.”

If one of the remote devices 102b-102d regain AC power, the MAU 102a, for example, stores the state data in the memory 358, clears the flag for blinking status LED 346, and annunciates “SATELLITE (REMOTE DEVICE) NUMBER # HAS REGAINED POWER.” If one of the remote devices 102b-102d reports a failed power supply, the MAU 102a, for example, stores the state data in the memory 358, sets the flag for blinking the status LED 346, and annunciates “AC ADAPTER PROBLEM ON SATELLITE (REMOTE DEVICE) NUMBER #.” In a preferred embodiment, this condition is annunciated when, for example, the disarm button is pressed.

The MAU 102a also is capable of handling abnormal events or conditions reported from the remote devices 102b-102d, such as abnormal events or conditions related to a battery of the remote devices 102b-102d. For example, if one of the remote devices 102b-102d reports a low battery condition, the MAU 102a stores the state data in the memory 358, sets the flag for blinking the status LED 346, and annunciates “LOW BATTERY ON REMOTE DEVICE NUMBER #.” In a preferred embodiment, this condition is annunciated when, for example, the disarm button is pressed.

If one of the remote devices 102b-102d reports that the battery is restored, the MAU 102a, for example, stores the state data in the memory 358, and clears the flag for blinking the status LED 346.

If one of the remote devices 102b-102d reports a bad battery, the MAU 102a, for example, stores the state data in the memory 358, sets the flag for blinking the status LED 346, and annunciates “REPLACE BATTERY ON SATELLITE (REMOTE DEVICE) NUMBER #.” In a preferred embodiment, this condition is annunciated when, for example, the disarm button is pressed. If one of the remote devices 102b-102d reports that the battery has been replaced (e.g., the Battery Condition bit changes from 1 to 0), the MAU 102a, for example, stores the state data in the memory 358, and clears the flag for blinking the status LED 346.

In one embodiment, remote devices do not report when their batteries have been replaced. It can be difficult and expensive to keep track of that through the power cycle that is necessary to replace batteries. Because remote device can report low batteries but can't report replaced batteries, a protocol was developed for to turn off the condition in the MAU that reports a low battery in a remote device 102b-102d. The MAU sets the “low battery in remote device” bit to zero every time it announces it, and the remote device keeps sending packets reporting low batteries (once per hour) for as long as the batteries are low. This achieves the desired goal: The user gets bugged about low batteries for as long as they are low, the MAU sets the condition to zero as soon as it reports it, and we didn't have to add the ability to write to EEPROM in the remote devices (which saves cost and code space) to keep track of changes in battery condition through power cycles.

The MAU 102a also is capable of handling abnormal events or conditions reported from the remote devices 102b-102d, such as abnormal events or conditions related to a bypass mode of the remote devices 102b-102d. For example, if one of if one of the remote devices 102b-102d reports that it has been placed in a bypass mode (e.g., via a bypass switch), the MAU 102a stores the state data in the memory 358, sets the flag for blinking the status LED 346, and annunciates “SATELLITE (REMOTE DEVICE) NUMBER # IS BYPASSED.” If one of the remote devices 102b-102d reports that it has been taken out of the bypass mode, the MAU 102a, for example, stores the state data in the memory 358, clears the flag for blinking the status LED 346, and annunciates “SATELLITE (REMOTE DEVICE) NUMBER # IS ACTIVE.”

The MAU 102a also is capable of handling abnormal events or conditions reported from the remote devices 102b-102d, such as abnormal events or conditions related to one of the remote devices 102b-102d powering on or off. For example, if one of the remote devices 102b-102d reports that it is powering off, the MAU 102a stores the state data in the memory 358, sets the flag for blinking the status LED 346, and annunciates “SATELLITE (REMOTE DEVICE) NUMBER # IS POWERING OFF.” If one of the remote devices 102b-102d reports that it is powering on, the MAU 102a, for example, stores the state data in the memory 358, clears the flag for blinking the status LED 346, and annunciates “SATELLITE (REMOTE DEVICE) NUMBER # IS POWERING ON.” In one embodiment of the invention, a burglar alarm is triggered if a satellite alarm unit 102b is powered off or bypassed while the MAU 102a is armed.

The MAU 102a also is capable of handling abnormal events or conditions reported from the remote devices 102b-102d, such as abnormal events or conditions related to one of the remote devices 102b-102d missing the heartbeats. For example, if the timeout interval for heartbeats for one of if one of the remote devices 102b-102d has expired, the MAU 102a stores the state data in the memory 358, sets the flag for blinking the status LED 346, and annunciates “SATELLITE (REMOTE DEVICE). NUMBER # IS NOT REPORTING.” In a preferred embodiment, this condition is annunciated when, for example, the arm or disarm button is pressed.

Then in the Disarmed mode, the MAU 102a detects radio signals and motion from the PIR motion detector 302. The MAU 102a enters the Disarmed mode, for example, as a default state following a successful power-up of the MAU 102a, or when the MAU 102a detects a valid Disarm command from a keyfob unit 102c in its “family”, or when the MAU 102a receives a disarm command during an incoming call session from the user (described below), or when the MAU 102a receives an emergency disarm command (described below).

Upon entering the Disarmed mode, the MAU 102a, for example, sets the Swinger Count value, corresponding to the number of calls that have been placed to the central monitoring center 104d, and the Tap Count value, corresponding to the number taps detected in the emergency disarm routine, to zero. In a preferred embodiment, the Swinger Count value is reset to zero every time the MAU 102a receives a disarm command.

If the Unreported Alarm or Unreported Panic bit=1 when the MAU 102a enters disarmed mode, then the MAU 102a, for example, annunciates “THERE WAS AN UNREPORTED ALARM (OR PANIC),” and resets the Unreported Alarm/Panic bit to zero. In a preferred embodiment, if the Disarm command came from a user call, the MAU 102a makes the annunciation over the phone line.

In addition, while in Disarmed mode, the MAU 102a, for example, accepts input from the panic button, the power switch, and the learn button. In a preferred embodiment, the PIR motion detector 302 is looking for motion and blinking, even while the MAU 102a is disarmed.

Further, the MAU 102a responds to inputs in the Disarmed mode as follows. For example, if the power switch is pressed while the MAU 102a is in the Disarmed mode, the MAU 102a calls a Power-off subroutine. If the panic button is pressed, the MAU 102a, for example, puts a Panic call-byte at the head of the call-queue, and calls an Alarm subroutine. If the learn button is pressed, the MAU 102a, for example, enters Learn mode. If a telephone ring is detected on the phone line, the MAUI 102a, for example, calls an Incoming Call subroutine (described below).

If a valid transmission is received from one of the known remote RF devices 102b-102d while the MAU 102a is in the Disarmed mode, the MAU 102a, for example, stores the state data in a memory location of the memory 358 allocated to the reporting device, and takes any necessary actions. For example, if a panic signal is received from a known satellite unit 102b or keyfob unit 102c while the MAU 102a is in the Disarmed mode, the MAU 102a puts a Panic call-byte at the head of the call-queue, and calls the Alarm subroutine. If a motion signal is received from a known satellite 102b, or if a glass break detect signal or premise entry detect signal is received from a known remote device 102b-102d while the MAU 102a is in the Disarmed mode, the MAU 102a, for example, does nothing (because the system is not armed).

If a medical alert signal is received from a known remote device 102b-102d while the MAU 102a is in the Disarmed mode, the MAU 102a, for example, puts the Medical Alert call-byte at the head of the call-queue, and calls the Alarm subroutine. If a smoke, flood, carbon monoxide, etc., signal is received from a known remote device 102b-102d while the MAU 102a is in the Disarmed mode, the MAU 102a, for example, puts the appropriate call-byte in the call-queue, then calls a Fire Alarm subroutine.

If a known satellite unit 102b reports a change in state corresponding to an abnormal condition (e.g., bypass switch pressed, power switch pressed, loss of AC power, low battery, etc.) while the MAU 102a is in the Disarmed mode, the MAU 102a handles such condition as previously described. If a remote device 102b-102c sends a heartbeat signal (e.g., heartbeat bit=1) while the MAU 102a is in the Disarmed mode, the MAU 102a, for example, resets the heartbeat timer for that device to zero.

If a remote device 102b-102d sends a test signal (e.g., test bit=1) while the MAU 102a is in Disarmed mode, the MAU 102a, for example, annunciates “SATELLITE (REMOTE DEVICE) NUMBER # TESTING OK.” If an Arm command is received while the MAU 102a is in Disarmed mode, the MAU 102a, for example, initiates the arming routine (described below). If the MAU 102a receives a valid Disarm signal, the MAU 102a, for example, annunciates the state of the MAU 102a and any/all existing abnormal conditions in the system.

If the MAU 102a is disarmed and it receives a valid arm command, it initiates an arming routine as follows: Before the MAU 102a enters the Armed mode, if the MAU 102a has received a valid Arm command and if the System Deactivated bit=1, then the MAU 102a, for example, annunciates “SYSTEM IS DEACTIVATED,” sets the Armed bit to zero, and returns to the Disarmed mode. Such annunciation is made by the MAU 102a over the speaker 342 or the phone line, depending on how the MAU 102a is being armed.

In a preferred embodiment, if the system is not deactivated and the MAU 102a receives a valid arm command (while disarmed), the MAU 102a checks for any abnormal conditions. If any abnormal conditions exist, the MAU 102a will not enter armed mode immediately. Rather it will announce the conditions and give the user the option to remedy the abnormal conditions, or to proceed directly arming by sending the arm command again (preferably within a predetermined amount of time, e.g. within 10 seconds).

Therefore, in a preferred embodiment, if any abnormal conditions exist (e.g. bypassed Satellite, low batteries, missing heartbeats, etc.) before the MAU 102a enters the Armed mode, the MAU 102a, for example, annunciates those conditions followed by “FIX THE CONDITION OR PRESS THE ARM BUTTON AGAIN TO FORCE ARMING.” If the user is arming the MAU 102a from a telephone, the MAU 102a, for example, annunciates “FIX THE CONDITION OR PRESS ONE AGAIN TO FORCE ARMING.” If another valid Arm command is received within a predetermined time period (e.g., 5 seconds), the MAU 102a, for example, proceeds to the Arming Process or otherwise remains in the Disarmed mode. If no abnormal conditions exist, the MAU 102a, for example, goes directly to the Arming Process.

There is an “exit delay” period (e.g. of 60 seconds) after the MAU receives a valid arm command, but before the MAU enters armed mode. This allows the user time to leave the premises. The MAU 102a may provide feedback to the user during the exit delay by making warning tones, blinking lights, or announcing a countdown timer to the instant of arming. Upon starting the exit delay, the MAU 102a, for example, accepts input from the panic button, ignores input from the power switch and the learn button and maintains these switch input criteria until the system is disarmed (e.g., the MAU 102a cannot power off or enter learn mode while armed).

After the exit delay has expired (e.g., the Armed mode has started), the MAU 102a, for example, blinks the LED 350 continuously while the MAU 102a is armed (e.g., indicating that the MAU 102a is armed). While the MAU 102a is armed, motion can be detected via the PIR motion detector 302 and motion, glass breakage, premises entry, and other triggering events may be detected via any of the known remote devices 102b-102d. If detection of an intruder event is made from a remote device 102b-102d, the MAU 102a, for example, updates the state information for that device. Then, for the duration of the Entry Delay (e.g., with a default value of 30 seconds) and if the Silent Burglar alarm bit=0, the MAU 102a, for example, emits warning tones over the speaker 342, and the LED 350 is made to blink in an arming pattern. (If the Silent Burglar Alarm bit=1, then warning tones are note emitted during the entry delay period.) If a valid Disarm command is received before the end of the Entry Delay, the MAU 102a, for example, stops the tones and turns off the LEDs 346 and 350, sets the Arm bit to zero, and goes into the Disarmed mode. Otherwise, after the Entry Delay has expired, the MAU 102a, for example, sounds the siren 310 (e.g. for 5 minutes) and (if the swinger shut down feature has not been implemented), and puts an Alarm call-byte at the head of the call-queue. (If the Silent Burglar Alarm bit=1, then the siren is not sounded.) To assist the understanding of the present invention, “Swinger” is an industry term for alarm systems that report repeated false alarms. “Swinger shutdown” refers to a method for preventing swingers from reporting an excessive number of false alarms. In a preferred embodiment, swinger shutdown may be controlled by one parameter (“SwingerMax”) and one counter (“SwingerCount”). SwingerMax sets an upper limit on the number of alarms that may be reported in one arming period (the period of time between when the system is armed and the system is disarmed). In a preferred embodiment, the default value of SwingerMax is 2. SwingerCount counts the number of times alarms have been reported in the current arming period. In a preferred embodiment, SwingerCount is reset to zero each time the system is disarmed. In another preferred embodiment, Swingercount is incremented only when burglar alarms are reported. In another preferred embodiment, the value of SwingerMax can be changed by Supercall.

If a Panic or Medical Alert signal is detected by the MAU 102a while the MAU 102a is armed, and if the signal came from a remote device 102b-102d, the MAU 102a, for example, updates the state information for that device in the memory 358, sets the Panic or Medical bit to 1, calls the Alarm subroutine, and puts a Panic or Medical Alert call-byte at the head of the call-queue. Then, when the Call Monitoring Service subroutine is complete, and if the Panic or Medical Alert event was successfully reported, sets the Panic or Medical Alert bit to zero. If a smoke, flood, carbon monoxide, etc., signal is detected while the MAU 102a is armed, the MAU 102a, for example, puts a smoke, flood, carbon monoxide, etc., call-byte in the call-queue, and calls the Fire Alarm subroutine.

If a change of state signal (e.g., other than a burglary, panic, medical alert, fire alarm event) is received from a known satellite unit 102b while the MAU 102a is armed, the MAU 102a, for example, updates the state information for the satellite unit 102b in the memory 358, and handles the event as previously described with respect to abnormal event or conditions. If telephone ringing is detected while the MAU 102a is armed, the MAU 102a, for example, calls the Incoming Call subroutine (described below). If an Arm command is received while the MAU 102a is armed, the MAU 102a, for example, annunciates “ALARM SYSTEM IS ARMED,” and remains in the Armed mode. If a valid Disarm command is received while the MAU 102a is armed, the MAU 102a, for example, sets the Armed bit to zero, and goes into the Disarmed mode.

The Alarm subroutine is a routine employed by the MAU 102a to, for example, handle a burglar alarm, a panic alarm, a medical alert, etc. The term alarm/panic/medical refers to either of alarm, panic, or medical alerts, depending on which event called the routine. If the MAU 102a detects an alarm condition, it does the following: If the System Disabled bit=1, the MAU 102a, for example, sets to zero the bit that caused the alarm subroutine to be executed. The Alarm subroutine, for example, next checks the Silent Burglar or Silent Panic bit (e.g., whichever one is relevant) to see if they have been set.

For Silent Burglar alarms, for example, the siren 310 is not sounded. For Silent Panic alarms, for example, the siren 310 is also not sounded. If the relevant Silent Alarm bit is not set, the Alarm subroutine sounds the burglar alarm (e.g., the siren 310) for a predetermined period of time (e.g., 5 minutes) and may also flash the LED bar 350 in the alarm pattern. In a preferred embodiment, the LEDs 350 are flashed in the alarm pattern until the MAU 102a is disarmed in order to notify the user when they come home that there was a problem while they were away.

If the Power switch is pressed, while the system is armed, the Alarm subroutine calls the Emergency Disarm subroutine (described below). If a valid disarm command is received before the Alarm is finished (e.g., after 5 minutes), the Alarm subroutine, for example, turns off the siren 310 and the LEDs 350, puts a Cancel Alarm call-byte in the call-queue, sets the Armed bit to 0 and goes into the Disarmed mode, and sets the alarm/panic/medical bit to zero to indicate the alarm condition is cleared. A disarm command could come from a known keyfob unit 102c, from a phone call, from the emergency disarm procedure, etc.

The Fire Alarm subroutine is called, for example, when the MAU 102a receives a report of a smoke, fire, flood, carbon monoxide, etc., event from a remote device 102b-102d in the MAU 102a family of devices. For example, when the Fire Alarm subroutine is called, a fire alarm (e.g., preferably having a different sound than a burglar alarm) is sounded over the siren 310 for a predetermined period of time (e.g., 5 minutes), and the status LED 346 is blinked. The status LED 346 continues to blink until the condition is cleared (e.g., the Fire Alarm bit is set back to zero). The Fire Alarm condition is cleared, for example, if the MAU 102a does not detect the same event again for predetermined period of time (e.g., x minutes, where x=the value of a Fire Alarm Cleared timer).

If the status LED 346 is blinking because of an un-cleared smoke, flood, carbon monoxide, etc., condition, and the user, for example, presses the Disarm button on the keyfob unit 102c, the MAU 102a annunciates “ALARM CONDITION ON REMOTE DEVICE NUMBER #.” A fire alarm may be turned off at any time during the alarm, if the MAU 102a receives a valid disarm command.

The Call Monitoring Service subroutine is a routine employed by the MAU 102a, for example, for calling the central monitoring center 104d to report various alarm conditions, as previously described. This subroutine is called, for example, when there is a call-byte in the call-queue.

The Call Monitoring Service subroutine, in a preferred embodiment, functions as follows: When the routine is in process, it ignores incoming calls, The MAU 102a goes off-hook, checks the Dial 9, Dial 8, and Dial *70 bits to determine how to dial the phone number, and then dials the central monitoring center 104d. The Call Monitoring Service subroutine follows a predetermined communications specification (e.g., the Ademco CID protocol described above) for placing the call to and handshaking with central monitoring center 104d.

Once communication with the central monitoring center 104d is established, the Call Monitoring Service subroutine reads the first call-byte in the call-queue and sends the DTMF codes for the associated event code to the central monitoring center 104d. When the present call-byte is successfully transmitted to and acknowledged by the central monitoring center 104d, the Call Monitoring Service subroutine, for example, processes the remaining call bytes in the call-queue in a similar manner as described above until the call-queue is emptied.

If a “special” tone is received at any time during the call, the Call Monitoring Service subroutine, for example, stays off-hook and waits for initiation of a supercall (described below). The supercall initiation tone may be any tone defined or specified in a communications protocol. Otherwise, if the supercall tone is not received during the call, then after the Call Monitoring Service subroutine has reported the last event, the Call Monitoring Service subroutine, for example, initiates a disconnect procedure (e.g., the Ademco Kissoff and Hang-up procedure), and places the phone line back on hook.

There is a specific reason for having a supercall initiation tone that initiates a supercall while in the midst of a event report. There may be a user who has not paid the monitoring fees, but the BES 104 has not been able to contact the user to deactivate their system—may be they changed their phone number and we don't have the new number. If the user's MAU 102a calls to report an alarm, the computer system at the monitoring center 104d will get a report that this is a deadbeat account, and we now have a way to initiate a supercall and deactivate their system.

If the alarm/panic/medical condition was successfully transmitted to the central monitoring center 104d, then the Call Monitoring Service subroutine sets the alarm/panic/medical bit to 0. If an alarm/panic event was not sent successfully to the central monitoring center 104d, then the Call Monitoring Service subroutine maintains the alarm/panic bit at 1. In a preferred embodiment, if smoke/flood/carbon monoxide events, etc., are reported, for example, by the devices 102d, the Call Monitoring Service subroutine does not set the corresponding bits to 0, but rather sets those bits to 0 after the event is cleared, for example, by a timer or by an annunciation to the user that the alarm event occurred.

In a preferred embodiment, a plurality of phone numbers (e.g., two phone numbers) are provided for contacting the central monitoring center 104d. In this way, if a connection to the central monitoring center 104d cannot be established using one number, the MAU 102a hangs up and attempts a connection using the next number, etc. This process is continued until communication has been attempted with all of the phone numbers, in which case communication with the first number dialed is again attempted. This process is continued until a connection is established with the central monitoring center 104d, or until a communication using each number has been attempted a predetermined number of time (e.g., 4 times per number).

The Emergency Disarm subroutine is employed to execute an emergency disarm procedure in case the user is not able to disarm the system with the keychain remote control 102c. For example, this routine can be employed when user enters the front door of the premises protected by the alarm system 100 and discovers that the batteries in the keyfob 102c have expired not allowing a remote disarm of the alarm system 100 via the keyfob 102c. Accordingly, the Emergency Disarm subroutine may employ one or more counters to determine if the user presses a predetermined combination of buttons that is known to deactivate the alarm system 100. In another embodiment, the Emergency Disarm subroutine may detect a button sequence without a counter.

In one embodiment, one of the counters may activate an audible count indicator to advise the user of the number of time a user has pushed a button or set of buttons. The user may be required to press the power button, panic button, or a combination of buttons in order to deactivate the alarm system 100. The combination of buttons required to deactivate the alarm system 100 may vary depending on the device used to deactivate the system 100.

If the proper button combination is entered prior to a specified countdown period, the Emergency Disarm subroutine sets the Armed bit to zero, places the alarm in the Disarmed mode, puts a Cancel call-byte in the call-queue, and resets the counters to zero, completing the emergency disarm procedure.

In a preferred embodiment, to perform an emergency disarm (while the siren is sounding) the user presses the power button a specified number of times (preferably a randomly generated and assigned number that is printed in the user's documentation). After pressing the power button the specified number of times, the user presses the panic button once, and the system is disarmed. Alternately, the user may press the learn button multiple times to perform and emergency disarm. In a further embodiment, either the power or learn button may be pressed to perform and emergency disarm.

The Incoming Calls subroutine provides protocols for accepting incoming calls to the MAU 102a. The user of the alarm system 100 can make a call to the MAU 102a, for example, to check and/or change the state of the MAU 102a (e.g., referred to as a User Call subroutine). The server 104a and/or the central monitoring center 104d can make a call to the MAU 102a, for example, to modify device parameters (e.g., referred to as a supercall subroutine and discussed below). The Incoming Calls subroutines are executed, for example, if the MAU 102a detects a specific, predetermined ring sequence while in Disarmed or Armed modes. In a preferred embodiment, incoming calls are ignored while in Learn mode and the MAU 102a continues to accept and read RF transmissions during the Incoming Calls subroutines.

In Off-Hook/passcode subroutine of the Incoming Calls subroutines determines if, for example, one or two rings are detected. If so, the Off-Hook/passcode subroutine determines if no further ring is detected for at least M seconds, and if another ring is detected within N seconds, wherein the time interval between M and N seconds, while waiting for the next ring, is referred to as an Incoming Ring Delay interval. If the noted conditions are satisfied, the MAU 102a goes Off Hook and sends a “greeting” that preferably consists of a handshake tone and/or, for example, an annunciation of “ENTER PASSCODE” via the phone line, and waits for DTMF tones corresponding to the User and/or the Super passcodes to be received (e.g., the handshake tone is employed as a signal to a supercaller that the call has been answered by the MAU 102a, and the voice annunciation is for a human call). Following the greeting, if no DTMF tones are detected within a predetermined time period (e.g., 15 seconds), the MAU 102a goes to an On Hook state.

If DTMF tones are detected within the predetermined time period, the MAU 102a interprets the DTMF tones as they are received and compares them to the User and the Super passcodes. If a predetermined tone is detected (the “initiate Supercall” tone), the MAU 102a calls the supercall subroutine. If the User passcode (e.g., 5-digits) is detected, the MAU 102a calls the User Call subroutine. If no tones are detected during a predetermined period of time after receiving the first tone (e.g., 3 seconds), the MAU 102a annunciates “INCORRECT PASSWORD” and returns to the “ENTER PASSCODE” step for a predetermined number of further attempts (e.g., three attempts). If the predetermined number of attempts are unsuccessfully employed, the MAU 102a, for example, annunciates “GOOD-BYE,” places the MAU 102a in an On Hook state, and returns the MAU 102a to a mode indicated by the Armed bit.

If the MAU 102a detected the “initiate Supercall” tone, it starts the Supercall procedures (described below). If the MAU 102a detects a valid user passcode (preferably stored in memory 307) the MAU 102a starts the User Call procedures (also described below).

The supercall subroutine is employed, for example, for handling a telephone call from a Supercaller to the MAU 102a. Communications are performed via, for example, DTMF tones, but other forms of communications (e.g., modem (AT command set), Internet, etc.) can be employed, as will be appreciated by those skilled in the relevant art(s).

The supercall, in general, allows an automated and convenient way to change operating parameters of the MAU 102a and alarm system 100 and to get system status reports (e.g. state dumps) without requiring any user action or involvement. As previously discussed, the supercall may be used, for example, to set or change operating parameters, such as dialing a 9 to get an outside line, dialing an 8 to get an outside line, dialing *70 to turn off call waiting, making a Panic alarm silent, making a Burglar alarm silent, reporting AC power outages, activating or deactivating the alarm system 100, activating or deactivating calls to the central monitoring center 104d, etc. The supercall also may be used, for example, to set or change delay intervals, such as the entry delay (e.g., 0 to 180 seconds, with a default of 30 seconds), the exit delay (e.g., 0 to 180 seconds, with a default of 60 seconds), etc. The supercall also can be used, for example, to provide other functions, such as changing the Swinger Max value (e.g., 0 to 5 alarms per arming period, with a default of 2), storing or changing phone numbers (e.g., the phone numbers for the central monitoring center 104d, or for the alarm system provider, etc.), changing User passcodes, requesting the state information of the MAU 102a and remote devices 102b-102d (referred to as an MAU 102a state dump and a remote device state dump, respectively).

In one embodiment, the supercaller apparatus 104j may remotely deactivate the front end system 102. There may be two levels of deactivation. At one level, the alarm system 100 may still be armed, but does not report alarm triggering events to the monitoring service 104d. For example, alarm reporting or alarm monitoring may be turned off. Likewise, the alarm system 100 may be deactivated to prevent a user from arming the system at all. This level of deactivation might be implemented for people who trigger false alarms frequently, disturbing their neighbors.

In a preferred embodiment, if a supercall disables calls to the central monitoring center 104d or deactivates the alarm system 100, the MAU 102a places one more call to the central monitoring center 104d to report such a state change for security purposes. After such call is completed, no more calls can be made by the MAU 102a and/or arming on the MAU 102a is disabled. The MAU 102a, however, can still accept incoming calls, if calls are disabled or the alarm system 100 is deactivated. This allows a supercall to enable calls again, or to reactivate the alarm system 100.

The User Call subroutine is employed to handle calls from the user to the MAU 102a. The MAU 102a, via the User Call subroutine, receives DTMF tones, and gives feedback to the user by annunciating (e.g., speaking) over the phone line.

Accordingly, in one embodiment, after receiving a valid User passcode, the User Call subroutine annunciates the alarm system 100 status followed by, for example, “PRESS 1 TO ARM, 2 TO DISARM, 3 TO SET SPEAKER VOLUME, 4 TO REPEAT SYSTEM STATUS, 5 TO LISTEN.” The User Call subroutine then waits for DTMF tones.

If, for example, a “1” is received, the User Call subroutine annunciates “ALARM SYSTEM ARMED” via the phone line, sets the armed bit to 1, and goes to the Armed mode.

If, for example, a “2” is received, the User Call subroutine, for example, annunciates “ALARM SYSTEM DISARMED” via the phone line, sets the armed bit to 0, and goes to the Disarmed mode.

If, for example, a “3” is received, the User Call subroutine, for example, annunciates “ENTER NUMBER 1 THROUGH 6 TO SET SPEAKER VOLUME.” Then, if a DTMF “1”-“9-” is received, the User Call subroutine annunciates “SPEAKER VOLUME CHANGED TO LEVEL #,” where # corresponds to volume level 1-9, and changes the volume according to the tone number that was received. In a preferred embodiment, if a 7, 8, 9 is entered, the User Call subroutine sets the volume to a maximum volume. If a DTMF 0, * or # is received, the User Call subroutine, for example, annunciates “INCORRECT ENTRY” and goes to the “ENTER NUMBER 1 THROUGH 6 TO SET SPEAKER VOLUME” step.

If, for example, a “4” is received, the User Call subroutine, for example, annunciates the alarm system 100 status via the phone line.

If, for example, a “5” is received, the User Call subroutine turns on the monitoring microphone 336 for a predetermined time interval, or for as long as the caller stays on line.

If digits other than 1, 2, 3, 4 or 5 are received, the User Call subroutine goes to the “PRESS 1 TO ARM, 2 TO DISARM, 3 TO SET SPEAKER VOLUME, 4 TO REPEAT SYSTEM STATUS, 5 TO LISTEN” step. In a further embodiment, the User Call subroutine also may annunciate “PRESS 7 TO DISABLE CALL WAITING, PRESS 8 TO DIAL 8 FIRST, PRESS 9 TO DIAL 9 FIRST.”

If no tones are received within a predetermined period (e.g., 20 seconds), the User Call subroutine, for example, annunciate “GOODBYE,” places the MAU 102a in an On Hook state, and enters the mode indicated by the Armed bit.

If a hang-up occurs at the other end of the phone line, the User Call subroutine places the MAU 102a in an On Hook state, and enters the mode indicated by the Armed bit.

In addition, the User Call subroutine of the alarm system 100 is programmed to handle abnormal conditions that may occur during an incoming call to the MAU 102a. For example, if an Alarm, Panic or Medical Alert condition is detected during an incoming call, the User Call subroutine, for example, annunciates “ALARM (OR PANIC) CONDITION RECEIVED. GOOD-BYE,” places the MAU 102a in an On Hook state, goes to the mode indicated by the Armed bit, and calls the Alarm subroutine. If any other abnormal conditions are reported (e.g., other than panic, alarm or medical alert), then the User Call subroutine records the new state data, and takes the appropriate action after the incoming call is completed. If the MAU 102a receives an Arm/Disarm command, the User Call subroutine enters the Armed/Disarmed mode. In a preferred embodiment, the User Call subroutine accepts the last recognized Arm or Disarm command. In a further embodiment, the User Call subroutine also allows a user to check or modify the status of the alarm system 100 by calling the premises.

This is one specific embodiment of system parameters that can be modified by a User Call. Other embodiments could enable the user to modify different sets of system parameters. For example, additional capabilities may be added such as, but not limited to: “press 8 to dial first” allows the MAU 102a to dial an 8 before making the Alarm or Panic call, “press 9 to dial 9 first”, allows the MAU 102a to dial an 8 before making the Alarm or Panic call; “PRESS 7 TO DISABLE CALL WAITING”, allows the MAU 102a to disable call waiting during an Alarm or Panic call.

As discussed above, and throughout this disclosure, one of the advantages of the embodiments of the present invention is minimizing user complexity. For example, by employing audible, verbal annunciations via a speaker on the MAU 102a or via telephone, a user may more clearly understand the alarm system 100 status.

The Power-off Routine is employed to power off the MAU 102a. The following events cause the MAU 102a to enter the Power-off Routine, for example: the MAU 102a is in the Disarmed mode and the power switch is pressed; or there is no AC power and the backup battery 360b voltage drops below a predetermined voltage.

The Power-off routine, for example, annunciates “ALARM SYSTEM POWERING OFF,” generates a power off tone, and then powers off the system electronics or puts the system electronics into a sleep mode. In a preferred embodiment, the power management circuit 362 continues to function normally during power off.

### Learn Mode

As previously discussed, the Learn mode is used, for example, to record in the MAU 102a the device ID numbers of the devices 102a-102c in the alarm system 100. One embodiment of a learn mode process 300c-e is depicted in FIGS. 3c-e. The Learn mode is entered, for example, if the MAU 102a is in the Disarmed mode, at step 1402, and the Learn button is pressed. In a preferred embodiment, the Learn mode cannot be entered from the Armed mode. Accordingly, when the Learn button is pressed, the Learn mode bit is set to one, at step 1404, incoming calls are ignored, radio signals are monitored, but no alarms or panics are initiated, “LEARN MODE” is annunciated, at step 1406, and a first timer (e.g., 30 second) is started, at step 1408.

The MAU 102a responds to inputs while in the Learn mode. For example, if Learn button is pressed again, at step 1410, then the Exit Learning subroutine is called, at step 1418. If the Panic button on the MAU 102a is pressed, at step 1412, for example, “TO ERASE ALL DEVICES FROM MEMORY, PRESS PANIC BUTTON AGAIN” is annunciated, at step 1420, and a second timer (e.g., 10 second) is started, at step 1422. If the Panic Button on the MAU 102a pressed again, at step 1424, within second timer period, for example, state information (e.g., including device IDs) of all remote devices 102b-102d is erased, at step 1428, and “ALL REMOTE DEVICES HAVE BEEN ERASED” is annunciated, at step 1430.

If within the first timer period, a signal having the Panic bit=1 or the Test bit=1 is detected from one of the remote devices 102b-102d, at step 1414, then the second timer is reset, and the device ID received is compared against existing device IDs stored in the memory 358, at step 1432. If a new device ID is determined to have been received, the new device ID is written and state information are stored in the memory 358, at step 1434, and an appropriate annunciation is generated (e.g., “KEYFOB NUMBER 4 STORED IN MEMORY,” “SATELLITE NUMBER # STORED IN MEMORY,” “REMOTE DEVICE # STORED IN MEMORY,” etc.), at step 1436.

If the received ID matches the device ID of a device already in the memory 358, an appropriate annunciation is generated (e.g., “PREVIOUSLY KNOWN KEYFOB NUMBER # CONFIRMED. PRESS BUTTON AGAIN TO ERASE THIS KEYFOB,” “PREVIOUSLY KNOWN SATELLITE NUMBER # CONFIRMED. PRESS BUTTON AGAIN TO ERASE THIS SATELLITE,” “PREVIOUSLY KNOWN REMOTE DEVICE NUMBER # CONFIRMED. PRESS BUTTON AGAIN TO ERASE THIS DEVICE,” etc.), at step 1438, a third timer (e.g., 10-second) is started, at step 1440, and if the same signal is received, at step 1442, before the third timer times out, the corresponding device ID is erased from memory 358, at step 1446, and an appropriate annunciation is generated (e.g., “KEYFOB NUMBER ERASED,” “SATELLITE NUMBER H ERASED,” “REMOTE DEVICE # ERASED,” etc.), at step 1448.

If no ID codes are received during the first timer period, the Exit Learning subroutine is called, at step 1418. The Exit Learning subroutine then, for example, annunciates “THERE ARE X SATELLITES, Y KEYFOBS, AND Z OTHER REMOTE DEVICES IN YOUR SYSTEM. EXITING LEARN MODE,” sets the Learn bit to zero, and goes to the Disarmed mode.

Accordingly the alarm system 100, advantageously, includes a one touch learning feature, as described above. With this feature a user presses the learn button on the MAU 102a and then presses the panic or test button on a device 102b-102d and the MAU 102a then learns the device ID of the corresponding device 102b-102d. In this way, the devices 102b-102d in the MAU 102a family are quickly and easily learned or programmed into the MAU 102a.

In a preferred embodiment, after the MAU 102a exits Learn Mode, it makes a report on the new set of devices 102a-102d in its “family” to the database portion of the master database 104c of the server 104a. This procedure is referred to as an “MAU call” because the MAU 102a initiates the call to the supercaller apparatus 104j to store the family set in the database 104c. Accordingly, if any devices are added or removed from the MAU 102a family of devices during the Learn mode, the MAU 102a places a call to server 104a to report on the new set of devices in the family of devices 102a-102d for updating the MAU database portion of the master database 104c. Advantageously, this allows for tracking of device 102a-102d use patterns, modifying of billing based on the number and kind of devices 102a-102d in the MAU 102a family of devices, etc. One embodiment of a MAU call process 300f is depicted in FIG. 3f.

The MAU call updating operation is performed, for example, by the MAU 102a going into the Off Hook state, at step 1450, and dialing the phone number of the Supercaller 104j, at step 1452. When the supercaller apparatus 104j, answers the incoming call from the MAU 102a, the MAU 102a and the supercaller apparatus 104j complete an initial communications handshake procedure, at step 1454. Then, the MAU 102a starts a Remote Device State Dump, at step 1456.

If the MAU 102a fails to transmit all of the Remote Device State data, at step 1458, the MAU 102a may make a predetermined number of further attempts (e.g., two), at step 1462. If all attempts fail, the MAU 102a may place the MAU 102a on hook, at step 1464, and wait a predetermined time interval (e.g., 10 minutes), at step 1466, before again attempting to perform the Remote Device State Dump.

In a preferred embodiment, abnormal conditions during the Learn mode are handled. For example, panic states and alarm conditions are ignored during Learn mode (e.g., no alarms are acted upon and panic states are used for learning or unlearning devices). If any state changes (e.g., other than panic or alarm) occur that require action (e.g., annunciations or calls to the central monitoring center 104d), the corresponding state changes are stored in the memory 358 and the appropriate action is taken after exiting the Learn mode.

### Supercall Protocols

The supercall protocol provides a means to modify the operating parameters of an MAU 102a and obtain information about the status of an alarm system 100 from a remote location. One embodiment of a supercall process 300g-h is depicted in FIGS. 3g-h. The following sequence of events typically occur during the supercall, for example, the supercaller apparatus 104j sets a Call Attempt counter to zero, places the supercall apparatus 104j off hook, at step 1502, and dials the phone number of the MAU 102a, at step 1504. The MAU 102a detects the ring and starts the Off-Hook/passcode subroutine. The supercaller device 104j, for example, waits for at least one but not more than two rings, then hangs up at step 1512, and starts a recall timer, at step 1518. The supercaller apparatus 104j then waits until the recall timer times out and places another call to the MAU 102a. If the supercaller apparatus 104j does not detect a predetermined initiation tone or signal from the MAU 102a within a predetermined period of time, X seconds, from placing the second call, the supercaller apparatus 104j increments the Call Attempt counter, hangs up, and waits a predetermined period of time, Y seconds, and tries again. If the supercaller apparatus 104j fails to connect, at step 1506, to the MAU 102a, for example, after three attempts, for example, the supercaller apparatus 104j stops trying, and sends a warning to an alarm system 100 administrator (e.g., for the server 104a or the central monitoring center 104d) that there may be a problem with the MAU 102a, at step 1516.

If the MAU 102a detects a call within the Incoming Ring Delay interval, the MAU 102a answers the call, at step 1506, and initiates a predetermined handshake procedure, at step 1508. When the handshake between MAU 102a and Supercaller 104j is successfully completed, the body of the Supercall begins.

If the supercaller apparatus 104j and MAU 102a successfully complete the handshake procedure, at step 1510, the supercaller apparatus 104j sends one or more commands via predetermined DTMF tones, in one embodiment, to the MAU 102a during the supercall, at step 1526. The MAU 102a decodes the commands. In a preferred embodiment, a checksum is included at the end of each command sequence, and the receiving device performs a checksum verification after receiving each command. If a checksum is not correct, at step 1528, or if the MAU 102a cannot decode the commands, the MAU 102a may request that the supercaller apparatus 104j resend the command, at step 1544. If the command is successfully decoded and the checksum is verified, at step 1528, the MAU 102a attempts to execute the appropriate action. Such action typically includes the MAU 102a modifying one or more values stored in the memory 358. In some cases, the supercaller apparatus 104j may wait for the MAU 102a to process the command. In other cases, the supercaller apparatus 104j may disconnect from the MAU 102a and wait for the MAU 102a to dial the supercaller apparatus 104j after the command has been executed or failed. In one embodiment, the command may request specific changes in the status of an account of a user of the alarm system 100, etc.

In a preferred embodiment, if the MAU 102a is commanded to send additional information to the supercaller apparatus 104j, such information is processed serially (e.g., before the supercaller apparatus 104j issues another command). If the supercall does not receive the correct response, at step 1432, within a predetermined period of time, Z seconds, the supercaller apparatus 104j resends the request, at step 1544, and tries, for example, twice more for the correct completion of the command. If the supercaller apparatus 104j does not receive the correct response, at step 1532, after, for example, three attempts, the supercaller apparatus 104j notes that such command was not completed, attempts the next command, at step 1526, and sends a warning to the alarm system 100 administrator of any incomplete commands, at step 1542.

The supercaller apparatus 104j continues communications with the MAU 102a until the commands are completed or have failed after, for example, three attempts, at step 1514. If the Supercaller apparatus 104j is through with the call to the MAU 102a, the supercaller apparatus 104j initiates the disconnect procedure, at 1512. As previously noted, if the MAU 102a is engaged in a supercall, and receives an event, for example, a Panic signal (or if the MAU 102a is armed and receives a burglar alarm signal), the MAU 102a terminates the supercall by initiating the disconnect procedure, at step 1512. Then, when the call is terminated, the MAU 102a processes the event. If an MAU 102a terminates the supercall with the disconnect procedure, the supercaller apparatus 104j waits a predetermined amount of time, X hours, then calls the MAU 102a again to attempt complete the unfinished commands.

The supercaller apparatus 104j and supercaller process 300g-h provides many advantages over the prior art. One of the advantages of the embodiment described is a simplified user interface. Complicated user interfaces are one of the biggest consumer complaints about alarm systems and are the single largest cause of false alarms. Similarly, another advantage of one embodiment is minimizing the need for user interface. Likewise, a further advantage of one embodiment of the present invention is the ability to remotely control an alarm system 100, such as shutting down or deactivating a runaway alarm system 100 without requiring on-site technical assistance. A further advantage of one embodiment is the ability to automatically keep track of the state of an alarm system 100 in the field and to keep a record of the number and kind of remote devices in each installation. Tracking the number or remote devices allows for enhanced customer service and may provide for different levels of monitoring services based on the number of devices employed and the types of monitoring services requested.

Although, the MAU 102a is described in terms of employing a telephone interface (e.g., via the devices 312-342) using DTMF signaling to connect to the central monitoring center 104d and/or the server 104a, other interfaces using other signaling can be employed, such as communications network interfaces using, for example, a network interface card (NIC), a modem (e.g., an analog modem, a Digital Subscriber Line (DSL) modem, a cable modem, a wireless modem, etc.) and IP signaling over the communications network 108 (e.g., the Internet, an intranet, a wireless network, etc.), etc., as will be appreciated by those skilled in the relevant art(s).

### Satellite Alarm Unit

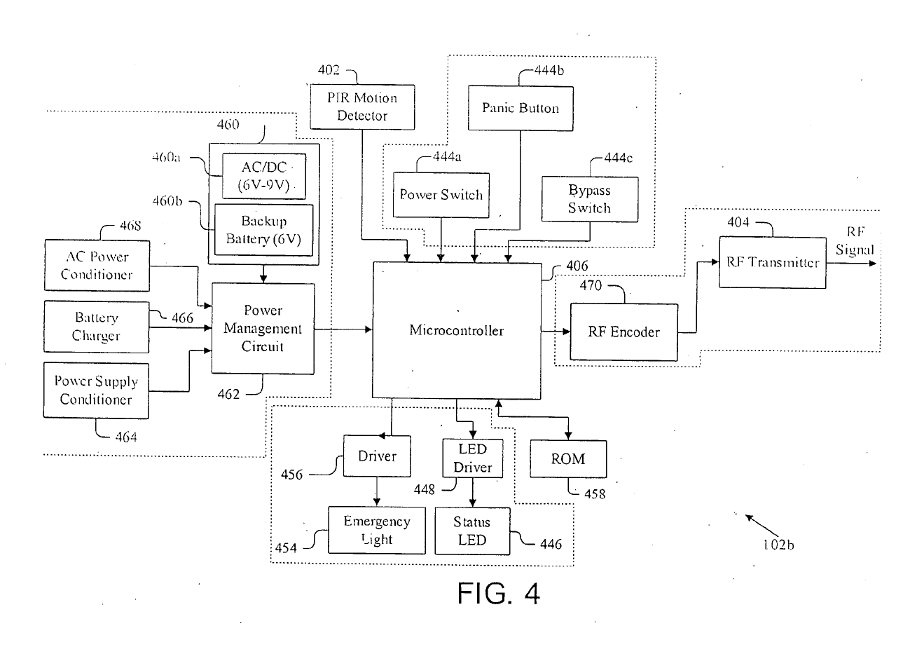

FIG. 4 is a block diagram for illustrating the operations and functions performed by the satellite alarm units 102b of the alarm system 100 of FIG. 1. Generally, the satellite units 102b work in conjunction with the MAU 102a. The depicted satellite alarm unit 102b includes a satellite microcontroller 406, a satellite power module 460-468, a satellite memory 458, a satellite user interface module 444, a satellite radio frequency (RF) transmission module 404, 470, a satellite detection module 402, and a satellite indication module 446-448, 454-456.

In FIG. 4, the satellite unit 102b provides, for example, the following functions: detection of motion and warm bodies using a PIR motion detector 402; transmitting motion detect events and other state information to the MAU 102a via packet radio signals via an RF encoder 470 and transmitter 404; sending of heartbeat signals as a verification that the satellite unit 102b is operational; entering a power off state via a power switch 444a, reporting of a panic event via a panic button 444b; providing a secondary function via the panic button to teach the satellite unit's ID to the MAU 102a; enabling or suppressing transmission of motion detect signals via a bypass switch 444c, etc.

In a preferred embodiment the satellite unit 102, for example, has a transmit-only radio capability. The radio transmits state data when there are state changes detected. The satellite unit 102b includes, for example, a red status LED 446 that is steady under normal operation, and blinks when the satellite unit 102b is bypassed. In a further embodiment, an amber bypass LED (not shown) may be used to indicate the status of the satellite unit 102b. In one embodiment, the satellite unit 102b includes an emergency light 454 that, for example, lights in the event of loss of AC power, as determined by an power management circuit 462. The satellite unit 102b may, include a means of electronic communications (e.g. a serial port and connector) that provides communications access to the microcontroller 406 for manufacturing and/or testing purposes.

The satellite unit 102b includes, for example, a satellite device ID and state machine, for example, implemented via the microcontroller 406 and a memory device 458 (e.g., a protected flash ROM, EEPROM, etc.). The unique ID number is stored in the memory 458. The state machine keeps track of operational status of the satellite unit 102b. For example, each condition and/or state is tracked with one bit, with a bit set to zero for normal or default conditions, and a bit set to one for unusual, abnormal or error conditions. In one embodiment, the satellite unit 102b is programmed at the factory to enable ease of setup with a MAU 102a and minimize user input and programming. This eliminates the need for the user to set up or program the device (such as setting DIP switches or keying in a device ID manually at a control panel) at the time of installation—which one of the most common causes of error and problems with current alarm systems.

The powering up of the satellite unit 102b via the power circuit 462 is similar to that described with respect to the MAU 102a.). The default source of power is from an AC/DC converter connected to a standard AC power source.

In one embodiment, batteries 460b may be employed to provide an uninterruptible source of back-up of power. In this way, if the satellite unit 102b is powered on and if AC power is lost, the power management circuit 462 will switch to battery back-up power. The power management circuit 462 then monitors for presence of AC power, and switches hack to AC power if it is restored. The power management circuitry 462 is functional whenever power is present, regardless of the on/off state of the satellite unit 102b electronics.

While in sleep mode, the satellite unit 102b electronics are monitoring the input line from the power switch 444a. The power management circuit 462 also tracks the following conditions and reports them to the microcontroller 406, for example: AC power lost or restored; low battery or need to replace battery; power supply operating or bad; etc.

In one embodiment, when the power switch 444c is pressed, the satellite unit 102b electronics wake up and go into a boot-up and self-test routine mode. Following a successful power-on, boot-up and self-test, the satellite unit 102b, for example: sends power to the light in the panic button 444b, powers the emergency light 454 for a predetermined period of time (e.g., one second), starts up an event manager (or RTOS), and transmits state information to the MAU 102a with the Powering Up bit=1.

The satellite unit 102b further includes a heartbeat feature that transmits a heartbeat packet whenever an internal heartbeat timer times out (as described above).

In Event Manager is controlled by a Main Event Loop. The Main Event Loop manages or monitors the following in each loop, for example: the AC power status; battery 460b charge state; condition of the power supply; condition of the battery 460b; signals from the PIR 402; input from the panic button 444b; switch debouncing; input from the power switch 444a; input from the bypass switch 444c; the heartbeat timer; etc. I/O and interrupt management is performed by software in the satellite unit 102b and manages the following device I/O's, based on events that occur during the main event loop, for example: transmitting state changes via the RF transmitter 404; output to the bypass switch 444c LED; output to the emergency light 454; interrupts (if necessary), etc.

In Operational mode of the satellite unit 102b is entered following a successful power up. In the Operational mode, the PIR 402 is powered up and detecting motion and the default state of the transmitter 404 is powered down. Advantageously, the transmitter 404 powers up only to transmit state information to conserve power. Accordingly, upon entering the Operational mode, for example: the PIR 402 is powered on and looking for motion and the LED is blinking; the radio is powered off; the bypass switch 444c LED is either steady or blinking (e.g., depending on a state of the Bypass bit); the emergency light 454 is off, etc. In a preferred embodiment, when the satellite unit 102b powers up, it transmits a Powering On packet.

The satellite 102b processes responses to inputs in the Operational mode. For example, if the PIR 402 detects motion, a motion detect filtering algorithm is performed. If the algorithm determines that the motion detection is to be transmitted and if the Bypass bit is zero, then the state information with the Motion bit=1 is transmitted to the MAU 102a. If the Panic button 444b is pressed, the state information with the Panic bit=1 is transmitted to the MAU 102a. If the Bypass button 444c is pressed, the value of the Bypass bit is toggled, and the state information with the new value of the Bypass bit is transmitted to the MAU 102a.

In a preferred embodiment, if the Bypass bit=1, then the Bypass switch 444c LED is set to a blinking state, whereas if the Bypass bit=0 the Bypass switch 444c LED is set to a steady light emitting state. If the Power button 444a is pressed, the satellite 102a transmits the state information with Powering off bit=1, and calls a Power Off routine. If the power circuit 462 reports loss or resumption of AC power, the satellite 102a transmits the state information with the AC power bit set appropriately (e.g., 1 or 0), and turns on the emergency light 454 for a predetermined amount of time (e.g., 7 minutes). In a preferred embodiment, the power circuit 462 can report loss/restoration of AC power, faulty power supply, a bad battery 460b, etc. If the power circuit 462 reports a bad battery 460b, the satellite unit 102b transmits the state information with the Bad Battery bit=1. The ability to activate a bypass mode using a one-touch user input at the satellite unit 102b is an advantage of one embodiment of the present invention.

In one embodiment of the present invention, the motion detect filtering algorithm employed by the PIR 402 may be customizable. By storing timers and counters in the memory 446 of the satellite unit 102b, the supercall apparatus 104j may access a front end system 102 and change the filter parameters to adjust the sensitivity of the PIR 402. For example, each PIR 402 within an alarm system 102 may be customized for the location and operating environment in which it is installed. Customizing individual PIRs 402 is advantageous in minimizing the number of false alarms that might occur. In one embodiment, a the MAU 102a may send a command to a specific satellite unit 102b to rewrite the memory (i.e. EEPROM) with new filtering parameters. Alternatively, the filtering may occur within the MAU 102a. Remote modification of the motion detect filtering algorithm may also be applicable to the MAU 102a.

The Power-off routine is employed to power off the satellite unit 102b. The following events cause the satellite unit 102b to enter the Power-off routine, for example: the satellite unit 102b is in the Operational mode and the power switch 444a is pressed, and in a preferred embodiment no other events trigger the Power-off routine. The Power-off routine causes the satellite unit 102b to, for example, transmit state information with the Powering Off bit=1; power down the PIR 402 and the radio 470, 404, power off the Bypass switch 444c LED; power off the light in the Panic button 444b; put the satellite unit 102b electronics in the sleep mode, etc.

Although, the satellite unit 102b is described in terms of employing a radio interface (e.g., via the devices 470 and 404), other interfaces, such as hard wiring, network communications, etc., may be employed, as will be appreciated by those skilled in the relevant art(s).

### Keyfob Remote Control

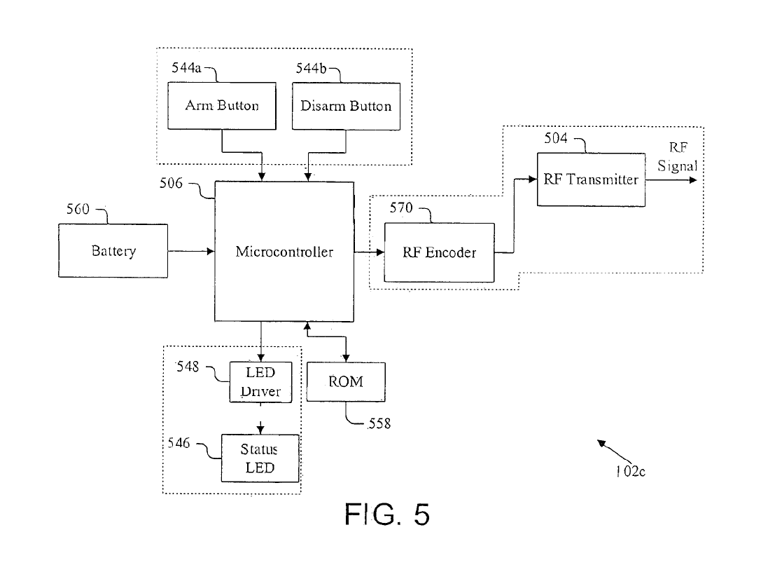

FIG. 5 is a block diagram for illustrating the operations and functions performed by the keyfob remote control 102c of the alarm system 100 of FIG. 1. The keyfob remote control 102c is, for example, a small, handheld RF remote device, designed to be placed on a key chain. Generally, the keyfob remote control 102c works in conjunction with the MAU 102a. The depicted keyfob remote control 102c includes a keyfob microcontroller 506, a keyfob power module 560, a keyfob memory 558, a keyfob user interface module 544, a keyfob radio frequency (RF) transmission module 504, 570, and a keyfob indication module 546-548.

In FIG. 5, the keyfob remote control 102c includes, for example, two buttons, an arm button 544a, and a disarm button 544B. In one embodiment, if both buttons 544a and 544b are pressed simultaneously, a Panic event is transmitted from the keyfob remote control 102c to the MAU 102a. Both switches 544a and 544b are, for example, momentary pushbutton logic switches, with switch inputs processed and debounced by a microcontroller 506. In an alternative embodiment, the buttons on the keyfob remote control 102c may be programmed to perform multiple functions depending on the number, frequency, or order of button presses. In a further embodiment, the keyfob remote control 102c may have one button or more than two buttons. For example, the keyfob remote control 102c may have dedicated panic button.

The keyfob remote control 102c further includes a radio (e.g., transmit-only), implemented via an RF encoder 570 and an RF transmitter 504. The radio transmits state data to the MAU 102a when state changes of the keyfob remote control 102c are detected.

The keyfob remote control 102c includes a device ID and state machine. The unique ID number is stored in a memory device 558 (e.g., a protected flash ROM, EEPROM). The state machine is employed to keep track of a status of the keyfob remote control 102c. Each condition or state can be tracked, for example, with one bit, wherein a bit is set to zero for normal or default conditions, and a bit set is to one for unusual, abnormal or error conditions.

Power is provided from a battery or power source 560 (e.g., an AC/DC power supply, and/or battery, etc.). A default state of the keyfob remote control 102c electronics is a sleep or ultra-low-power mode. When the key 544a or 544b is pressed, the keyfob remote control 102c electronics wake up, detect the key event, and transmit the appropriate state information for the key that was pressed to the MAU 102a.

For example, if the arm key 544a is pressed, the state information is transmitted with the Arm bit=1. If the disarm key 544b is pressed, the state information is transmitted with the Disarm bit=1. If key-down events for both keys 544a and 544b occur within a predetermined period of time (e.g., 500 msec), the state information is transmitted with the Panic bit=1. In a further embodiment, a predetermined key sequence may correspond to a status request that initiates an alarm system 100 status annunciation at the MAU 102a (e.g. pressing the Disarm key 544b three times within 500 ms).

Advantageously, the keyfob remote control 102c may be programmed into an alarm system 100 by simply pressing a learn button on the MAU 102a and then transmitting a panic from the keyfob 102c. In one embodiment, the keyfob remote control 102c and the MAU 102a communicate using the communications packet protocol discussed herein. This simplified learning process minimizes user input and reduces the potential errors that may occur in a more complicated system.

### Other Remote Devices

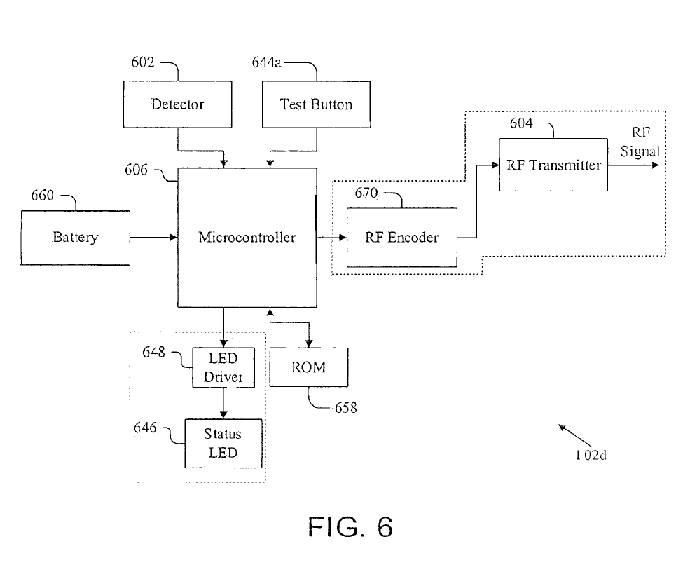

FIG. 6 is a block diagram illustrating the operations and functions performed by the other remote device 102d of the alarm system 100 of FIG. 1. Generally, the other remote device 102d works in conjunction with the MAU 102a. The depicted other remote device (ORD) 102d includes an OR) microcontroller 606, an ORD power module 660, an ORD memory 658, an ORD user interface module 644, an ORD) radio frequency (RF) transmission module 604, 670, an ORD detection module 602, and an ORD indication module 646-648.

In FIG. 6, the other remote device 102d includes a detector 602 and test button 644a. The other remote device 102d functions in a similar manner as described with respect to the satellite unit 102b and/or the keyfob remote control 102c. A difference being that the detector 602 may include any of a variety of detectors, including motion, smoke, water, gas, fire, etc., detectors. The other remote device 102d further includes the test button 644a for testing the detector 602 function, activating the learn mode, etc., and a battery or power source 660 (e.g., an AC/DC power supply, and/or battery, etc.).

As previously described, various data (phone numbers, serial numbers, etc.) are embedded or pre-programmed in the devices 102a-102d of the alarm system 100, advantageously, providing a monitored alarm system 100 directly and out of the box. For example, a default state of the MAU 102a (e.g., programmed in at the factory, etc.) is to report calls to the central monitoring center 104d. Accordingly, the alarm system 100, advantageously, is pre-configured so that the alarm devices 102a-102d work seamlessly within the entire alarm system 100 directly out of the box, with minimal or no programming or adjustments required by a user of the alarm devices 102a-102d.

### Preventing Disabling of the Alarm

As previously discussed, a way for a burglar to thwart a monitored alarm system may be to disconnect or break a communications link to an external system, such as a central monitoring center. The alarm system 100 of FIGS. 1 and 2a-c includes a connection 102f to an external device or system, such as the device 202, the server 104a, and the central monitoring center 104d, over the communications network 108. The alarm system 100 includes an entry delay (e.g., of about 30 seconds) provided between when the MAU 102a, once armed, detects an alarm-triggering event (e.g., a motion detection, a glass break detection, a door/window sensor being triggered, or other alarm triggering condition or event requiring an entry delay, etc.) and when the MAU 102a initiates an internal alarm sequence (e.g., a siren, a flashing light, a call to the central monitoring center 104d, any programmed internal alarm response, etc.).

Accordingly, a way for a burglar to thwart the alarm system 100 may be to disconnect or break the connection 102f to the communications network 108 prior to expiration of the entry delay and, thus, disable communications with the central monitoring center 104d. Because the connection 102f can include a phone line, etc., the burglar may simply unplug, cut, or otherwise disable the phone line from the alarm system 100 to defeat the alarm system 100.

The communications link 102f also can include an “always on” connection, to the device 202, such as cable modem, DSL modem, set-top box, cable box, satellite television receiver, etc., as shown in the alarm system 200 of FIG. 2a. In this case, the burglar may disconnect or cut a cable 202a connecting the MAU 102a and the device 202, prior to expiration of the entry delay, in an attempt to defeat the alarm system 200.

The alarm-triggering event can be detected by the MAU 102a and/or any remote components, such as the satellite units 102b, the keyfob unit 102c, the detector 102d, etc. The remote components 102b-102d can transmit a signal indicating an alarm triggering event to the MAU 102a over the wireless communications link 102e using a wireless communications protocol. However, if the communications link 102f is broken, the MAU 102a is not able to report the break-in to the central monitoring center 104d, which will prevent the central monitoring center 104d from dispatching law enforcement and/or from notifying the owner of the alarm system 100 of the problem.

In addition, with any solution to the above-noted problems, it is valuable not to compromise the entry delay. For example, the entry delay gives the user time to open the front door, and disable the alarm system 100, otherwise, burglaries would be reported every time the user enters a premises protected by the alarm system 100.

In view of the above-noted problems and conditions, a pre-alarm signal is generated by an alarm device, such as the MAU 102a, upon detection of an alarm-triggering event and is transmitted to an external device or system, such as the central monitoring center 104d, the server 104a and/or the device 202. The external device or system then starts a timer, which may be approximately equal in duration to an entry delay of the alarm device. If a disarm signal is not received from the alarm device prior to the expiration of the timer on the external device, the external device can initiate an external alarm sequence. The external alarm sequence can include reporting the alarm condition to a central control center, such as the central monitoring center 104d, notifying the owner, dispatching law enforcement to the premises, turning on a monitoring microphone or camera, and/or triggering a siren that is remotely controlled. Thus, even if a burglar were to disconnect the alarm device from the external device or otherwise disable the alarm device, the external alarm sequence can still be generated, allowing the alarm event to be reported and responded to.

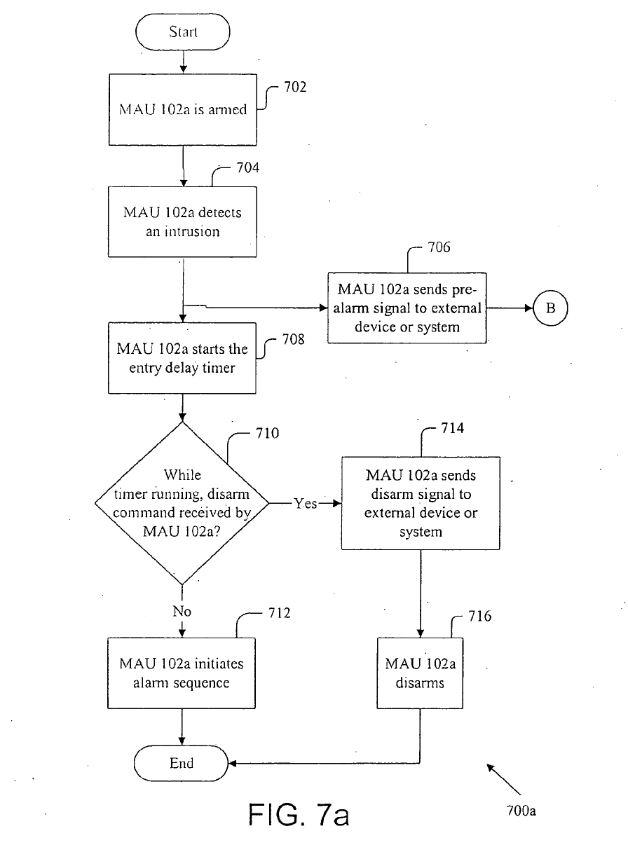

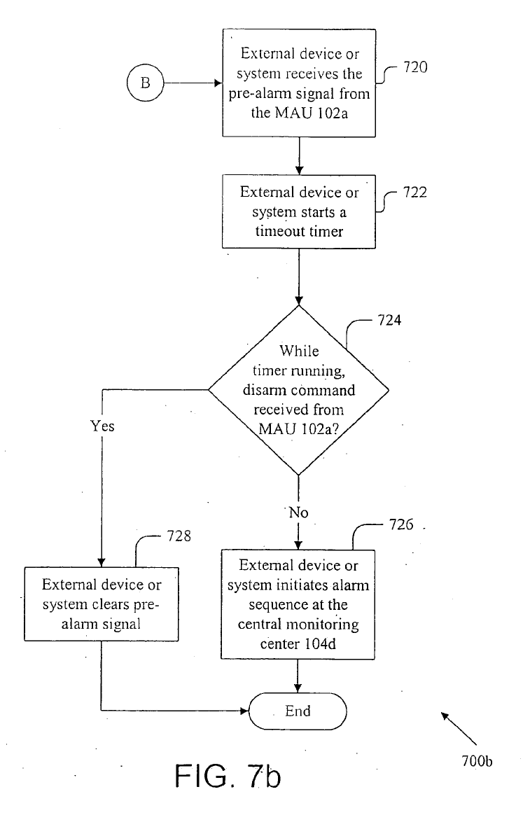

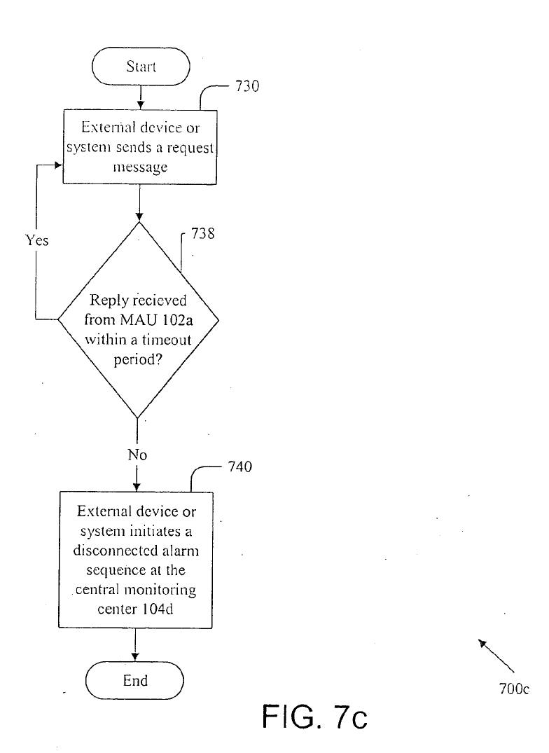

FIGS. 7a and 7b are a flowchart for illustrating an exemplary pre-alarm generation scheme 700a-b that can be used prevent a burglar from thwarting the alarm system 100 or 200. In FIGS. 7a and 7b, when the MAU 102a is armed at step 702 and the MAU 102a detects the alarm-triggering event at step 704, the MAU 102a immediately sends a “pre-alarm” signal, packet, token, etc., to an external alarm device or system (e.g., the device 202 located inside or outside the premises, the server 104a, the central monitoring center 104d, etc.) at step 706.

Such a pre-alarm generation scheme can be most effective with the communications link 102f including an always on broadband connection, because in this way the pre-alarm signal can be sent to the external device or system (e.g., a device located at a cable company, a device located at DSL company, a device located at satellite television company, a device located at alarm system 100 service provider company, the central monitoring center 104d, the server 104a, the device 202, etc.) within milliseconds of a pre-alarm detection. In this respect, the bandwidth of the connection is not as significant as having an always on connection, as an always on connection is what would allow a quick transmission of the pre-alarm signal.

The pre-alarm generation scheme also can be implemented with the communications link 102f including a phone line, which may take about 3 or 4 seconds for the MAU 102a to dial out, handshake, and send the pre-alarm signal to the external device or system.

Nonetheless, at step 708, the MAU 102a starts an entry delay timer (e.g., of about 30 seconds) and if no disarm command or signal is received by the MAU 102a at the expiration of the entry delay timer, as determined by step 710, the MAU 102a initiates the internal alarm sequence at step 712. Otherwise, if while the entry delay timer is running a disarm command or signal is received by the MAU 102a, as determined by step 710, the MAU 102a transmits a disarm signal, packet, token, etc., to the external device or system at step 714 and disarms itself at step 716.

Then the external device or system receives the pre-alarm signal from the MAU 102a at step 720, a pre-alarm timer (e.g., equal in duration to that of the entry delay timer) is started at step 722. If the disarm signal from the MAU 102a is not received by the external device or system prior to the expiration of the pre-alarm timer, as determined by step 724, the external device or system initiates an external alarm sequence (e.g., a call to fire or police departments, a call to emergency medical personnel, any programmed external alarm response, etc.) at the central monitoring center 104d at step 726.

Accordingly, in a preferred embodiment, the external alarm sequence is generated at step 726 after the pre-alarm timer times out. Otherwise, if while the pre-alarm timer is running the disarm signal from the MAU 102a is received by the external device or system, as determined by step 724, the external device or system clears or resets the pre-alarm signal at step 728 and, for example, takes no further action.

Thus, even if the burglar has disabled communications link 102f and/or destroyed the MAU 102a, advantageously, the external alarm sequence is still initiated at step 726, without sacrificing or compromising the entry delay feature.

Although the pre-alarm generation scheme is described in terms of the external alarm sequence of step 726 being generated after the pre-alarm timer times out, the external alarm sequence of step 726 can be generated before the pre-alarm timer times out, as will be appreciated by those skilled in the relevant art(s).

Although the pre-alarm generation scheme is described in terms of being employed with the MAU 102a, the pre-alarm generation scheme can be employed with any alarm device, such as an alarm control panel, etc., as will be appreciated by those skilled in the relevant art(s).

### Connection Verification

The pre-alarm generation scheme described above with respect to FIGS. 7a and 7b is adequate to preclude most communications failures that may occur after the alarm-triggering event is detected by the MAU 102a and during the entry delay period. However, a burglar could disable the communications prior to the alarm-triggering event being detected by the MAU 102a, thus, thwarting the alarm system 100. Accordingly, FIG. 7c is a flowchart for illustrating an exemplary connection verification scheme 700c that can be employed to detect a break in the communications link 102f prior to an alarm triggering event.

In FIG. 7c, at step 730, an external device or system (e.g., a device located at a cable company, a device located at DSL company, a device located at satellite television company, a device located at alarm system 100 service provider company, the central monitoring center 104d, the server 104a, the device 202, etc.) sends a connection verification message to the MAU 102a over the communications network 108. At step 732, the MAU 102a receives the connection verification message via the communications link 102f. In response to receiving the connection verification message, at step 734, the MAU 102a sends a connection reply message to the external device or system over the communications network 108 via the communications link 102f.

At step 736, the external device or system receives the connection reply message from the MAU 102a. The external device or system determines at step 738 whether or not a connection reply message corresponding to the sent connection verification message has been received from the MAU 102a (e.g., after waiting a predetermined period of time after sending the connection verification message, etc.).

If it is determined at step 738 that a connection reply message corresponding to the connection verification message has been received by the external device or system from the MAU 102a, no break in communications is determined to have occurred and control returns to step 730, wherein further connection verifications can be performed in the previously described manner.

If it is determined at step 738, however, that a connection reply message corresponding to the connection verification message has not been received by the external device or system from the MAU 102a, a break in communications is determined to have occurred and the external device or system initiates a disconnected alarm sequence at the central monitoring center 104d. The disconnected alarm sequence can include attempting to contact the user of the alarm system 102, for example, via phone, e-mail, facsimile, pager, etc., to inform the user that the MAU 102a may have been disconnected.

Steps 730-738 can be performed a predetermined amount of times before step 740 is performed. For example, the external device or system can send the connection verification message three times, many times over a predetermined period (e.g., every 2 seconds over a 5 second period, etc.), etc., before determining that a break in the communications may have occurred. In this way, temporary or transient problems due to the communications network 108 can be ruled out without initiating the disconnected alarm sequence at the central monitoring center 104d.

Although the connection verification scheme is described in terms of being employed with the MAU 102a, the connection verification scheme can be employed with any alarm device, such as an alarm control panel, etc., as will be appreciated by those skilled in the relevant art(s).

An alternative embodiment allows the connection verification scheme to be simplified. The off-site device does not need to ping the MAU. The MAU can just have a heartbeat—similar to the heartbeats in Satellites. Satellite send their heartbeats to the MAU, which monitors the conditions of Satellites (and other remote devices). The MAU can send its heartbeat to the off-site device, and if no heartbeats (or other signals) are received from the MAU for a “missing heartbeat” period, the off-site device determines that the communications link is broken and appropriate steps are taken. This method lets us use a one-way channel to monitor the communications link.

### Multi-Priority Message Code Assignments with Error Tolerance

As previously noted, in many applications, there are several levels of urgency or priority associated with messages being communicated amongst devices. For example, the alarm system 100 of FIG. 1 can include one or more urgent or high priority messages and a number of normal priority messages that can be transmitted from the devices 102b-102d to the MAU 102a over the data link 102e.

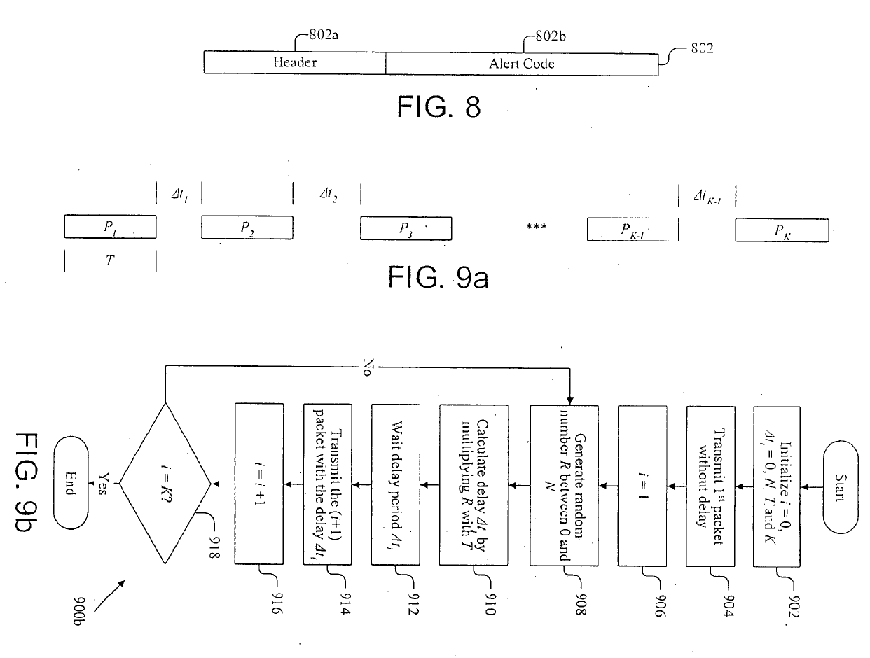

FIG. 8 is a signal diagram illustrating an exemplary communication packet. As shown in FIG. 8, such a message 802 can include a header 802a used for radio communication purposes and an alert code 802b used for indication of urgent or high priority messages and non-urgent or low priority messages.

Urgent message alert codes can include, for example, a panic alert, a medical emergency alert, etc. Normal priority message alert codes can include, for example, an arm alert, a disarm alert, a low battery alert, a battery charge adequate alert, a bad battery alert, a battery operating alert, an AC power loss alert, an AC power detected alert, a power supply problem alert, a power supply operating alert, a device bypass ON alert, a device bypass OFF alert, a device powering on alert, a device powering off alert, a motion detected alert, a glass break detected alert, a premise entry detected alert, a smoke/fire detected alert, a flood/water detected alert, a carbon monoxide detected alert, etc.

In such a scenario, it is desirable that the urgent messages be communicated more reliably than the normal priority messages. Assuming each message alert code includes n bits, then there are N=2″ possible message alert codes that can be employed. Of the N alert codes, the number of alert codes that include exactly k 1's is given by:

$${C}_{k , n} = \frac{n !}{k ! ( n - k ) !}$$

The above formulation is referred to as a “combination” and represents the number of ways of choosing k items out of a total of n items, where an order of the k items is not important. In this case, the number of n-bit alert codes 802b containing k 1's is the same as the number containing k 0's. It can be seen that exactly one alert code has n 1's and exactly one alert code has n 0's. Accordingly, by assigning the urgent alert codes to a respective one of the all 1's code and the all 0's code, advantageously, a maximum Hamming distance (e.g., a number of bit locations in which two codes differ) of n is provided between the two urgent codes.

In order to provide a further level of error tolerance in the communication of alert codes between the devices 102b-102d and the MAU 102a, the number of total possible alert codes, for example, is set to be less than N. Thus, the alert codes that are employed have more than the required number of bits and the extra bits are used for error protection.

For example, two urgent high-priority messages and m normal-priority messages are employed. In the case of n being an even number, one of the two urgent messages, for example, is assigned the alert code including all 1's, and the other urgent message is assigned the alert code including all 0's. The m non-urgent or normal priority messages then are assigned alert codes with n/2 1's. In this way, the Hamming distance between either of the urgent alert codes and any of the normal priority codes is at least n/2. Because of this, several bit errors can occur during transmission of the message 802 from the devices 102b-102d, with the receiver, the MAU 102a, still being able to make a very accurate assumption whether or not one of the urgent messages has been sent.

In addition, the number m of normal priority messages can be set to be less than:

C_{n/2,n},

and n/2-bit alert codes that have Hamming distances greater than two from the urgent codes can be chosen for the normal priority message alert codes, providing additional error protection. Accordingly, if messages that are n bits in length (e.g., n-bit messages) and m normal priority messages that have n/2 1's and n/2 0's are employed, there are C_{n/2,n} of such possible messages and the number m of normal priority messages can be set to less than C_{n/2,n}.

For example, two urgent messages and fifteen normal-priority messages (e.g., m=15) can be employed in the alarm system 100 of FIG. 1, with n=6 (e.g., the messages are transmitted using 6-bit codes). Accordingly, one urgent message alert code is assigned the code 111111, and the other urgent message alert code is assigned the code 000000. The m normal priority message alert codes then are assigned to codes having exactly three 1's and three 0's.

In this way, if a code received at the MAU 102a contains six 1's or five 1's the MAU 102a assumes the code to be an all 1's urgent message, possibly with a 1-bit transmission error in the five 1's case. Similarly, if a code is received with six 0's or five 0's, it is assumed to be an all zeroes urgent message, possibly with a 1-bit transmission error in the five 0's case. With this technique, advantageously, a single bit error during transmission between the devices 102b-102d and MAU 102a can be corrected by the MAU 102a. Since all other messages have three 1's and three 0's, advantageously, at least two bit errors have to occur for a non-urgent or normal priority message alert code to be inadvertently decoded as one of the urgent or high priority message alert codes. In this example, it would take 3 bit errors for an urgent packet to be interpreted as a normal priority packet.

Thus, for the normal priority messages, there are:

C_{3,6},

or 20 possible codes to choose from. Since all the normal priority codes have three 1's and three 0's, advantageously, it takes at least two bit errors to change one normal priority code to another normal priority code.

Accordingly, at least two bit errors would have to occur in order for a message to be incorrectly interpreted by the MAU 102a. In addition, since 15 of the possible 20 alert codes actually correspond to valid messages, additional error protection is provided since a two bit error may transform a message alert code into an alert code that is not used for any message.

As another example, 7-bit alert codes can be employed. As before, one urgent message alert code is assigned the all 1's code (e.g., 1111111), and the other urgent message alert code is assigned the all zeroes code (e.g., 0000000). The normal-priority message alert codes then are assigned to codes having exactly three or four 1's.

In this case, there are:

C_{3,7},

or 35 possible codes with exactly three 1's and another 35 codes with exactly four 1's. Fifteen (or more) of these alert codes are chosen to have a minimum Hamming distance of at least 2 from all other alert codes employed, thereby, providing detection of all one bit errors. As before, advantageously, at least two bit errors have to occur for a non-urgent or normal priority message alert code to be inadvertently decoded as one of the urgent or high priority message alert codes.

If the number of codes required to be used is a sufficiently small fraction of the available (possible) codes, it may be possible to choose codes that have a Hamming distance greater than or equal to 3. In this case, either a 1 bit error can be corrected or 2 bit errors can be detected. This concept can be extended to even higher Hamming distances, as will be appreciated by those skilled in the relevant art(s).

Although the present invention is described in terms of application in the alarm system 100 of FIG. 1, the present invention is applicable to other systems, such as systems employing transmission of multi-priority codes, as will be appreciated by those skilled in the relevant art(s).

Although the present invention is described in terms of assigning two urgent alert codes to codes having all zeroes and all ones, respectively, and assigning a plurality of non-urgent alert codes to codes having a greatest Hamming distance from either of the urgent alert codes, the present invention is applicable to other alert code assignments, such as assigning three or more urgent alert codes to codes having all zeroes, all ones, and a greatest Hamming distance from either of the other assigned urgent alert codes, respectively, as will be appreciated by those skilled in the relevant art(s).

### Reliable Packet Communications in Systems with Multiple Independent Transmitters

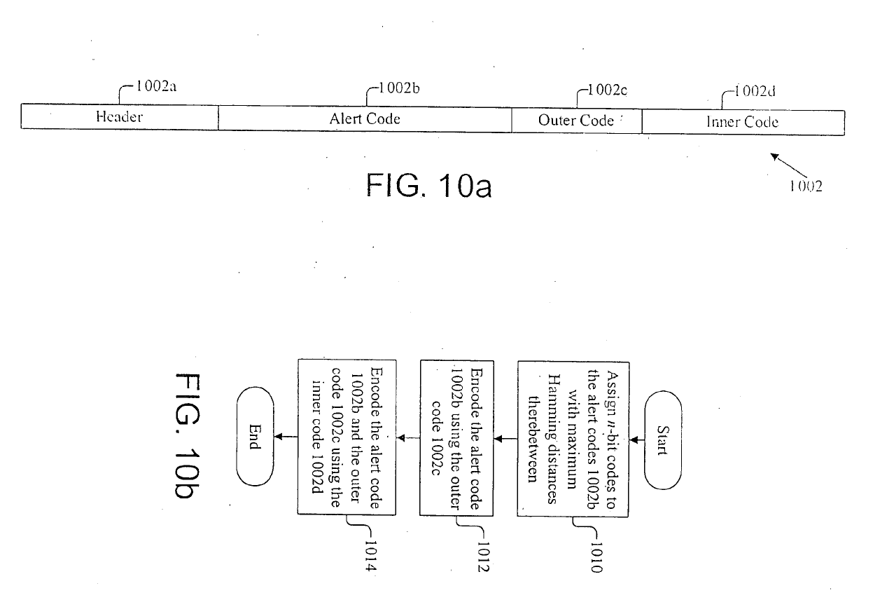

As previously discussed, multi-transmitter environments can lead to reception errors due to the intra-system packet interference problem. The present invention recognizes and addresses such problems by having each transmitter (e.g., the devices 102b-102d) send each data packet multiple times, with random (e.g., based on a pseudo-random number, etc.) time delays between transmissions. This invention is most particularly applicable to systems with one-way communications and/or systems with no means for the transmitters to synchronize their transmissions with one another. The concept is most easily understood by means of an example, illustrated with reference to FIGS. 1 and 9a-9c.

FIG. 9a is a diagram illustrating a packet repetition technique with improved error tolerance in a multi-transmitter environment. For example, the alarm system 100 can employ L transmitters (e.g., the devices 102b-102d), each arranged to transmit distinct packets to a central receiver, the MAU 102a. In one embodiment, a single transmitter may transmit multiple copies of one data packet P₁ . . . Pₖ, as shown in FIG. 9a, with a random time delay, .DELTA.t, between each packet. A time duration or packet interval of each repeated packet P₁ . . . Pₖ is given by T, wherein T is calculated from a bit rate BR of a transmission and a number of bits n in a data packet (e.g., T=n/BR). This technique for reliable transmission of data may be employed with data transmission in digital or analog formats and may employ any transmission medium (not just radio) so long as the approximate duration of each packet is known.

In this scenario, in order to maximize chances that a data packet is properly received by the MAU 102a, each transmitter 102b-102d sends each packet K times. The delays .DELTA.t₁ . . . DELTA.tₖ₋₁ between successive data packet transmissions are given, in one embodiment, by a uniformly distributed (e.g., random number chosen uniformly between 0 and NT) function. In another embodiment, the delays may be generated by a non-uniformly distributed random number generation (RNG) function. In a preferred embodiment, N is an integer greater than zero and T is the packet duration. However, N does not necessarily need to be an integer, as will be appreciated by those skilled in the relevant art(s).

Accordingly, a probability that a packet can be successfully received by the MAU 102a in K attempts (e.g., a probability that at least one of the K packet repetitions is not corrupted by a simultaneous transmission by another transmitter) is lower-bounded by:

$${[ 1 - {( \frac{2}{N} )}^{K} ]}^{L - 1}$$

and upper-bounded by:

$${[ 1 - {( \frac{4}{N} )}^{K} ]}^{L - 1}$$

On average, a probability that a packet is successfully received by the MAU 102a is approximately given by:

$${[ 1 - {( \frac{3}{N} )}^{K} ]}^{L - 1}$$

A probability that conflicts from other transmitters 102b-102d can prevent a packet from successfully being received at the MAU 102a is approximately given by:

$$1 - {[ 1 - {( \frac{3}{N} )}^{K} ]}^{L - 1}$$

Based on the above formulations, advantageously, a packet repetition system that yields any desired reliability level can be achieved. For example, the alarm system 100 can include 17 independent transmitters (the devices 102b-102d, each without any reception capability) that communicate packets to a central receiver, the MAU 102a.

In this scenario, each of the transmitters sends each packet K times with an inter-packet delay uniformly distributed between 0 and N times the packet duration T. For K=10 and N=10, the probability of a packet not getting through to the receiver successfully is approximately 9.45×10⁻⁵. If K is increased to 15 in this example, the probability of the packet not getting through to the receiver successfully is 2.3×10⁻⁷.

Alternatively, if K remains at 10 but N is increased to 15, the probability of the packet not getting through to the receiver successfully is 1.64×10⁻⁶. If the system 100 requires packets to be received successfully with a failure rate of less than 10⁻⁹, a configuration with K=20 and N=10 yields a failure probability of 5.58×10⁻¹⁰, while a configuration with K=15 and N=15 yields a failure probability of 5.24×10⁻¹⁰.

In some systems, however, there may be a limit on the amount of time a given packet can be re-transmitted. Such limits are typically required by government or private institute regulations. For such systems, the maximum time a packet may require re-transmission for the given parameters is KT+(K−1)NT packet times, while the average time is given by: KT+(K−1)NT/2.

Therefore, if such a time limit exists, the limitation on the packet repetition is that KT+(K−1)NT packet times is set less than the regulatory limit.

The above results do not take into account the effect of received uncorrected bit errors rendering a packet reception useless. However, these results can be adjusted to account for such errors, as will be appreciated by those skilled in the relevant art(s).

FIG. 9b is a flowchart for illustrating the above packet repetition process 900b. In FIG. 9b, i and .DELTA.tᵢ are initialized to zero, K is set to the desired number of packet repetitions (e.g., 10), T is determined by the bit rate (BR) and the number of bits in a packet (n), and a value for N is chosen (e.g., 10, step 902). The first packet then is transmitted without any delay (step 904) and the value for i is incremented to 1 (step 906). A random number R (e.g., a pseudo-random number, etc.) between 0 and N is generated (step 908) and a new random delay .DELTA.tᵢ is calculated by multiplying R with T (step 910). A wait period equal to the delay .DELTA.tᵢ is executed (step 912).

The i+1 packet is transmitted following a delay of .DELTA.tᵢ seconds (step 914). A new value for i is calculated by incrementing the previous i value by one (step 916). Then, it is determined if the new value for i is equal to K (step 918). If so, the packet repetition process is completed. Otherwise, control transfers back to a previous step (step 908), where the above processing (steps 908-918) is repeated until the packet has been re-transmitted K times, each time with a new random delay .DELTA.tᵢ.

The random delay algorithm can be employed to compute the random numbers R that, for example, are uniformly distributed from 0 to N (e.g., 0 to 20). However, care must be taken to ensure that different transmitters 102b-102d do not inadvertently compute a same sequence of random numbers R.

In an alternative embodiment, packets that indicate urgent or high priority messages (e.g., a panic alert, a medical alert, etc.) can be repeated continuously, for example, for some number M repeats. Advantageously, this can ensure that the urgent messages are communicated as quickly as possible and with a vanishingly small likelihood of not getting through to the receiver.

On the other hand, non-urgent or low priority messages (e.g., an arm command, a disarm command, etc.) can be repeated less frequently, for example, to save power on battery powered units, such as the key chain activation unit 102c. The higher resulting miss probability, however, may be acceptable, because the non-urgent messages (e.g., an arm command, a disarm command, etc.) can provide immediate feedback to the user and the actions can be repeated until successful. For the non-urgent messages, for example, 6 repeats can be used instead of, for example, 20 as in the case of urgent messages, resulting in a probability of not successfully getting through of about 1%.

Accordingly, there can be employed, for example, three categories of packets: Urgent packets, which are repeated M times with no inter-packet delay (e.g., transmitted continuously), Normal priority packets, which are repeated K times with random inter-packet delays, as described above, and Low priority (or special) packets, which are repeated fewer than K times, with or without random inter-packet delays, and which can afford a higher probability of failure because of other feedback mechanisms.

Although the present invention is described in terms of application in the alarm system 100 of FIG. 1, the present invention is applicable to other systems, such as any systems employing multiple transmitters, as will be appreciated by those skilled in the relevant art(s). This packet repetition technique may be employed with data transmissions in digital, analog, or any other transmission medium so long as the approximate duration of each packet is known.

### Multi-Level Error Correction and Detection

As previously discussed, in many applications, such as the alarm system 100 of FIG. 1, a very high probability of successful reception of a message transmitted by a transmitter (e.g., the devices 102b-102d) to a receiver (e.g., the MAU 102a) should be provided. Accordingly, multiple levels of error protection for messages transmitted from the devices 102b-102d to the MAU 102a are employed. The protection provided is distributed between error correction and error detection. One level of coding concentrates more on error correction and an outermost level of coding provides error detection. In addition, alert codes included in the messages themselves are coded in such a way as to maximize Hamming distances therebetween.

FIG. 10a is diagram illustrating an exemplary coded message format including multi-level error correction and detection, according to the present invention. As shown in FIG. 10a, in messages 1002 transmitted from the devices 102b-102d to the MAU 102a, an inner code 1002d (e.g., a Hamming code, a Bose-Chaudhuri-Hocquenghem (BCH) code, a Reed-Solomon code, other block codes, convolutional code, trellis code, etc.) is employed primarily for error correction on bits including an alert code 1002b and an outer code 1002c. The inner code 1002d may have a residual uncorrected error rate after decoding, so that some messages 1002 may be corrupted. The level of residual errors depends on a raw error rate on a communication channel (e.g., the wireless data link 102e) and an error correction capability of the code employed. The message 1002 further includes a header 1002a used for radio communication purposes. The alert code 1002b is used for indication of urgent or high priority messages and non-urgent or low priority messages, as previously described in the section entitled “MULTI-PRIORITY MESSAGE CODE ASSIGNMENTS WITH ERROR TOLERANCE.”

The second level of coding is provided by the outer code 1002c (e.g., Hamming, BCH, Reed-Solomon, etc.) that includes some error detection capability on the bits including the alert code 1002b. The level of coding provided by the outer code 1002c can be used entirely for error detection or for a combination of error correction and detection. For example, an extended Hamming code (e.g., with minimum Hamming distance of 4) can be used to correct single bit errors and detect double bit errors, or to detect single, double, and triple bit errors in the alert code 1002b.

A third level of coding involves an actual assignment of bit patterns or codes to messages corresponding to the alert code 1002b, as previously described in the section entitled “MULTI-PRIORITY MESSAGE CODE ASSIGNMENTS WITH ERROR TOLERANCE.”

The above processes will now be described with reference to the flowchart of FIG. 10b. In FIG. 10b, n-bit codes are assigned to messages corresponding to the alert codes 1002b and having a maximum Hamming distance from each other, as described above, (step 1010). The alert code 1002b is then encoded using the outer code 1002c, as described above, (step 1012). Finally, the bits of the message 1002 including the alert code 1002b and the outer code 1002c are encoded using the inner code 1002d, as described above, (step 1014), completing the encoding process. The decoding process is basically the inverse of the encoding process described above, as will be appreciated by those skilled in the relevant art(s). Accordingly, a description of the decoding process is omitted for the sake of brevity.

Advantageously, the addition of the third level of coding (e.g., the error-tolerant state code assignments), and the use of very simple codes that are extremely easy to implement, solves several of the problems with conventional approaches. The advantage of the multi-level system is that it provides a level of error correction and detection that is quite secure relative to the amount of computing power required to implement it and relative to the number of additional bits that must be added to the payload (the actual data bits). The more bits you have in your packets, the more data traffic you have to manage. We are looking at two ratios: The level of error protection to the amount of computing power to encode/decode; and the level of error protection to the number of error protection bits added to the payload.

In addition to the error detection and correction provided by the present invention, packet repetition, as previously described in the section entitled “RELIABLE PACKET COMMUNICATIONS IN SYSTEMS WITH MULTIPLE INDEPENDENT TRANSMITTERS,” can be employed to add to the robustness of messages transmitted from the devices 102b-1102d to the MAU 102a.

In a further embodiment, the encoded message 1002 may be encoded using a four-way interleave in which the message 1002 is separated into four segments of equal size and the four segments are interleaved with one another. For example, a message that is 80 bits in length may be separated into four 20-bit segments. The segments may or may not correspond to the fields 1002a-d described above. To interleave the segments, the first bit from each segment (e.g. bits 1, 21, 41, and 61) may be placed together, followed by the second bit from each segment, and then the third bit from each segment, and so forth. Interleaving the segments of a single message 1002 may decrease potential data errors due to burst errors that occur during transmission of the message 1002.

Although the present invention is described in terms of application in the alarm system 100 of FIG. 1, the present invention is applicable to other systems, such any systems requiring reliable transmission of messages, as will be appreciated by those skilled in the relevant art(s).

### Account Activation and Customer Support System (AACS)

As previously discussed, typical monitored alarm systems are expensive, difficult to install and operate, and become a permanent fixture in a consumer's premises. The alarm system 100, including the family of alarm devices, the MAU 102a, the satellite units 102b, the keyfob units 102c, and the other remote devices 102d, advantageously, addresses such problems with the typical monitored alarm system. The monitored alarm devices 102a-102d, are affordable to the average consumer, can be easily set up, and can be purchased and easily activated by the consumer.

The alarm devices 102a-102d may be distributed, for example, through mass market, specialty, do-it-yourself, other retail outlets, etc. The devices 102a-102d also may be distributed through a variety of reseller channels, for example, including telecom, cable, cellular, direct TV, others, etc. Commercial distribution channels, for example, include office and apartment complexes, hotels, retail management companies, etc.

The unique product line of the devices 102a-102d, coupled with a monthly subscriber base, provides an affordable, monitored home security alarm system, with all the features and benefits of expensive, expert-installed alarm systems. The product line also can be customized for resellers of, for example, cable, telecom services, etc., to provide a smart “self knock-off strategy.” Product line extensions and various product line configurations can be custom tailored to be sold in, for example, cellular, cable, satellite, etc., reseller promotions, adding customer longevity, loyalty, and income from current and new subscribers.

The target customers include (but not restricted to), for example, retail customers, end user customers, renters/leasers of an apartment, condo, townhouse, homeowners, etc., seeking an alternative to the costly expert-installed systems. The alarm system 100 also can be promoted to small businesses. The potential number of owned households, rental units, and small business establishments, currently, is in excess of 100 million.

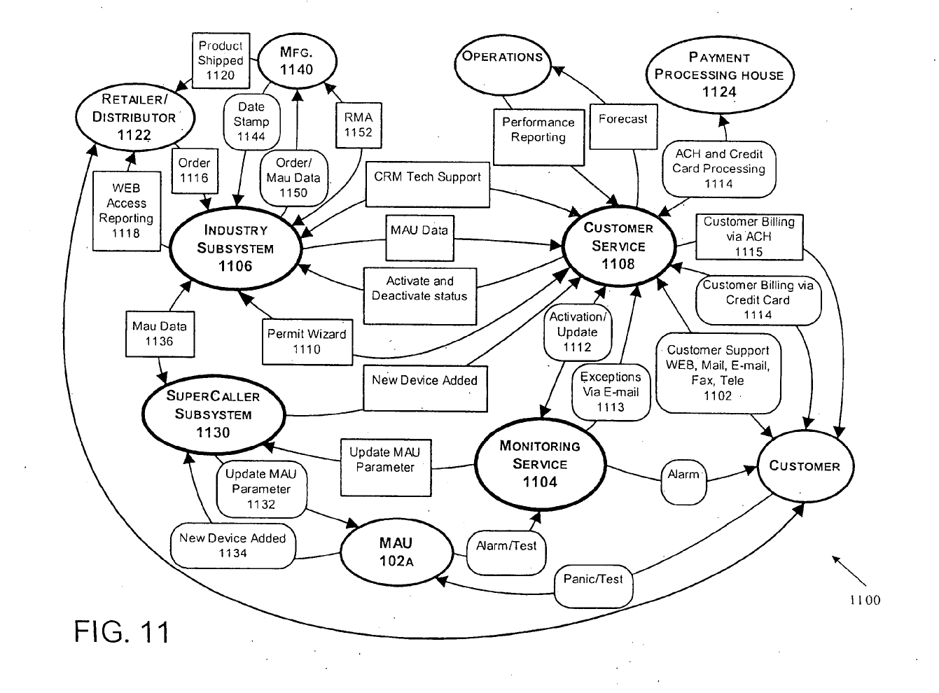

The alarm system 100 (the MAU and remote devices monitored alarm devices (102a-102d) and system (the IT infrastructure FIG. 11a) that work together seamlessly—from receiving PO's from customer; to transmitting automated orders to the factory (including all the necessary data for the devices to work in the system); to the user being able to take to product out of the box, plug in power and a phone line, activating monitoring, and it seamlessly works.

The current state of the art in alarm and security systems has shortcomings and problems that make alarms difficult to install, difficult to set up, and difficult to use. These shortcomings and problems are experienced by the alarm salesman, the installer, the end user, and the monitoring service. The shortcomings of the current state of the art are described below to aid in understanding the improvements and benefits of the inventions disclosed herein.

In the current state of the alarm and security industry, the security products are manufactured by a company which sells the products to distributors and ultimately to “dealer-installer” firms. The dealer-installer firms sell the security products to the end user, and they install the systems. (In some case, there are “do-it-yourself” system which the end user installs in his own premises.) Then the system needs to be configured and/or programmed to communicate with a monitoring service. This requires contacting the monitoring service to exchange data, and then programming appropriate data into the security system. It can also require setting operating parameters—typically by opening the case to get access to the internal electronics, then setting DIP switches or jumpers. The set-up process also requires setting up account information at the monitoring service.

This industry model, in which manufacturing, sales and installation, and monitoring are discrete business units, results in inefficiencies that cost the industry and the consumer money and are hindrances to sales of security systems, particularly in the consumer market.

One object of the invention disclosed herein is to overcome the shortcomings and problems in the current state of the security industry, and thereby eliminate the attendant inefficiencies. One aspect of the invention disclosed herein is a seamlessly integrated system and method for ordering, manufacturing and selling alarm system and providing a monitoring service and customer service.

The integrated system and method is a novel, innovative and valuable approach to an alarm or security system and business. It is implemented in the product design, the business methods, the manufacturing methods, and the service aspects of the business. It integrates the previously separate functions of manufacturing, sales, installation, and monitoring into a single system.

As mentioned previously, the alarm system disclosed herein is designed to sold at retail locations and installed by the end user (rather than sold and installed through the traditional means of security system “dealer-installers”). When a retailer, distributor, or other commercial customer of the product places an order (for example for 10,000 alarm systems) this starts the innovative process.

The first step is automated generation of a production order to build the 10,000 alarm systems. As part of this step, the system generates a table with all the data that will be programmed into the 10,000 devices to make them compatible with the system. The data in the table that will be programmed into the devices includes a unique ID number for each device, the phone numbers to dial to report alarms, the phone number to dial the Supercaller, an account ID number to track billing, data that set the operating parameters of the device, the user passcode, the emergency disarm number (described above), etc. This step of pre-generating all the data is one of the innovative steps that enables this system. The data are stored in a central server and maintained by database software. Data relevant to manufacturing the product are sent to the manufacturing facility. Data relevant to monitoring are sent to the monitoring center. And data relevant to customer service and account activation are sent to the customer service center.

The next step is manufacturing the product. At the time of manufacture, all of the data necessary for the product to work with the system is programmed into each device. At the moment that the manufacturer programs the unique set of data into each device, information on the time and date of data programming is added to the table of data. This provides a record of the manufacturing time and date for each device. When the manufacturing run is completed, the table of data (with time/date stamps) is forwarded to the central server, and the product is shipped for distribution to the sales channel.

These steps allow the product to be pre-configured to work with the monitoring and customer service system. When an end user purchases the product, he does not need to program it or configure it to work with the monitoring and customer service systems. The product has been pre-programmed with device ID numbers, account ID numbers, etc. which allow it work seamlessly with the remainder of the system from the moment is taken out of the box.

This systems approach to the problem allows for an “instant” alarm system for the customer. The alarm system 100 does not require an installer and does not require programming of an alarm panel (previous common approaches taken in the Alarm industry). This approach creates a unique approach to lowering the cost of supplying and servicing the alarm system 100.

FIG. 11 is a chart illustrating exemplary functions of and processes performed by an Account Activation and Customer Support (AACS) System 1100. Consumers and other parties may access the AACS at different levels.

Once an alarm device 102a-102d is purchased by a consumer, the consumer may access 1102 the AACS to activate an account via the WEB, Fax, Mail, or telephone. For example, an account activation wizard that associates the device 102a-102d ID with an address, account, etc., of a customer may be employed. In this way, the activation wizard can automatically cross reference, for example, the customers address and zip code with a local law enforcement dispatch number, which may be included in a database maintained by the central monitoring center database 1104 and/or in the industry subsystem database 1106 and/or the customer service subsystem database 1108.

A police permit processing wizard 1110 also may be employed, because some jurisdictions, for example, in the United States require a customer to register a burglar alarm system and pay a burglar alarm permit fee. Presently, a customer must check with a county/city clerk to find out if a burglar alarm permit is required. Otherwise, after an alarm is reported, the police may notify or fine the customer if no permit is on file.

Accordingly, the permit processing wizard 1110 gathers and stores police burglar permit applications by jurisdiction in the industry subsystem database 1106. Then, when a customer fills out a monitoring agreement, the AACS checks to see if the jurisdiction of the customer requires such a permit. If so, the AACS notifies the customer of such requirement, and takes the customer to the police permit processing wizard, where the application form may be automatically filled out 1112 for the customer.

If the corresponding jurisdiction does not require an original signature of the customer, the AACS may process payment 1114, 1115 for the permit based on a credit/checking account of the customer and then send payment and the filled out application form to the corresponding office of the county/city clerk of the corresponding jurisdiction. Otherwise, the application form may be automatically prepared for and sent (e.g., via e-mail, regular mail, etc.) 1102 to the customer, so that the customer can sign and mail the application form to the office of the county/city clerk of the corresponding jurisdiction.

In a preferred embodiment of the present invention, Retailers, Resellers, Commercial accounts, etc., can access the AACS, for example, to place sales orders 1116, audit monitoring fee overrides that can be paid to the retailers on a monthly basis 1118, etc.

Accordingly, the AACS provides the following exemplary functions to, for example, the general public, account holders, system administrators, etc.:

Company and Product Information: Allows consumers to get information about the alarm system 100 products and services, provides answers to technical questions, provides online ordering of products 1102, allows checking of account status 1102 and access to Account Activation 1112, etc.

Account Activation 1112: Allows consumers to activate their accounts online by filling out activation agreements, such as a Purchase Agreement, a Monitoring Agreement, Monitoring Contact Information, and Automatic Billing Information. Any exceptions are reported back to the customer 1113.

Retail & Direct Ship Product Orders and Sales Tracking 1116, 1118, 1120, 104e, 1122:

Processes orders received from retailers 104e, 1122, resellers 104e, 1122 (e.g., telecom, utility companies, cellular, cable, etc.), direct response advertising 104e, 1122, and commercial accounts 104e, 1122, tracks sales data 104e, 1122, manages inventory 104e, 1122, automated advance notification for ordering new phone numbers and line cards, and shipping orders to contract manufacturers 1150 and the warehouse/fulfillment center 104e, 1122.

Monitoring Fee Overrides: Verifies activation accounts, reconciles monitoring fee override payments, and provides reporting and accounting functions 1106.

The alarm system 100 is designed to expand and change to accommodate new technologies and modifications, as the business of the alarm system 100 provider evolves and grows. The alarm system 100 includes integration with Information Technology (IT) systems of strategic partners of the alarm system 100 provider, which, for example, include the central monitoring center 104d, 1104, customer service subsystem 104k, 1107 the warehousing/fulfillment 104e, 1122, the manufacturers 104g, 1124, the retailers 104e, 1122, the distributors 104h, 1122, etc. The alarm system 100, for example, further includes components for database management, accounting systems, inventory control, sales analysis, business forecasting, etc., embedded within the industry subsystem 1106. The highest levels of security available are employed, and the alarm system 100 is accessible at various levels by, for example, management, administrators, consumers, retailers, distributors, etc., via a variety of user access devices, such as the devices 106a-106c.

In a preferred embodiment, customers receive activation agreements with purchase of one or more of the devices 102a-102d of the alarm system 100. In addition, consumers may purchase a pre-configured family pack of devices 102a-102d. Such agreements may be filled-in and submitted online through the AACS via the web server 104a, 1112, advantageously, providing fast account activation. Consumers also have the option of filling out form agreements and mailing in, faxing, emailing, etc., the filled in forms to an Order Processing facility 1102 of the alarm system 100 provider. Agreements received by mail, fax, email, etc., can be processed by the call center 1106, which enters the information into the AACS, and forwards the processed agreements to the alarm system 100 provider corporate offices 1106.

The Customer Account Activation module is designed so that contact information (e.g., name, address, city, state, zip, phone numbers, cell phone numbers, pager numbers, email addresses, fax numbers, etc.) for the consumer is entered one time into one agreement, such as a Purchase Agreement, then automatically entered into other agreements, such as Monitoring and Billing Agreements, etc., as needed.

Accordingly, the noted agreements provide, for example, the following functions and information:

Purchase Agreement: Details terms and conditions of using the alarm system 100. Includes, for example, name and signature acknowledging the consumer has read and accepted the agreement terms. Also offers consumers option to purchase optional products or services, such as a Protection Plus Plan (e.g., an insurance policy for property loss due to burglary, etc.), for an additional monthly fee.

Monitoring Agreement. Details terms and conditions of the monitoring service and includes, for example, customer's contact information, verification (e.g., name, signature, etc.) that they have read, understand, and agree to the terms of the agreement, etc.

Monitoring Account Contact Information: Includes, for example, customer's contact information, any serious medical conditions, whether they own a pet (s), etc. Customers also may supply a username and/or password, for example, for accessing the web server 104a, etc. Additional information includes, for example, contact information (e.g., name, address, phone numbers, fax numbers, email addresses, cell phone numbers, etc.) for individuals (e.g., three individuals) to be contacted in the event the purchasing consumer can not be located.

Automatic Billing Agreement: Includes, for example, the customer's contact and credit/debit card information, banking information for electronic funds transfer (EFT), approval for automatic monthly billing of the account, etc.

Once an account is active, a consumer is able to access account information, check on monitoring status (e.g., perform testing, determine number of alarm signals generated, etc), update account information, etc., for example, via telephone, online, via the web server 104a, etc. 1102.

The Retail/Direct Ship Product Orders and Sales Tracking module 1116, 1118, 104e, 1122, is employed by the AACS to, for example, process orders from retailers, resellers, commercial accounts, etc. The module also provides, for example, managing of manufacturing production order and delivery status, inventory control, sales tracking and reporting, managing of the customer database (e.g., included in the database 1106), etc.

Accordingly, exemplary functions performed by the Retail/Direct Ship Product Orders and Sales Tracking Module 1116, 1118, 104e, 1122, for example, include:

Processing of purchase orders received from retailers, distributors, reseller accounts, etc.

Maintaining of a trade customer database (e.g., included in the database 1106 and 1108), including details of, for example, pricing for products and services and monthly monitoring fees, quantity discounts, payment terms, promotional allowances, returns and damaged inventory for each account, etc.

Issuing of purchase orders to manufacturers 1140, tracking production status 1144, delivery 1120, return material authorization 1142, etc.

Inventory management via Electronic Data Interchange (EDI) and other systems, etc. (not shown).

Interfacing with variety of retailer, warehousing and fulfillment messaging and data systems, etc.

Analysis and reporting capabilities, etc. 1118.

In a preferred embodiment, accordingly, the alarm system 100 can include an EDI VAN (not shown) and credit card processor for performing various of the above-noted functions, as will be appreciated by those skilled in the relevant art(s).

The Monitoring Fee Overrides module for example 1114, activated accounts may be billed monthly (e.g., via credit card, debit card, EFT, etc.) through a merchant account 104g, 1124 of the alarm system 100 provider, overrides on the monthly monitoring can be paid to retailers, resellers and commercial accounts, etc. Such overrides can be payable at set intervals for each trade account.

Accordingly, each device 102a-102d is manufactured with a memory device (e.g., memories 358, 458, 558, and 658, respectively), for example, programmed with a product ID number and a monitoring account number 1140. Then, for example, orders for the devices 102a-102d are produced and shipped to each retail or reseller account as a consecutively numbered batch (e.g., retailer A orders X units and receives devices with respective consecutive device ID numbers YYYY-ZZZZ, etc.). The customer then provides the product ID number in order to activate an account 1112. The activated product ID numbers are then matched against the shipped product ID numbers 1120 to determine the override payment due any specific trade account. In a preferred embodiment, not all products shipped and sold may necessarily be activated.

Accordingly, the Monitoring Fee Overrides module provides reporting and analysis functions 1118, for example:

Percentage of customers activating monitoring accounts by retailer, region, promotion, price, etc.

Lag time from date of purchase to date of activation, etc. [0389] Verification of monthly billing, notification of non-paying accounts, etc.

Daily reporting of non-paying accounts and status, such as account cancelled, credit card cancelled, etc.

Predetermined notification (e.g., 30 day) to a customer for non-payment, etc.

Predetermined notification (e.g., 60 day) of monitoring service termination, etc.

Accounting reports and override payment adjustments, etc.

In addition, the alarm system 100, advantageously, is designed so that the retailer or the reseller does not have to keep track of which locations sold what units, because the alarm system 100 provider tracks the activations and monitoring fee overrides, and each trade account can securely access to the alarm system 100 to audit monitoring fee activations, overrides payable, etc., via the server 1106.

Although the present invention is described in terms of application to the security industry, for example, wherein a customer can purchase the alarm system 100 devices 102a-102d at retail and use the Internet to activate service, the present invention can be applied to other industries having monthly recurring revenues, such as the cable television or Internet industry, the satellite television or Internet industry, etc., as will be appreciated by those skilled in the relevant art(s).

Although the present invention is described in terms of activation of the alarm system 100 devices 102a-102d, the present invention can be applied to activation of any form of security monitoring, such as activation of burglar, fire, life safety, GPS tracking, etc., security monitoring, as will be appreciated by those skilled in the relevant art(s).

The Supercaller Subsystem/Apparatus 1130 is a set of services to allow alarm system 100 devices 102a-102d to be remotely managed and also to send changes that are made to alarm system 100 devices 102a-102d. The backbone of the SuperCaller subsystem 1130 is the SuperCaller Server. This server takes XML web service requests over the Internet and translates them into actions on the MAU through a telephony interface with the MAU device 1132. The Server stores current state information for MAUs in its own database 1130. The SuperCaller Server also receives calls from the MAU when a new satellite 1102c or other remote device 1102d is added 1134 to the MAU 102a. The database is updated with the new state information.

### Alarm System Activation Process

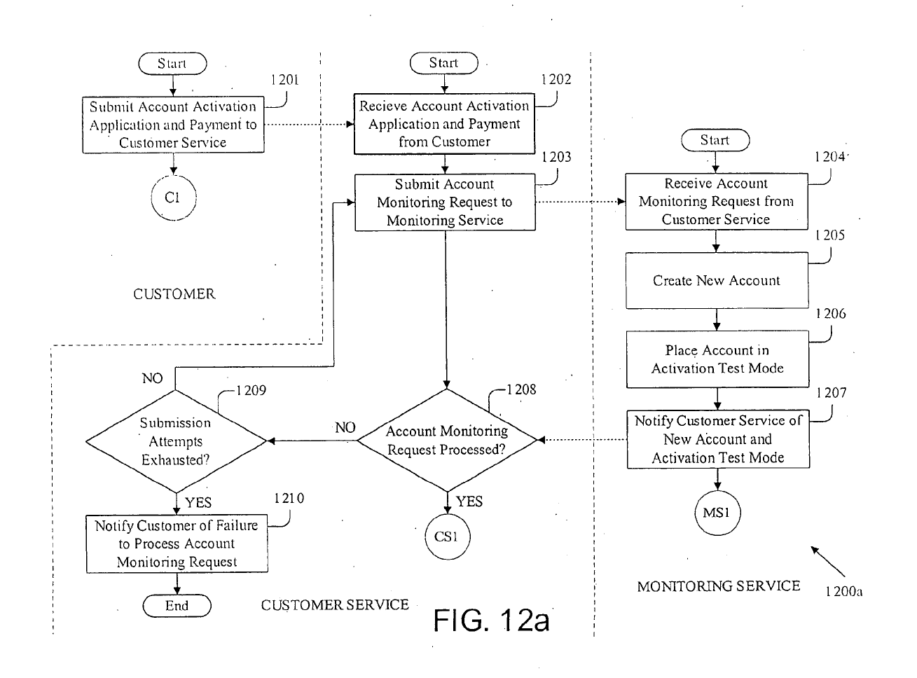

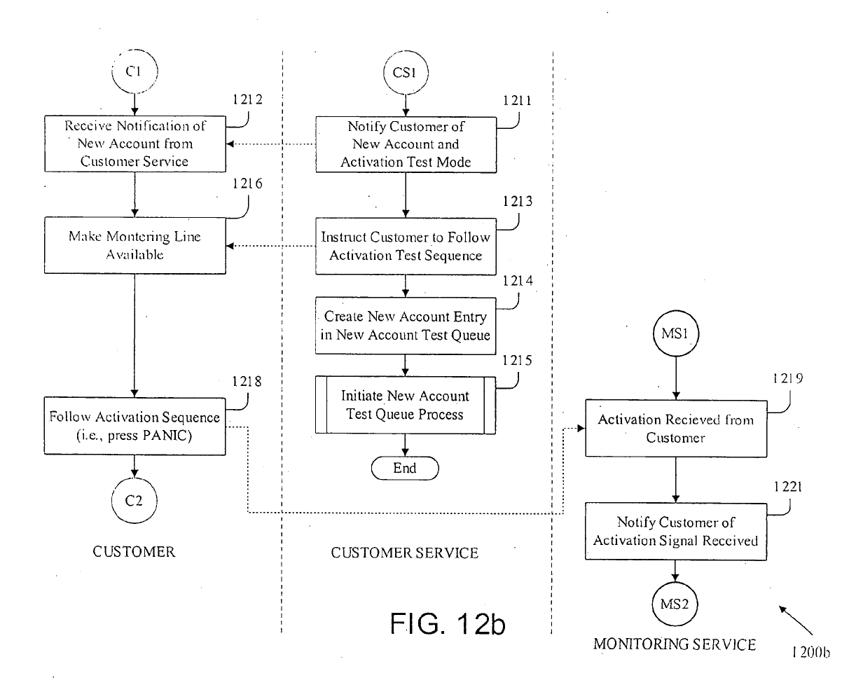

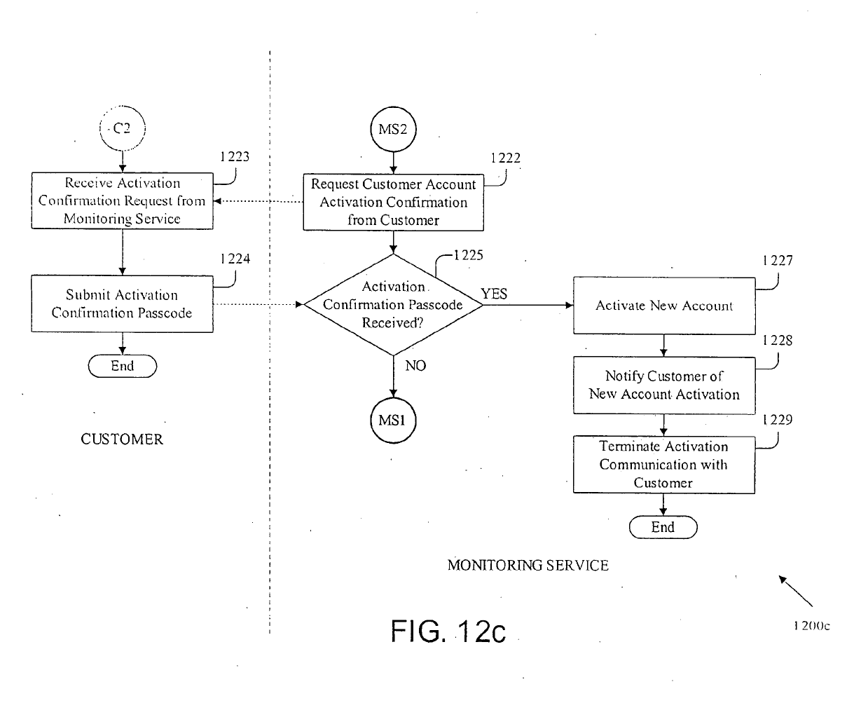

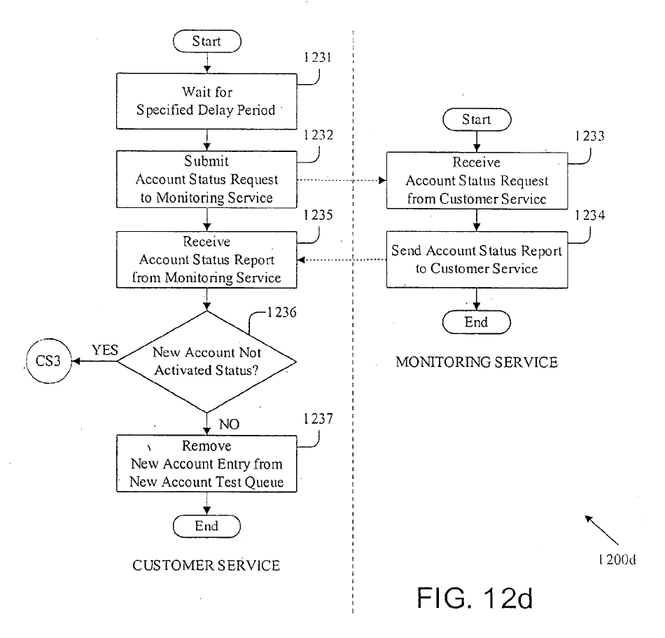

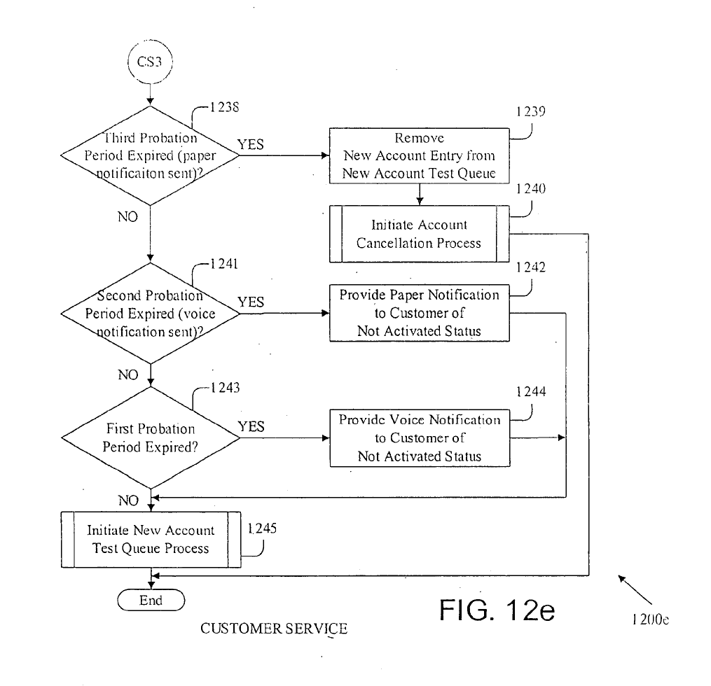

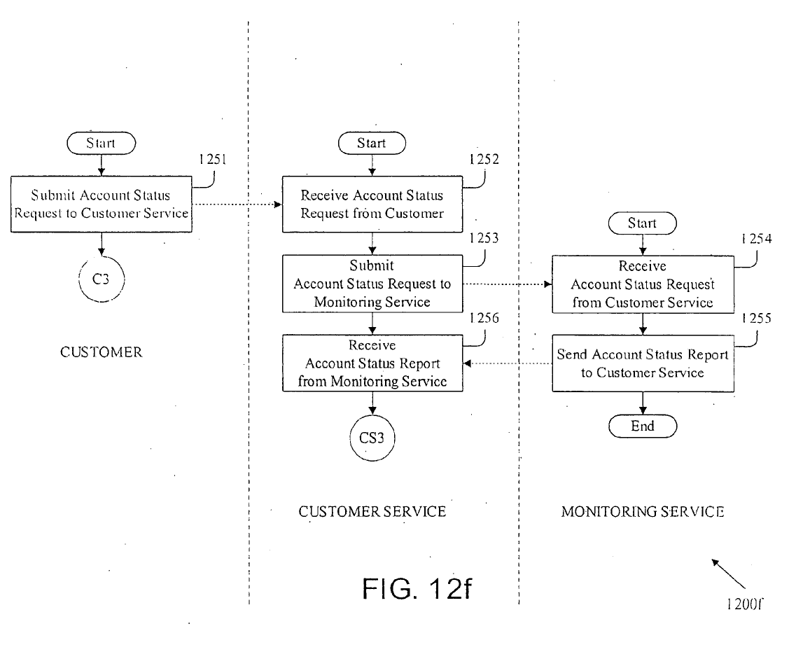

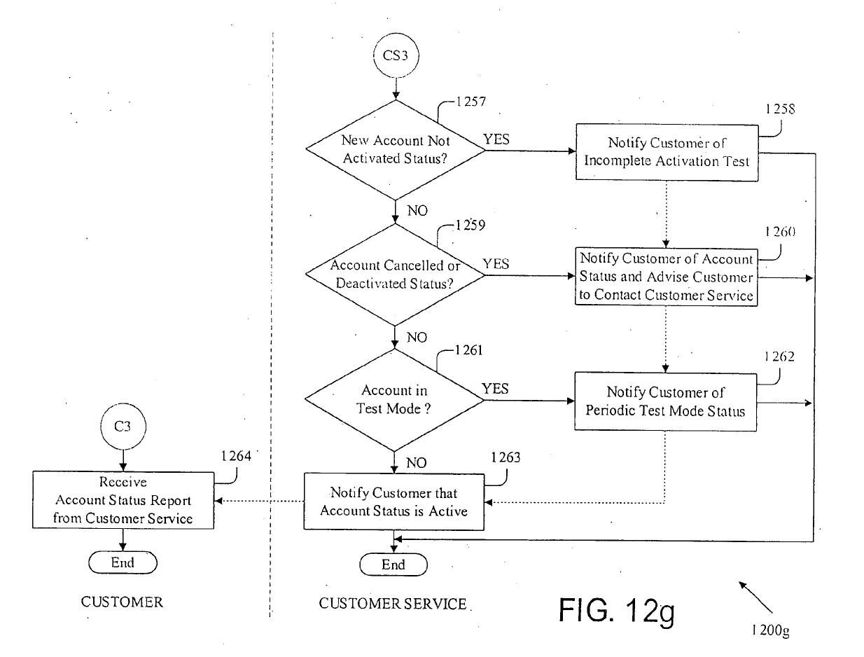

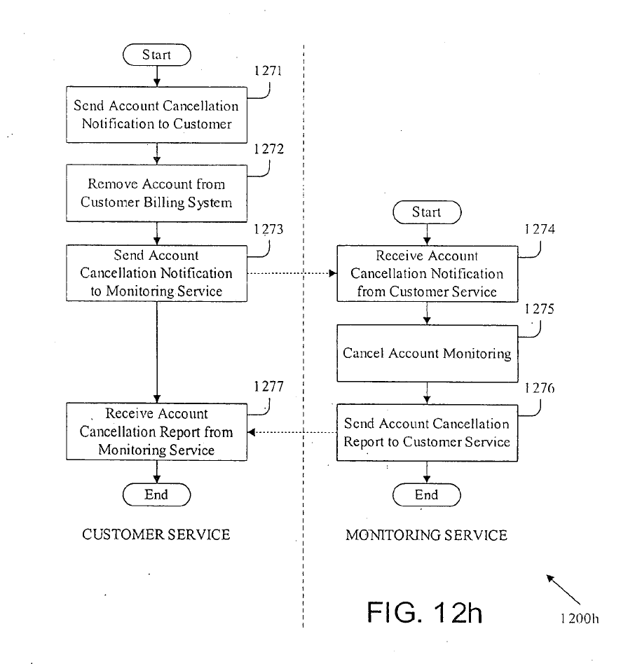

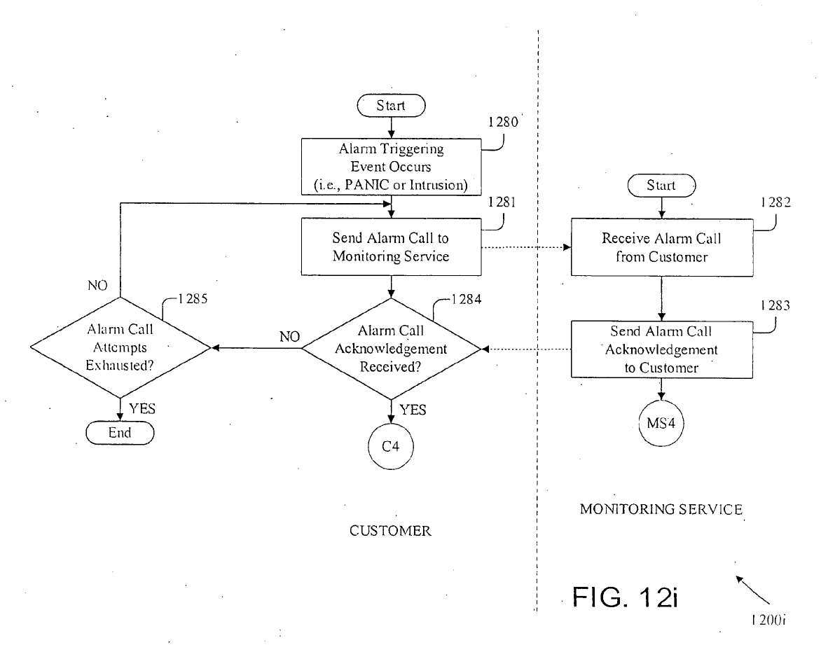

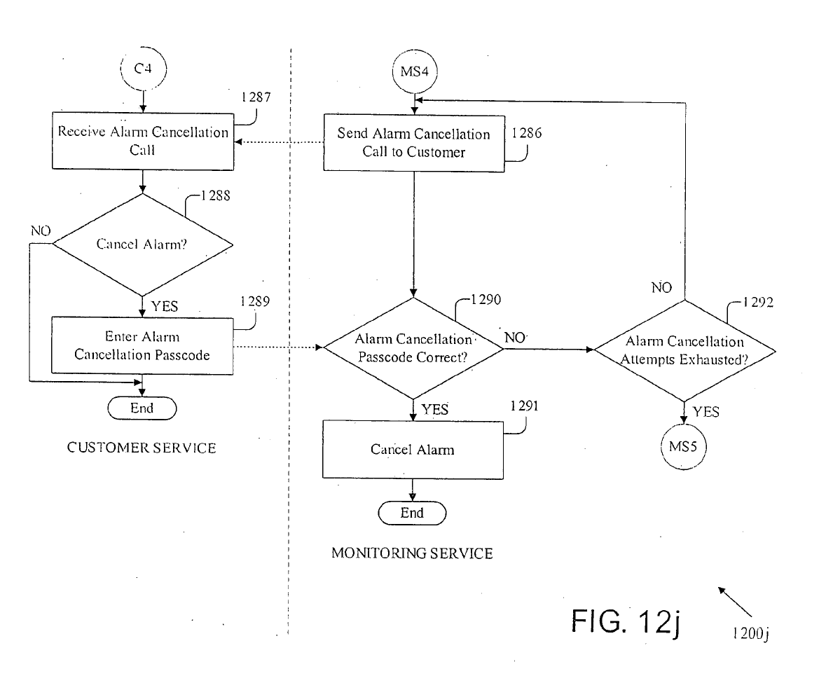

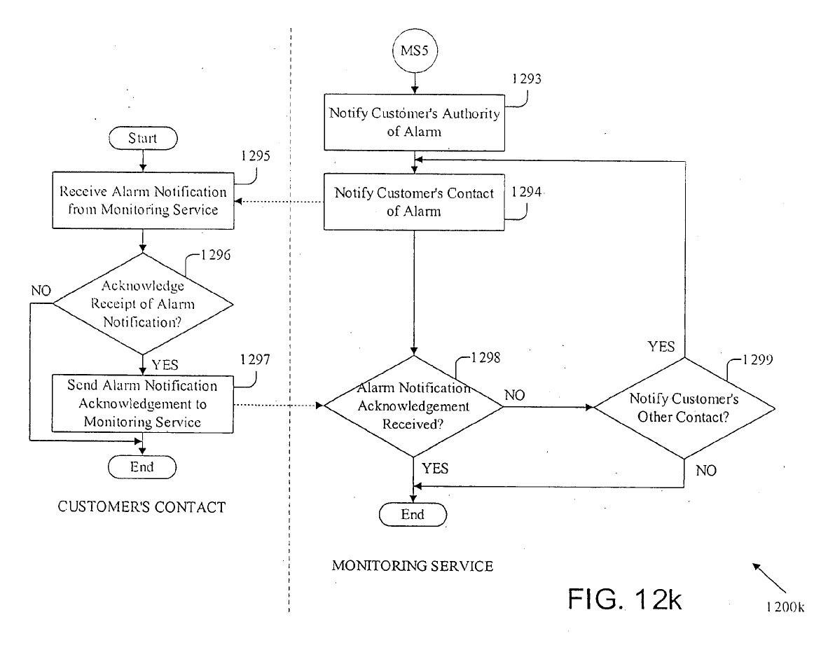

FIGS. 12a, 12b, and 12c depict one embodiment of an activation process 1200a-c, for activating a MAU 102a within a front end system 102. Advantageously, the illustrated activation process 1200a-c minimizes the required amount of user interaction and programming, thereby minimizing most or all of the potential errors that occur during a conventional installation of an alarm system.

The depicted embodiment of the activation process 1200a-c begins with the submission of an account activation application and initial payment, at step 1201. The account activation application may be submitted directly by a customer using an Internet website, a fax, a telephone, a mail-in application, or any other application format suitable for submitting the required application information. Alternatively, the account activation application may be submitted by a customer service representative (CSR) on behalf of a customer using a similar application submission format 1102. For example, a customer service representative may submit an application via fax, Internet, mail, or telephone.

The account activation process 1200a-c begins at the customer service center as the account activation application and initial payment are received, at step 1202, from either the customer or the customer service representative. The customer service center then submits and account monitoring request to the monitoring service, at step 1203.

The account activation process 1200a-c begins at the monitoring service center as the account activation application is received from the customer service center, at step 1204. Upon receiving the account monitoring request from the customer service center, the monitoring service center creates a new account, at step 1205, and places the new account in an activation test mode, at step 1206. The monitoring service center then automatically notifies the customer service center of the new account created.

The customer service center determines, at step 1208, if the account monitoring request has been processed at the monitoring service. If the account monitoring request has not been processed successfully, the activation process 1200a-c determines, at step 1209, if all submission attempts have been exhausted from submitting the account monitoring request to the monitoring service center. For example, the customer service center may attempt to submit the account monitoring request three times before notifying the customer that the account could not be set up or activated, at step 1210 and the depicted activation process 1200a-c ends.

Otherwise, if the account monitoring request is processed by the monitoring service center, the customer service center notifies the customer, at step 1211, that a new account has been created and activated. In the depicted embodiment, the customer receives the notice from the customer service center, at step 1212. After notifying the customer of the new account, the customer service center instructs the customer to follow a particular activation sequence, at step 1213. The customer service center subsequently creates a new account entry in a new account test queue, at step 1214, and initiates a new account test queue process, at step 1215. The new account test queue process will be discussed in more detail with relation to FIGS. 12d and 12e.

After receiving the activation test mode instructions from the customer service, the customer makes the monitoring line available (ensure the MAU 102a is connected to the phone line), the customer then follows the activation sequence to activate the monitoring account. In one embodiment, the customer may press the panic button on the MAU 102a to activate the monitoring service, at step 1218.

Upon pressing the panic button, in one embodiment, on the MAU 102a, to activate the monitoring account, the MAU 102a calls the monitoring service center. The monitoring service center may, in one embodiment, notifies the customer that the activation sequence call was received, at step 1219. The monitoring service center then requests a customer account activation confirmation from the customer, at step 1222. In the depicted embodiment, the customer receives the activation confirmation request from the monitoring service, at step 1223, and submits an activation confirmation passcode, at step 1224. In a preferred embodiment, the monitoring service center uses an IVR to call the customer over the telephone and request the account confirmation passcode. The customer, in this embodiment, may enter the proper account confirmation passcode using the keys on the telephone.

If the monitoring service center does not receive the activation confirmation passcode from the customer or if the monitoring service center determines that the received passcode is incorrect, at step 1225 the call is terminate. The Test Queue Process 1200c-d will handle expections. If the monitoring service center receives the correct passcode from the customer, the monitoring service center activates the new account, at step 1227, notifies the customer that the new account is activated, at step 1228, and terminates the activation communication 1229 with the customer, at step 1229. At this point, the new account is registered with the customer service center and activated with the monitoring service center, meaning that the alarm system 100 may be monitored by the monitoring service for alarm-triggering events.

### Alarm System Account Test Queue Process

FIGS. 12d and 12e depict one embodiment of the new account test queue process 1200d-e that may be initiated by the customer service center or the monitoring service center during the activation process 1200a-c described above. The account test queue process 1200d-e is employed, in one embodiment, to allow the customer service center to verify the status of an account to ensure that the account is monitored or that the customer has been notified that the account is not monitored. This process ensures that the customer knows that they are not actively monitored until they have completed the activation. The customer may be notified via a phone call, or by US mail, or even a certified letter that they are not actively monitored and that no local authority notification will occur.

The depicted account test queue process 1200d-e begins by waiting a specified delay period, at step 1231, and then the customer service center submits an account status request to the monitoring service, at step 1232. In a preferable embodiment, the communications between the customer service center and monitoring service center are automated and do not require the interaction of a human operator or representative. Alternatively, the communications may be facilitated, in part, in a non-automated fashion.

The monitoring service center receives the account status request, at step 1233, from the customer service center and responds by sending the requested account status report to the customer service center, at step 1234. Upon receiving the account status report, at step 1235, the customer service center determines, at step 1236, if the new account has been activated by the monitoring service center, as explained above with relation to the account activation process 1200a-c. The account is now actively monitored by the monitoring service. If the new account has been activated, the corresponding new account entry is removed from the new account test queue, at step 1237, and the account test queue process 1200d-e ends.

If the customer service center determines, at step 1236, that the new account has not been activated at the time that the account status report is generated, the customer service center determines, at step 1238, if a third probation period has expired (the first and second probation periods will be discussed below). The third probation period, in one embodiment, is longer than the first and second probation periods and is used to determine if the new account should be cancelled. For example, if a customer applies for a new account, but does not activate the alarm system 100, the monitoring service cannot monitor the alarm system 100 and the customer may be notified and the customer's account may be cancelled if no further contact from the customer is received. At the expiration of the third probation period, the customer service center removes the corresponding new account entry from the new account test queue, at step 1239, and initiates an account cancellation process, at step 1240, that will be discussed in more detail with regard to FIG. 12h.

If the third probation period has not expired, the customer service center determines, at step 1238, if a second probation period has expired. The second probation period is preferably shorter than the third probation period, but longer than the first probation period. At the expiration of the second probation period, the customer service center provides a paper notification, such as by mailing a printed notification, to the customer, at step 1242, that the new account is neither activated nor monitored.

In a similar manner, if the second probation period has not expired, the customer service center determines, at step 1243, if a first probation period has expired. The first probation period is preferably shorter than the second and third probation periods. At the expiration of the first probation period, the customer service center provides a voice notification, such as by placing a call using the IVR or in another embodiment via a live customer service representative, to the customer, at step 1244, that the new account is neither activated nor monitored. If none of the probation periods have expired, the account entry remains in the new account test queue and the account test queue process 1200d-e is reinitiated, at step 1245. In this way, the account test queue process 1200d-e continues until the new account is either activated by the customer or cancelled by the customer service center for failure to activate the account.

### Alarm System Account Status Check Process

FIGS. 12f-g depict one embodiment of an account status check process 1200f-g that allows a customer or a customer service representative to check the status of an account. In one embodiment, the customer or CSR may use a telephone and telephone IVR to check the status of the account. Alternatively, the customer or CSR may use an Internet website to check the status of the account. In a preferred embodiment, the communications between the customer service center and the monitoring service center are performed in an automated manner, such as through an XML interface.

The illustrated account status check process 1200f-g begins when the customer or CSR submits an account status request to the customer service center, at step 1251. The customer service center receives the account status request, at step 1252, and submits a corresponding account status request to the monitoring service center, at step 1253. Upon receiving the account status request, at step 1254, the monitoring service center responds by sending an account status report to the customer service center at step 1255. This account status report indicates the current monitoring status of the account.

Using the account status report from the monitoring service center, the customer service center determines, at step 1257, if the new account is not yet activated. If the account is not yet activated, the customer service center notifies the requesting customer or customer service representative that the account is not active and is not being actively monitored, at step 1258, because the activation process 1200a-c is not complete. If the account has been activated, the customer service center determines, at step 1259, if the account has been cancelled or deactivated. An account may be cancelled due to failure to activate the account within a specified time period. The account may also be cancelled upon request from a customer or customer service representative. An account may be deactivated, but not cancelled, also due to a customer request. A deactivated account is not currently monitored, in one embodiment, by the monitoring service center, but may be reactivated at a later time. If the account is cancelled or deactivated, the customer service center notifies the customer or customer service representative that the account is cancelled or deactivated and advises the customer to contact the customer service center to discuss the account status, at step 1260.

The customer service center also determine, at step 1261, if the account is in a test mode in which user may be testing the connection between the monitoring service center and the Master Alarm Unit 102a. The account may be placed in a test mode for other administrative reasons. If the account is in test mode, the customer service center notifies the customer or customer service center that the account is currently in test mode, at step 1262. Otherwise, if the account is activated and not in a test mode, the customer service center notifies the customer or customer service representative that the account is in an active status, at step 1263. The customer or customer service representative receives the account status report from the customer service center by way of email, IVR, Internet website, or another appropriate communications medium.

### Alarm System Account Cancellation Process

FIG. 12h depicts one embodiment of an account cancellation process 1200h that may be invoked by a customer or customer service representative. In the given embodiment, the customer service center sends initiates the account cancellation process and sends an account cancellation notification to the customer, at step 1271. The customer service center then removes the account from the customer billing system and other account management applications, at step 1272.

After removing the account from the customer service center applications, the customer service center sends an account cancellation notification to the monitoring service center, at step 1273. The monitoring service center receives the account cancellation notification, at step 1274, stops monitoring the alarm system 100 designated by the cancelled account, at step 1275, and sends an account cancellation report to the customer service center, at step 1276. After the customer service center receives the account cancellation report, the depicted account cancellation process 1200h ends.

### Alarm System Alarm Process

FIGS. 12i-j depict one embodiment of an alarm process 1200i-j that may be invoked by detection of an alarm triggering event such as a panic or intrusion, at step 1280, during active monitoring of the alarm system 100. Upon detecting an alarm-triggering event at the premises of the front end system 102, the MAU 102a sends an alarm call to the monitoring service center, at step 1281. The monitoring service center receives the alarm call, at step 1282, and sends and alarm call acknowledgement to the customer, at step 1283. The alarm call and alarm call acknowledgement may be communicated during a continuous communication between the monitoring service center and the front end system 102.

If the MAU 102a determines, at step 1284, that no alarm call acknowledgement was received by the front end system, in one embodiment, during a specified response period, the MAU 102a attempts to resend the alarm call to the monitoring service center. The MAU 102a attempts to resend the alarm call to the monitoring service center, in one embodiment, until a predetermined number of attempts have been exhausted, at step 1285.

After sending the alarm call acknowledgement, the monitoring service center sends an alarm cancellation call to the customer, at step 1286. The alarm cancellation call is preferably placed by an IVR at the monitoring service center and requests an alarm cancellation passcode from the customer. Upon receiving the alarm cancellation call from the monitoring service, at step 1287, the customer may decide, at step 1288, to cancel the alarm call because it is a false alarm. If the customer decides to cancel the alarm call, the customer enters a particular alarm cancellation passcode, such as using the telephone.

If the monitoring service center receives the correct passcode, at step 1290, the alarm is cancelled, at step 1291. Otherwise, the monitoring service center attempts to resend the alarm cancellation call to the customer, in one embodiment, until a pre-determined number of attempts have been exhausted, at step 1292. Once the pre-determined number of attempts to resend the alarm cancellation call have been exhausted, the monitoring service notifies the customers authority, such as the local police, of the alarm, at step 1293. In one embodiment, the local authority may be contacted by a customer service representative or an IVR message. In a preferred embodiment, the customer's local authority is automatically called using a specified telephone number determined at the time of account activation. In a preferred embodiment, the local authority's number is automatically populated into a database during the activation process based on a lookup table and a customer identifier, such as a zip code.

In the preferred embodiment, the customer's local authority is called automatically by an automated dialer and the call is transferred to a monitoring service representative to communicate the alarm to the local authority. In a similar manner, the monitoring service center notifies a customer's contact, such as a neighbor, family member, or other person specified by the customer, of the alarm, at step 1294. Upon receiving notification of the alarm, at step 1295, the customer's contact may acknowledge receipt of the alarm notification, at step 1296, by sending an alarm notification acknowledgement to the monitoring service, at step 1297. The alarm notification acknowledgement may be in the form of an audible response, such as the word “yes,” or may be entered using the keys on the telephone, in an alternate embodiment.

The monitoring service center determines, at step 1298, if the alarm notification acknowledgement was received, in one embodiment, within a specified response time period. If an alarm notification acknowledgement is not received by the monitoring service center, the monitoring service center may notify another one of the customer's contacts, at step 1299, in substantially the same manner. After one of the customer's contacts acknowledges receipt of the alarm notification, or if none of the customer's contacts properly acknowledges receipt of the alarm notification, the illustrated alarm process 1200i-k ends.

### Exemplary Computer System Architecture

The alarm system 100 can store information relating to various processes described herein. This information can be stored in one or more memories, such as a hard disk, optical disk, magneto-optical disk, RAM, etc., of the devices of alarm system 100 One or more databases of the devices and subsystems of the alarm system 100 of FIG. 1 can store the information used to implement the embodiments of the present invention. The databases can be organized using data structures (e.g., records, tables, arrays, fields, graphs, trees, and/or lists) included in one or more memories, such as the memories listed above or any of the storage devices listed below in the discussion of FIG. 13, for example.

The previously described processes can include appropriate data structures for storing data collected and/or generated by the processes of the system 100 of FIG. 1 in one or more databases thereof. Such data structures accordingly can include fields for storing such collected and/or generated data. In a database management system, data can be stored in one or more data containers, each container including records, and the data within each record can be organized into one or more fields. In relational database systems, the data containers can be referred to as tables, the records can be referred to as rows, and the fields can be referred to as columns. In object-oriented databases, the data containers can be referred to as object classes, the records can be referred to as objects, and the fields can be referred to as attributes. Other database architectures can be employed and use other terminology. Systems that implement the embodiments of the present invention are not limited to any particular type of data container or database architecture.

All or a portion of the alarm system 100 (e.g., as described with respect to FIGS. 1-12) can be conveniently implemented using one or more conventional general purpose computer systems, microprocessors, digital signal processors, micro-controllers, etc., programmed according to the teachings of the embodiments of the present invention (e.g., using the computer system of FIG. 13), as will be appreciated by those skilled in the computer and software art(s). Appropriate software can be readily prepared by programmers of ordinary skill based on the teachings of the present disclosure, as will be appreciated by those skilled in the software art. Further, the alarm system 100 can be implemented on the World Wide Web (e.g., using the computer system of FIG. 13). In addition, the alarm system 100 (e.g., as described with respect to FIGS. 1-12) can be implemented by the preparation of application-specific integrated circuits or by interconnecting an appropriate network of conventional component circuits, as will be appreciated by those skilled in the electrical art(s).

FIG. 13 illustrates a computer system 1301 upon which the embodiments of the present invention (e.g., the devices and subsystems of the alarm system 100 of FIG. 1) can be implemented. The embodiments of the present invention can be implemented on a single such computer system, or a collection of multiple such computer systems. The computer system 1301 can include a bus 1302 or other communication mechanism for communicating information, and a processor 1303 coupled to the bus 1302 for processing the information. The computer system 1301 also can include a main memory 1304, such as a random access memory (RAM), other dynamic storage device (e.g., dynamic RAM (DRAM), static RAM (SRAM), synchronous DRAM (SDRAM)), etc., coupled to the bus 1302 for storing information and instructions to be executed by the processor 1303. In addition, the main memory 1304 also can be used for storing temporary variables or other intermediate information during the execution of instructions by the processor 1303. The computer system 1301 further can include a ROM 1305 or other static storage device (e.g., programmable ROM (PROM), erasable PROM (EPROM), electrically erasable PROM (EEPROM), etc.) coupled to the bus 1302 for storing static information and instructions.

The computer system 1301 also can include a disk controller 1306 coupled to the bus 1302 to control one or more storage devices for storing information and instructions, such as a magnetic hard disk 1307, and a removable media drive 1308 (e.g., floppy disk drive, read-only compact disc drive, read/write compact disc drive, compact disc jukebox, tape drive, and removable magneto-optical drive). The storage devices can be added to the computer system 1301 using an appropriate device interface (e.g., small computer system interface (SCSI), integrated device electronics (IDE), enhanced-IDE (E-IDE), direct memory access (DMA), or ultra-DMA).

The computer system 1301 also can include special purpose logic devices 1318, such as application specific integrated circuits (ASICs), full custom chips, configurable logic devices (e.g., simple programmable logic devices (SPLDs), complex programmable logic devices (CPLDs), field programmable gate arrays (FPGAs), etc.), etc., for performing special processing functions, such as signal processing, image processing, speech processing, voice recognition, infrared (IR) data communications, DTMF communications, PIR functions, telephony functions, etc.

The computer system 1301 also can include a display controller 1309 coupled to the bus 1302 to control a display 1310, such as a cathode ray tube (CRT), liquid crystal display (LCD), active matrix display, plasma display, touch display, etc., for displaying or conveying information to a computer user. The computer system can include input devices, such as a keyboard 1311 including alphanumeric and other keys and a pointing device 1312, for interacting with a computer user and providing information to the processor 1303. The pointing device 1312 can include, for example, a mouse, a trackball, a pointing stick, etc., or voice recognition processor, etc., for communicating direction information and command selections to the processor 1303 and for controlling cursor movement on the display 1310. In addition, a printer can provide printed listings of the data structures/information of the system shown in FIG. 1, or any other data stored and/or generated by the computer system 1301.

The computer system 1301 can perform a portion or all of the processing steps of the invention in response to the processor 1303 executing one or more sequences of one or more instructions contained in a memory, such as the main memory 1304. Such instructions can be read into the main memory 1304 from another computer readable medium, such as a hard disk 1307 or a removable media drive 1308. Execution of the arrangement of instructions contained in the main memory 1304 causes the processor 1303 to perform the process steps described herein. One or more processors in a multi-processing arrangement also can be employed to execute the sequences of instructions contained in main memory 1304. In alternative embodiments, hard-wired circuitry can be used in place of or in combination with software instructions. Thus, embodiments are not limited to any specific combination of hardware circuitry and/or software.

Stored on any one or on a combination of computer readable media, the embodiments of the present invention can include software for controlling the computer system 1301, for driving a device or devices for implementing the invention, and for enabling the computer system 1301 to interact with a human user (e.g., users of the alarm system 100 of FIG. 1, etc.). Such software can include, but is not limited to, device drivers, firmware, operating systems, development tools, applications software, etc. Such computer readable media further can include the computer program product of an embodiment of the present invention for performing all or a portion (if processing is distributed) of the processing performed in implementing the invention. Computer code devices of the embodiments of the present invention can include any interpretable or executable code mechanism, including but not limited to scripts, interpretable programs, dynamic link libraries (DLLs), Java classes and applets, complete executable programs, Common Object Request Broker Architecture (CORBA) objects, etc. Moreover, parts of the processing of the embodiments of the present invention can be distributed for better performance, reliability, and/or cost.

The computer system 1301 also can include a communication interface 1313 coupled to the bus 1302. The communication interface 1313 can provide a two-way data communication coupling to a network link 1314 that is connected to, for example, a local area network (LAN) 1315, or to another communications network 1316, such as the Internet. For example, the communication interface 1313 can include a digital subscriber line (DSL) card or modem, an integrated services digital network (ISDN) card, a cable modem, a telephone modem, etc., to provide a data communication connection to a corresponding type of telephone line. As another example, communication interface 1313 can include a local area network (LAN) card (e.g., for Ethernet™, an Asynchronous Transfer Model (ATM) network, etc.), etc., to provide a data communication connection to a compatible LAN. Wireless links can also be implemented. In any such implementation, communication interface 1313 can send and receive electrical, electromagnetic, or optical signals that carry digital data streams representing various types of information. Further, the communication interface 1313 can include peripheral interface devices, such as a Universal Serial Bus (USB) interface, a PCMCIA (Personal Computer Memory Card International Association) interface, etc.

The network link 1314 typically can provide data communication through one or more networks to other data devices. For example, the network link 1314 can provide a connection through local area network (LAN) 1315 to a host computer 1317, which has connectivity to a network 1316 (e.g. a wide area network (WAN) or the global packet data communication network, such as the Internet) or to data equipment operated by a service provider. The local network 1315 and network 1316 both can employ electrical, electromagnetic, or optical signals to convey information and instructions. The signals through the various networks and the signals on network link 1314 and through communication interface 1313, which communicate digital data with computer system 1301, are exemplary forms of carrier waves bearing the information and instructions.

The computer system 1301 can send messages and receive data, including program code, through the network(s), network link 1314, and communication interface 1313. In the Internet example, a server (e.g., the server 104a) can transmit requested code belonging to an application program for implementing an embodiment of the present invention through the network 1316, LAN 1315 and communication interface 1313. The processor 1303 can execute the transmitted code while being received and/or store the code in storage devices 1307 or 1308, or other non-volatile storage for later execution. In this manner, computer system 1301 can obtain application code in the form of a carrier wave. With the system of FIG. 13, the embodiments of the present invention can be implemented on the Internet as a Web Server 1301 performing one or more of the processes according to the embodiments of the present invention for one or more computers coupled to the web server 1301 through the network 1316 coupled to the network link 1314.

The term “computer readable medium” as used herein can refer to any medium that participates in providing instructions to the processor 1303 for execution. Such a medium can take many forms, including but not limited to, non-volatile media, volatile media, transmission media, etc. Non-volatile media can include, for example, optical or magnetic disks, magneto-optical disks, etc., such as the hard disk 1307 or the removable media drive 1308. Volatile media can include dynamic memory, etc., such as the main memory 1304. Transmission media can include coaxial cables, copper wire and fiber optics, including the wires that make up the bus 1302. Transmission media can also take the form of acoustic, optical, or electromagnetic waves, such as those generated during radio frequency (RF) and infrared (IR) data communications.

As stated above, the computer system 1301 can include at least one computer readable medium or memory for holding instructions programmed according to the teachings of the invention and for containing data structures, tables, records, or other data described herein. Common forms of computer-readable media can include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media can be involved in providing instructions to a processor for execution. For example, the instructions for carrying out at least part of the embodiments of the present invention can initially be borne on a magnetic disk of a remote computer connected to either of networks 1315 and 1316. In such a scenario, the remote computer can load the instructions into main memory and send the instructions, for example, over a telephone line using a modem. A modem of a local computer system can receive the data on the telephone line and use an infrared transmitter to convert the data to an infrared signal and transmit the infrared signal to a portable computing device, such as a personal digital assistant (PDA), a laptop, an Internet appliance, etc. An infrared detector on the portable computing device can receive the information and instructions borne by the infrared signal and place the data on a bus. The bus can convey the data to main memory, from which a processor retrieves and executes the instructions. The instructions received by main memory can optionally be stored on storage device either before or after execution by processor.

It is envisioned that an embodiment of the invention may include wherein the multi-level protection module is further configured to employ an inner code and an outer code. Further, the multi-level protection module may employ the inner code for error correction on an alert code and the outer code. Still further, the multi-level protection module may employ the outer code for error detection. Yet further still, the multi-level protection module may employ the outer code for error correction and error detection.

It is additionally envisioned that the non-urgent alert code may include a normal priority alert code. Further, the non-urgent alert code may include a low priority alert code.

It is also envisioned an embodiment may include one or more of the following: a customer billing process; a retailer process; and/or a reseller process. Also, there may be included an account cancellation process, including: communicating an account cancellation request to a customer service party; canceling a customer service account with the customer service party; automatically communicating the account cancellation request from the customer service party to a monitoring service party; and canceling a monitoring service account with the monitoring service party.

Still further, it is envisioned that an embodiment may include an account activation process, which may include: communicating an account activation request to a customer service party; establishing a customer service account with the customer service party; automatically communicating the account activation request from the customer service party to a monitoring service party; and establishing and activating a monitoring service account with the monitoring service party.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An alarm system, comprising:
at least one main alarm unit configured to receive messages generated by the alarm system, the messages including predetermined alarm event messages; and
at least one remote alarm device configured to detect predetermined alarm events and transmit messages, the messages including predetermined alarm event messages,
wherein the messages are represented by codes;
wherein the messages are classified as either high priority or low priority; and
wherein all codes in low priority messages differ in a plurality of binary bit locations from all codes in high priority messages.

2. The system of claim 1, wherein the main alarm unit is further configured to sound an alarm in response to at least one predetermined alarm event or predetermined alarm event message.

3. The system of claim 1, wherein the main alarm unit is further configured to alert a central monitoring center in response to at least one predetermined alarm event or predetermined alarm event message.

4. The system of claim 1, wherein the Hamming distances between the codes in the high priority messages is maximized.

5. A method for assigning message codes in an alarm system, comprising:
classifying a set of messages into high priority messages and low priority messages; and
assigning codes such that all codes in low priority messages differ in a plurality of bit locations from all codes in high priority messages.

6. The method of claim 5, wherein the codes are binary.

7. The method of claim 6, wherein the Hamming distances between the codes in high priority messages are maximized.

8. The method of claim 7, wherein the high priority messages comprise two messages and the first of the two messages is assigned a code containing all ones (1's) and the second of the two messages is assigned a code containing all zeroes (0's).

9. The method of claim 8, wherein the codes contain at least twice as many bits as there are messages and the codes in the low priority messages are assigned codes with approximately the same number of ones (1's) and zeroes (0's).

10. The method of claim 6, wherein the codes contain at least twice as many bits as there are messages.

11. A method of unilateral packet transmission in systems with multiple independent transmitters, comprising:
transmitting a packet;
waiting a randomly determined amount of time less than a predetermined maximum amount of time;
retransmitting the packet; and
repeating the waiting and the retransmitting a predetermined number of times.

12. The method of claim 11, wherein the predetermined maximum amount of time in the waiting and the predetermined number of times in the repeating are configured such that packets will be received successfully with a failure rate less than a predetermined failure rate.

13. The method of claim 11, wherein the randomly determined amount of time in the waiting is calculated by a uniformly distributed function.

14. The method of claim 11, wherein the randomly determined amount of time in the waiting is calculated by a non-uniformly distributed function.

15. The method of claim 11, wherein the randomly determined amount of time in the waiting is equivalent to an integer multiple of the amount of time required to transmit the packet.

16. The method of claim 11, wherein the predetermined maximum amount of time in the waiting and the predetermined number of times in the repeating are configured such that the total possible time that a packet can be transmitted or retransmitted is at most equal to a limit established by a government regulation or a standard protocol.

17. The method of claim 11, wherein the packet has a predetermined priority and the predetermined maximum amount of time in the waiting, the predetermined number of times in the repeating, and the predetermined failure rate has been determined based on that priority.

18. The method of claim 11, wherein the method does not comprise receiving an acknowledgement that the packet has been received.

19. A method of encoding a message to increase error correction and detection in an alarm system, comprising:
encoding a message with an error detection code;
appending the error detection code to the encoded message; and
encoding the resulting encoded message and error detection code with an error correction code.

20. The method of claim 19, wherein the error detection code comprises a code selected from the group consisting of a Hamming code, a Reed-Solomon code, and a Bose-Chaudhuri-Hocquenghem code.

21. The method of claim 19, wherein the error correction code comprises a code selected from the group consisting of a Hamming code, a Reed-Solomon code, and a Bose-Chaudhuri-Hocquenghem code.

22. The method of claim 19, further comprising encoding the message using a four-way interleave.

23. The method of claim 19, wherein the error detection code can also be used as an error correction code.

24. A method for activating an alarm system, comprising:
receiving information to create a customer account, the customer account including a customer contact telephone number;
receiving an alarm notification produced by performing a single manual input action on an alarm unit;
telephoning the customer contact telephone number;
requesting a passcode;
receiving the passcode; and
activating a monitoring account for monitoring the alarm system after receiving the passcode.

25. The method of claim 24, wherein the telephoning and the requesting are executed by an interactive voice response module.
